(19) United States
(12) Patent Application Publication
(10) Pub. No.: US 2014/0040714 A1
(43) Pub. Date: Feb. 6, 2014

(54) Information Management System and Method

(71) Applicants: Louis J. Siegel, Owings Mills, MD (US); Brian E. Fromme, Forest Hill, MD (US)

(72) Inventors: Louis J. Siegel, Owings Mills, MD (US); Brian E. Fromme, Forest Hill, MD (US)

(21) Appl. No.: 13/874,158

(22) Filed: Apr. 30, 2013

Related U.S. Application Data
(60) Provisional application No. 61/640,558, filed on Apr. 30, 2012.

(51) Int. Cl. G06F 17/21

(52) U.S. Cl. CPC G06F 17/212
USPC 715/203

(57) ABSTRACT

A system and method for receiving, categorizing, arranging and displaying information is provided, wherein the method includes creating a database, wherein the database is governed by a database taxonomy defined by a user, introducing information into the database and generating classified information by classifying the information objects based on the database taxonomy, where the classified information objects includes information object metadata and an information taxonomy. The invention further includes assembling a virtual information package file responsive to the classified information objects, wherein the binder file includes links to the classified information objects in the database and providing a taxonomy and process to manage, edit, manipulate and distribute virtual information packages from a one or more collections of virtual information packages publishing the virtual information package file in the desired electronic document format.

### RELATED APPLICATIONS

This application is related to and claims benefit of the filing date of U.S. Provisional Patent Application Ser. No. 61/640,558 (Atty. Docket No. NAA-0001-P), filed Apr. 30, 2012, the contents of which are incorporated by reference herein in its entirety.

### FIELD OF THE INVENTION

The present invention relates to a system for managing electronic information and more particularly to a system and method for dynamically managing, organizing, arranging and displaying electronic information in a desired format.

### BACKGROUND OF THE INVENTION

In many situations, there is a need to organize and distribute many types of unstructured digital information typically called “content” and render the multiplicity of file formats in which the content is contained and their locations more manageable. A Content Management System (CMS) seeks to achieve this goal via various ways, such as by streamlining access, eliminating bottlenecks, optimizing security, and maintaining integrity of stored data. CMSs are well known in the art and are also typically used to edit, organize, archive, process and share documents and a variety of electronic information. Current CMSs obtain data from various outside sources, store that data in a repository and classify and order the stored data using a predetermined system known as a taxonomy (“taxonomy”) to separate elements of a group of objects into subgroups that are mutually exclusive, unambiguous and taken together, include all the content necessary to organize a specific subject. These CMSs allow for metadata and other specified attributes to be associated with the stored data to allow the data to be searched and to produce a sub-set of the stored data that satisfies a specific query. Additionally, current CMSs not only provide to the user the capability to compound and embed objects in documents, they also allow the user to combine documents and content by adding/subtracting pages, editing and annotating pages, combining and reordering pages and providing markers in the documents to separate and define inserted sections. The assembly of this structured content can be further organized in an electronically formatted compilation which may be typically referred to as a catalogue, binder or a document package, such as an Electronic Information Package (EIP). Some CMS's allow the EIP to be published in a plurality of available file formats which are collectively referred to hereinafter as an Electronic Document (ED).

For applications or industries that deal with a large number of compiled and/or compounded objects which are resident in a common repository, the ability to quickly assemble and reassemble content to better control and manage a task is an important feature. This is because in most cases, the EIP and its contained content must be reviewed and amended as it is commented upon by others. There may be a need to share and exchange information within the repository and/or import additional objects from external sources. There may also be a need to create new objects by replacing, relocating, deleting, appending and/or extracting objects or object fragments. Additionally, object fragments and attributes may also need to be linked to their parent objects with an automatic regeneration of footnotes, page numbers, taxonomic alpha/numeric ordering and other formatted information containing relevant metadata about the parent object, as well as a need to retain objects in their original file formats without the need to convert to a homogenous format. Accordingly, the complexity and labor required to accomplish these tasks increases as more object data is included, excluded, appended and/or processed.

Unfortunately however, several problems exist with the current methods and systems for managing the assembly of large amounts of information. One major problem involves the integration and coordination of multiple pieces of content into information packages. This problem is compounded when the content is organized according to the taxonomy of a CMS and then must be further compiled, manipulated and arranged in one or more different new taxonomy configurations. For example, the schema used by current CMSs and methods is typically not able to handle the complex operations required to adequately manage multiple taxonomies. The task becomes more complex when the aforementioned new taxonomy configurations must be quickly reconfigured and assembled to create new EIPs. Using current methods, an EIP is created by assembling information directly from the CMS taxonomy or an operating systems (OS) file structure containing a plurality of various content types and compiling the assembled information into a separate unique entity which is then stored in a repository compatible with the CMS or OS. While the resultant EIP may include metadata information for the integrated data, the EIP file, and thus the information contained therein, becomes a separate entity and the connections to its original sources may not be easily preserved or rendered in a satisfactory condition. And because of this discontinuity integrated and coordinated operations with other EIPs and electronic content stored in the CMS or OS designated repository is difficult, if not impossible.

Accordingly, because current methods and systems do not provide a method robust enough to satisfy this requirement, they are not able to operate an interactive virtual library to contain and properly manage a collection of EIPs. This is especially true for situations where large amounts of information also known as Big Data are processed. In addition, as the complexity and size of the repository increases, so too does the difficulty in managing the content and relevance contained in a collection of EIPs. The problem is further exacerbated when there is a need to assemble and join one or more EIPs into a new EIP and then insert a section or all of the new EIPs into other EIPs. The assignment becomes even more problematic when the user is asked to manipulate the rendered EIP in order to process third party comments in work flows once it is assembled. Accordingly, resolving the above issues can be a laborious and time consuming process. Depending on the complexity of the information to be integrated and considering time constraints the process may become practically impossible.

Another problem is that the current method of EIP assembly is limited because its compilation is dependent on the underlying operating system (OS) file structure and folder management methods used by the CMS or the source document repository. The file and folder management taxonomic methods used by known operating systems such as Microsoft Windows, Apple OS X and Linux and then adapted by the CMS are not intended or designed to work with complex EIP assembly structures much less to effectively manage a collection of EIPs. For example, consider the situation where a file is to be inserted into an EIP. This task typically requires that the file be copied from an existing operating system folder to another existing operating system folder and then that the new file then be renamed, formatted and meta-tagged to operate in accordance with the EIP taxonomy and then be automatically inserted into the new EIP. Further complexity arises when the EIP is a child variant of the parent EIP taxonomy. Unfortunately, current operating systems do not allow for such complex EIP assembly, or the design, build and interoperability of an unlimited number of new EIP configurations of the system taxonomy and as a result do not allow for the easy naming and renaming of content, editing of content, naming and renaming and ordering and reordering of sections and divisions of content and assembling and reassembling of content and resulting EIPs to satisfy this specific purpose

Another problem exists with the current art with regards to a method of automatically applying alpha-numeric indexing to the categories and files in the EIP. Typically, the user is asked to create an EIP and select a preferred alpha/numeric index structure. The user is then asked to rearrange the EIP and automatically adjust the alpha numeric index to update the rearranged EIP. The user is also asked to publish the ED with or without the alpha numeric index in the table of contents and in all sections and divisions. The user is then asked to combine the EIP with another EIP and automatically reorder the resulting EIP in the alpha numeric index used for the children EIPs. It should be appreciated that this task is difficult, time consuming and not easily accomplished.

Still yet another problem exists with the current art with regards to the method of creating a single parent file from a group of child files within a section or sections of the EIP. In this case, the user is asked to select a group of files, “stack” the files in the desired order to create a single file but still maintain the child file EIP attributes (i.e., its header, footer, sections, divisions, alpha numeric hierarchy and locations in the EIP). The user is also required to link each child file to its parent or source file if the parent is a child of another parent in the database. The parent file must then be automatically reinserted into a new selected location in the EIP. Additionally, the user may be tasked with separating some of the child files back into their original format and place them in separate folders in the desired location and alpha numeric order desired in the EIP. The user is also tasked with placing the parent (which contains the remaining child files) in the desired location and alpha numeric order in the EIP. The user is also asked to create the single file with and without the EIP attributes. As can be seen, this task is overly complex and laborious.

Still yet another problem exists with the current art in that there is no system or method to adequately combine or manipulate the contents of an EIP with another EIP or with a group or collection of EIPs. For example, consider that situation where a new EIP is to be created with a group of files (say, six files) contained and distributed in multiple (say, three) existing EIPs (where each of the existing EIPs may contain multiple files beyond what is required). In this case, the user is asked to select the three EIPs which contain the desired files and then select the desired files (assume two files from each of the existing EIPs are needed to create the new EIP containing six files). Four of the six files are categorized the same and two are categorized differently. The user is asked to automatically populate the new EIP with three sections that correspond to the categorized files. In accordance with the existing art, new sections would need to be manually created for each new category and the categorized documents must be manually moved into these new sections of the new EIP. The problem is made more complex when two of the new sections must be subsequently combined into one new section. Thus, the assigned tasks are quite difficult, if not impossible, to perform.

Still yet another problem exists in that current CMSs are not capable of creating an EIP that results from a query that selects a homogeneous sub-group of files from a total number of files classified to a taxonomy. For example, consider the situation where 50 apartments are identified as matching a specific query of 200 apartments within one apartment building, where the system is asked to create an EIP of query results where fifty sections representing the apartment addresses that contain the same two document types (i.e. 50 specific apartments out of 200 generic apartments) for each section and then create a sub-section for each document type. One problem occurs when certain of the query results are objects or object metadata that are not classified as categories in the taxonomy. For example in the above example the Section 1.0 headings may be each apartment unit's address (i.e., #2B) which may be attributes assigned to a data table at the taxonomy root (say Green Hill Apts) which may be the name of the Apartment project), while the Section 1.1 and 1.2 sub-headings may contain the two document types that are classified as categories in the taxonomy (say Lease and Repairs). The problem is further compounded when the user substitutes the Section 1.2 heading name (Repairs) and renames it (say to Improvements) as an attribute assigned to the original heading (i.e. Repairs) and the system is then asked to track the location of the substituted heading (Improvements) and replace it as desired with the heading name of the original query result (i.e. Repairs). Unfortunately, this EIP configuration and naming schema is exceedingly complicated and not able to be accomplished with the current art.

### SUMMARY OF THE INVENTION

A method for receiving, categorizing, arranging and displaying information is provided and includes creating a database, wherein the database may be governed by one or more database taxonomies (as may be defined by a user), introducing information into the database, generating classified information by classifying the information based on the database taxonomy(s) into one or more sub-taxonomies, where the classified information includes information metadata and other information necessary to assemble a Virtual Information Package (VIP) file responsive to the classified information contained in the VIP and to a collection of VIPs in the database, wherein the VIP file includes links to the classified information and VIPs in the database and to review, publish and distribute the VIP in the desired format file(s).

A method for managing information is provided and includes creating a database for containing information, wherein the information contained within the database is governed by a database taxonomy, generating classified information by identifying an information object responsive to the database taxonomy, assembling a virtual information package binder file responsive to the classified information object, wherein the virtual information package binder file includes a link to the classified information object in the database, providing a taxonomy and process to manage, edit, manipulate and distribute a virtual information package from a one or more collections of virtual information package binder files and publishing the virtual information package in a desired electronic document format

A system for implementing a method for receiving, categorizing, arranging and displaying information is provided and includes an input device for introducing information into the system, a display device having a display screen for displaying the information introduced in to the system and a processing device configured to implement a method for receiving, categorizing, and displaying information. The method for receiving, categorizing, arranging and displaying information includes creating a database, wherein the database is governed by a database taxonomy defined by a user, introducing information into the database, generating classified information by classifying the information based on the database taxonomy into one or more sub-taxonomies, where the classified information includes information metadata and other information necessary to assemble a Virtual Information Package (VIP) file responsive to the classified information contained in the VIP and to a collection of VIPs in the database, wherein the VIP file includes links to the classified information and VIPs in the database, and to review, publish and distribute the EIP file(s) in the desired ED format.

### BRIEF DESCRIPTION OF THE DRAWINGS

FIG. 1A is a block diagram illustrating one embodiment of data relevancy and Docubynd, in accordance with an embodiment of the invention.

FIG. 1B is a block diagram illustrating one example of query results, in accordance with an embodiment of the invention.

FIG. 1C is a screen capture of a document explorer window of a GUI for a Virtual Information Package (VIP), in accordance with an embodiment of the present invention.

FIG. 2A is a high level schematic block diagram illustrating a conceptual representation of the Virtual Information Package (VIP), in accordance with an embodiment of the invention.

FIG. 2B is a high level schematic block diagram illustrating a conceptual representation of the VIP of FIG. 2a.

FIG. 3A is a high level schematic block diagram illustrating a conceptual representation of the VIP of FIG. 2a.

FIG. 3B is a high level schematic block diagram illustrating a conceptual representation of the Master VIP (VEIP) of FIG. 2a.

FIG. 4A is a screen capture of a binder template, in accordance with one embodiment of the present invention.

FIG. 4B is a screen capture of a binder template edit and assembly window, in accordance with one embodiment of the present invention.

FIG. 5A is a screen capture where documents are selected to be merged into a new single document is created based on selected criteria, in accordance with one embodiment of the present invention.

FIG. 5B is a screen capture where a new single document is created and automatically ingested into the system based on selected criteria and classified, in accordance with one embodiment of the present invention.

FIG. 5C is a screen capture where the newly created single document is viewed in the document viewer, in accordance with one embodiment of the present invention.

FIG. 5D is a screen capture where the newly created single document is inserted into a new binder in the binder assembly, in accordance with one embodiment of the present invention.

FIG. 6 is a screen capture of a new document with structure retained, in accordance with one embodiment of the invention.

FIG. 7 is a screen capture of a new document with the structure retained, in accordance with one embodiment of the invention.

FIG. 8A is a screen capture illustrating the distribution of the TOC, in accordance with one embodiment of the invention.

FIG. 8B is a screen capture illustrating the distribution of the TOC, in accordance with one embodiment of the invention.

FIG. 8C is a screen capture illustrating the distribution of the TOC, in accordance with one embodiment of the invention.

FIG. 9A is a high level schematic diagram illustrating the physical architecture of the docubynd system, in accordance with one embodiment of the present invention.

FIG. 9B is a high level functional schematic diagram illustrating the physical architecture and functionality of the docubynd system, in accordance with one embodiment of the present invention.

FIG. 10A is a functional flow diagram of the method for implementing the docubynd system of FIG. 9A and FIG. 9B, in accordance with one embodiment of the present invention.

FIG. 10B is a functional flow diagram of the method for implementing the docubynd system of FIG. 9A and FIG. 9B, in accordance with one embodiment of the present invention.

FIG. 10C is a functional flow diagram of the method for implementing the docubynd system of FIG. 9A and FIG. 9B, in accordance with one embodiment of the present invention.

FIG. 10D is a functional flow diagram of the method for implementing the docubynd system of FIG. 9A and FIG. 9B, in accordance with one embodiment of the present invention.

FIG. 11A is a screen capture of a parent object window and a create fragment window, in accordance with one embodiment of the present invention.

FIG. 11B is a screen capture of a binder assembly window of a Binder Creation Window of the Graphical User Interface (GUI), where fragments in a binder are marked with the file extension .FRG, in accordance with one embodiment of the present invention.

FIG. 11C is a screen capture of a binder assembly window of a Binder Creation Window of the Graphical User Interface (GUI), showing the merger of fragments on one page in the binder and providing a link to view the parent source document, in accordance with one embodiment of the present invention.

FIG. 11D is a screen capture of the document viewer showing a fragment in its relative location in the parent source document, in accordance with one embodiment of the present invention.

FIG. 11E is a screen capture of a binder assembly window within the Document Explorer Window of the Graphical User Interface (GUI), showing the association of the fragment to the binders in which it is located, in accordance with one embodiment of the present invention.

FIG. 11F is a screen capture of a binder assembly window within the Document Explorer Window of the Graphical User Interface (GUI), showing the parent source document of the fragment and other document parent source properties, in accordance with one embodiment of the present invention.

FIG. 12 is a front view of the flip view form for the docubynd system of FIG. 9A and FIG. 9B, in accordance with one embodiment of the present invention.

FIG. 13 is a screen capture of a Graphical User Interface (GUI) showing the GUI dashboard which is used to create a Virtual Information Package (VIP), in accordance with one embodiment of the present invention.

FIG. 14 is a screen capture of the search window of the Binder Creation Window of the GUI, in accordance with one embodiment of the present invention.

FIG. 15 is a screen capture of the search window of the Binder Creation Window showing the results of a search, in accordance with one embodiment of the present invention.

FIG. 16 is a screen capture of a Binder to Document configuration sub-window, in accordance with one embodiment of the invention.

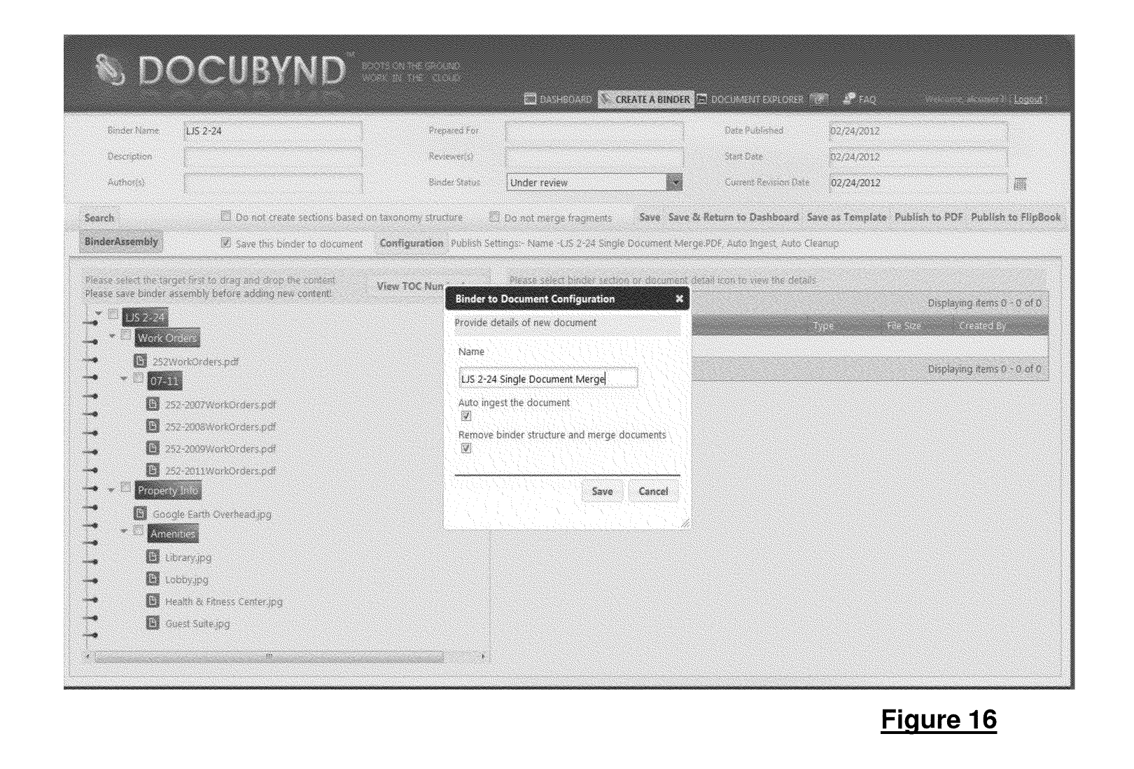

FIG. 17 is a screen capture of the taxonomy section classification window of the document explorer window of the GUI, in accordance with one embodiment of the present invention.

FIG. 18A is a screen capture of the binder assembly window of the Binder Creation Window, in accordance with one embodiment of the present invention.

FIG. 18B is a screen capture of the binder assembly window of the Binder Creation Window, in accordance with one embodiment of the present invention.

FIG. 18C is a screen capture of the binder assembly window of the Binder Creation Window, in accordance with one embodiment of the present invention.

FIG. 19 is a screen capture of the binder assembly window of the Binder Creation Window, in accordance with one embodiment of the present invention.

FIG. 20 is a screen capture of the document explorer window of the GUI, in accordance with one embodiment of the present invention.

FIG. 21A is a screen capture of the document explorer window of the GUI, in accordance with one embodiment of the present invention.

FIG. 21B is a screen capture of the document explorer window of the GUI, in accordance with one embodiment of the present invention.

FIG. 22 is a screen capture of the document explorer window of the GUI, in accordance with one embodiment of the present invention.

FIG. 23 is a screen capture of the document explorer window of the GUI, in accordance with one embodiment of the present invention.

FIG. 24 is a screen capture of the document explorer window of the GUI, in accordance with one embodiment of the present invention.

FIG. 25A is a screen capture of the “create a binder” window of the GUI, in accordance with one embodiment of the present invention.

FIG. 25B is a screen capture of the “create a binder” window of the GUI, in accordance with one embodiment of the present invention.

FIG. 26 is a screen capture of the document explorer window of the GUI, in accordance with one embodiment of the present invention.

FIG. 27 is a screen capture of the taxonomy section classification window of the document explorer window of the GUI, in accordance with one embodiment of the present invention.

FIG. 28 is a screen capture of the document explorer window of the GUI, in accordance with one embodiment of the present invention.

FIG. 29 is a screen capture of the Graphical User Interface (GUI) showing the binder after it was published, in accordance with one embodiment of the present invention.

FIG. 30 is a screen capture of the “FlipBook” publication window showing the binder as it is published, in accordance with one embodiment of the present invention.

FIG. 31 is a screen capture of the “FlipBook” window, in accordance with one embodiment of the present invention.

FIG. 32 is a screen capture of the “FlipBook” window, in accordance with one embodiment of the present invention.

FIG. 33 is a screen capture of the “FlipBook” window, in accordance with one embodiment of the present invention.

FIG. 34 is a screen capture of the “FlipBook” window, in accordance with one embodiment of the present invention.

FIG. 35A is a screen capture illustrating an example of a query format using a Master Taxonomy/Sub-Taxonomy approach, in accordance with one embodiment of the present invention.

FIG. 35B is a screen capture illustrating an example of a query format using a Master Taxonomy/Sub-Taxonomy approach, in accordance with one embodiment of the present invention.

FIG. 35C is a screen capture illustrating an example of a query format using a Master Taxonomy/Sub-Taxonomy approach, in accordance with one embodiment of the present invention.

FIG. 35D is a screen capture illustrating an example of a query format using a Master Taxonomy/Sub-Taxonomy approach, in accordance with one embodiment of the present invention.

### DETAILED DESCRIPTION OF THE INVENTION

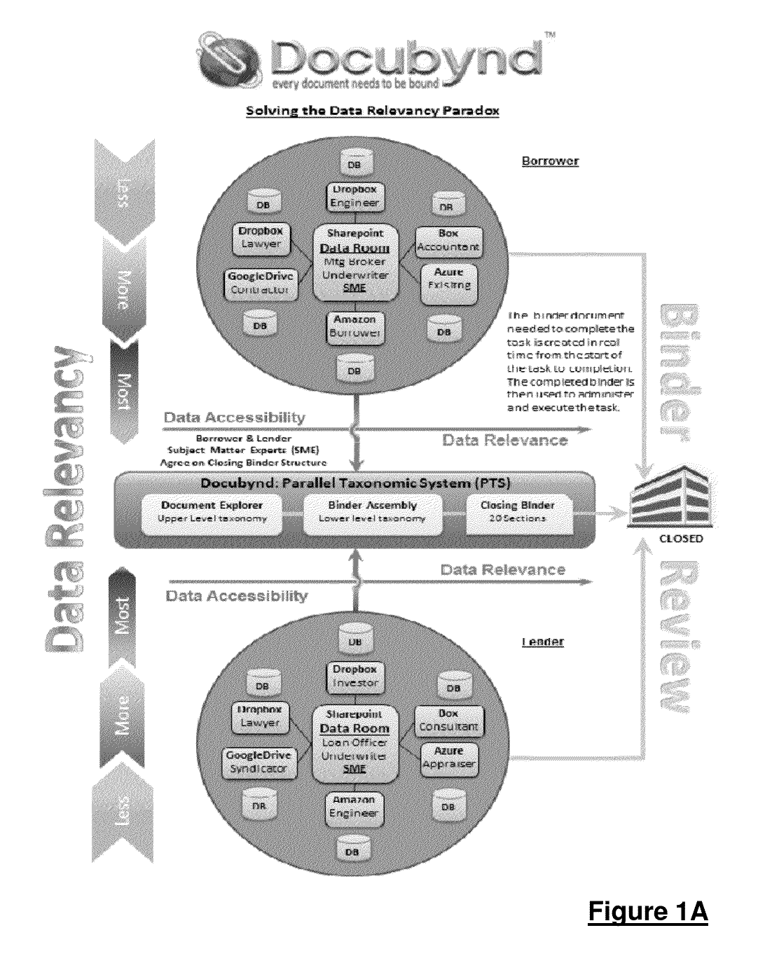

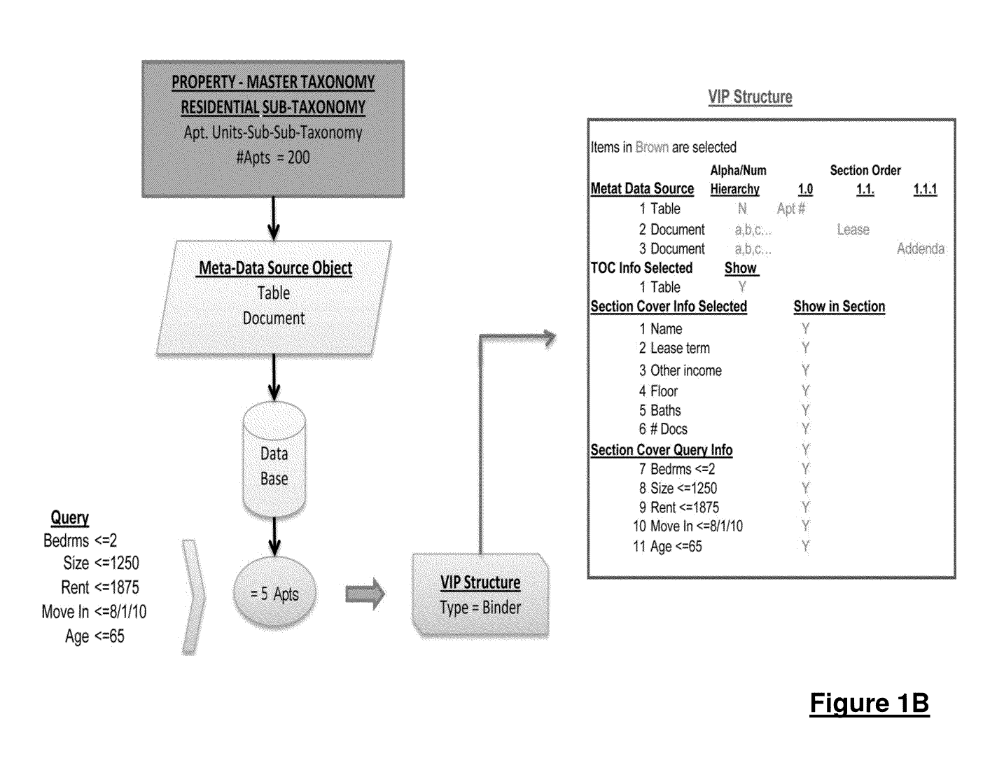

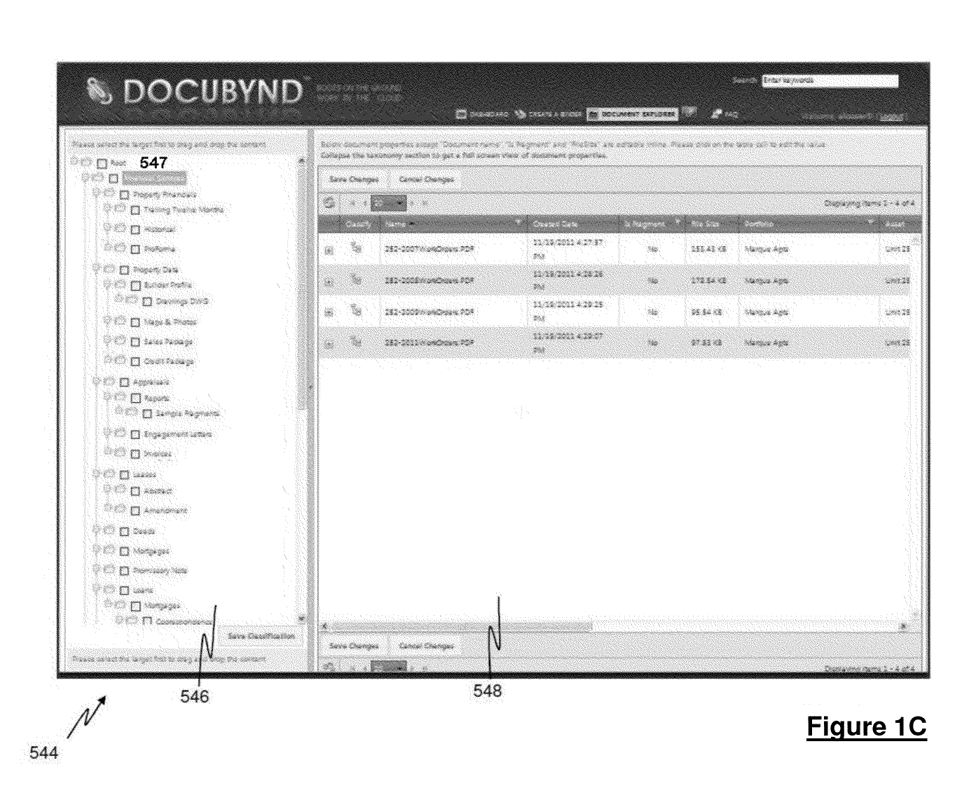

It should be appreciated that the present invention was created to solve what is referred to as “the data relevancy paradox” via a cost effective method to obtain the highest level of relevancy from the information overload that is dealt with during transactions. Referring to FIG. 1A, data relevancy denotes the extent to which data are applicable and useful for a task for which the data is to be applied. Data accessibility is the ability to easily obtain data. It seems logical that as access to data increases, the ability to obtain a more relevant analysis should also improve. However, the actual result is just the opposite and finding the best method to put the data into proper context isn't necessarily clear or immediately apparent. Accordingly, for time sensitive tasks, as more and more data is obtained and stored without context, the frustration mounts. This pressure can cause even the most seasoned analysts to seek only information and advice that they believe is the bare minimum amount required, as opposed to that which is actually needed. Thus, a data relevancy paradox exists when a large amount of data is accessible, but its relevance is extremely difficult to determine. Undesirable and unintended consequences are inevitable unless a practical solution is found to guide you to a decision.

As is known, data accessibility is an important requirement in most transactions and online storage services have been created help to meet this accessibility demand. They services include literally hundreds of choices, such as Dropbox, Box, SugarSync, Google Drive, SkyDrive, etc. These services allow a user to store, share, modify and annotate documents, audit file distribution, offer user provisioning (such as providing permissions for user access and security) and provide levels of perceived security. Unfortunately, problems quickly emerge when a different service or parts of the same service are used by different team members. For example, it typically becomes necessary to transfer files and folders from one or more services to each person's service or local repository and then to a group workspace. However, this practice creates data silos that are opaque, hard to search and can quickly confuse the best organizers. Eventually, individual team members must make sense of all this data “noise.” But, even at the group workspace level it is necessary to constantly obtain fresh data, discard what is no longer relevant, sort it all out and finally get some meaningful work done. Unfortunately however, there is a price to pay in time, cost, mistakes and aggravation.

The extent to which data is accessible and useful for a desired task requires great effort and can be rather cheap compared to the greater cost of data relevancy. For example, in the legal field a law firm can spend more than a hundred thousand dollars for expensive software to extract crucial relevant evidence from large discovery files. However, the current technology is at most 70% reliable. Additionally, the extracted data must then be analyzed and put into context relative to the situation. Thus, it makes sense that the more information you have, the more likely better and more informed decisions can be made. Unfortunately, this only proves true if the right Subject Matter Expert (SME) organizes a large data set and successfully reduces its size to an understandable product that can be understood by a knowledgeable group, such as a tabbed and indexed compilation that prioritizes the importance of the information. What happens to the rest of all the less than relevant data? It is neatly referenced in the appendix, bibliography and/or data repository via the database taxonomy. Unfortunately, there is still a problem in that an assumption must be made that the compiled product with the organized data includes not only all of the relevant information, but the most correct information relative to the situation as determined by the SME.

It should be appreciated that the present invention provides a method to solve these problems by allowing a SME to control where the data is gathered from, how the data is compiled, how the data is organized and separated and how the data is presented. For example, the present invention allows an SME to bring in data from various data accessibility sources and organize the data based on a file management system or taxonomy that classifies and sorts the files in a desired and controllable hierarchy. Additionally, the volume of incoming data may be limited if desired, such as by only allowing in data that meet certain criteria. A virtual ‘loose leaf binder’, which may be tabbed and indexed in an alpha-numeric hierarchy may then be created where the binder outline structure may be configured with the sections and sub-sections that identify all (or selected) relevant categories of data needed or desired. For example, a document explorer GUI may be used to search for and add those relevant documents and data that match the sections in the binder. Accordingly, the most relevant data may be classified and inserted into a VIP for all to see.

Thus, in one embodiment the more relevant data is identified and entered into the docubynd system. All relevant data may then be viewed and accessed via a electronic information packaging system in a binder assembly which may be designed by the user(s) who will be working the identified information. Any additional information that matched the binder section's requirement can be added as desired (in real time if desired) to update the docubynd system. Referring to FIG. 1A, an operational block diagram illustrating this is shown. It should be appreciated that, in at least one embodiment, the invention may be thought of as a Parallel Taxonomic System (PTS). The upper level of the PTS is the “Document Explorer” which may be used to introduce and store files from a variety of data accessibility sources and organize them based on an easy to use (and definable) file management system or database taxonomy (for example, one or more Master Taxonomies) which classifies and sorts the files is a desired hierarchy. It should be appreciated that this allows for the ability to limit and/or filter the incoming data to a certain criteria. Additionally, the database taxonomy may have multiple levels of hierarchy, such as a “Master Taxonomy” and one or more “sub-taxonomies” where the Master Taxonomy defines certain criteria which the data within the entire system must contain and the sub-taxonomy (s) which defines the criteria of the data contained within the sub-databases. Thus, sub-taxonomy criteria must satisfy Master Taxonomy criteria.

A Binder Assembly is a lower level of the PTS which allows for the task to be visually represented using a definable and/or familiar format (such as a virtual loose leaf binder, tabbed and indexed in alpha-numeric hierarchy). In one embodiment, the binder outline structure may be designed with sections and sub-sections to identify all the relevant categories of data which may be needed to complete a task. The Document Explorer may be used to search for and add those relevant documents and data that match the sections in the binder. Moreover, a hyperlink to the binder may be sent to team members to allow team members to add information of which they are responsible for the applicable section of the binder. An SME may classify these new relevant documents in the Document Explorer and then inserts them into the binder for all to see. Since the most relevant data is always in the Binder Assembly the team does not need to visit the Document Explorer (at the upper level of the PTS) where they might be distracted or confused by the increased size of the larger and less relevant data set. Saving that trip over and over will result in much higher team satisfaction, productivity and of course vastly improved relevancy.

Thus, the above can be summarized as follows: 1) The task at hand is to provide all of the relevant documents to complete the assembly of an EIP and to successfully complete a transaction, such as a commercial loan transaction. Each team member may introduce into docubynd, all the files/documents they believe are relevant for the task from whatever data accessibility services they used to store these files; 2) The introduced files/documents are checked into the Document Explorer by a designated Subject Matter Expert (SME) administrator according to the team's custom filing system designed for the task; 3) Docubynd's virtual information packaging system in the Binder Assembly is used to design the binder structure with the team's input (as desired); 4) When additional documents are needed, each team member may return to their respective data accessibility sources and retrieve and deliver the relevant documents that matched the binder section's requirements, changes could be made in real time (This advantageously allows the binder to be continuously updated without any email attachments or notifications). It should be appreciated that this approach provided a refreshing sense of relevancy and the team was focused. All of the introduced information was understandable in the context of a text searchable and indexed task centric EIP compilation. This allow for a quick understanding of what was missing in the binder and what required appending. Accordingly, the new content was able to be quickly verified.

In accordance with the present invention, as used herein the term “Master Taxonomy” may refer to a root directory of categories classified in a specified hierarchy which may include an alpha/numeric ordering method. In the system of the present invention, one embodiment of the master taxonomy is represented, as shown in FIG. 1C, as a root directory 547 that includes all the categories necessary to describe and classify a specified subject root directory name. Master Taxonomy categories may be assigned to folders containing a plurality of various types of content stored in the system repository. There is no limit to the number of master taxonomies that may be stored in the system. Master Taxonomies may be installed in the Document Explorer as discussed further herein. Master taxonomies may also be arranged in any hierarchy desired. Additionally, a Master Taxonomy may share categories and assigned content with other Master Taxonomies. Master Taxonomies or any parts thereof may also be combined to create a new Master Taxonomy. Furthermore, meta-information may be linked to one or more the Master Taxonomy categories. The use of the term “Master Taxonomy” herein may also refer to a system taxonomy and one or more Master Taxonomies.

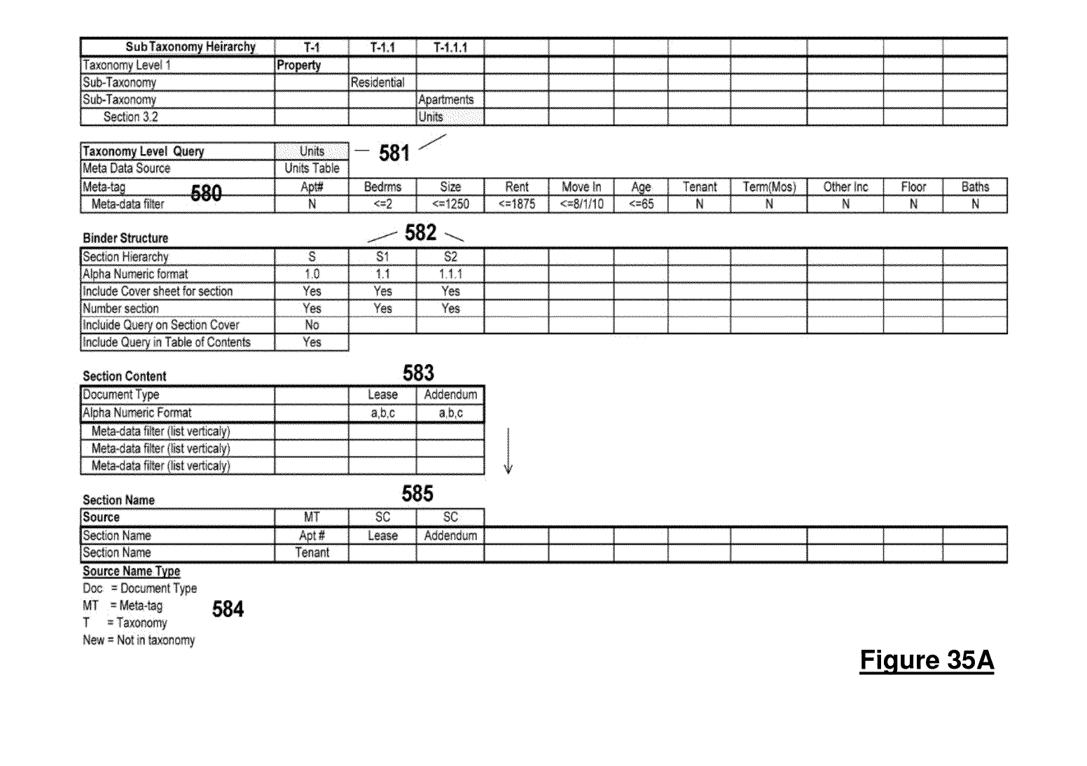

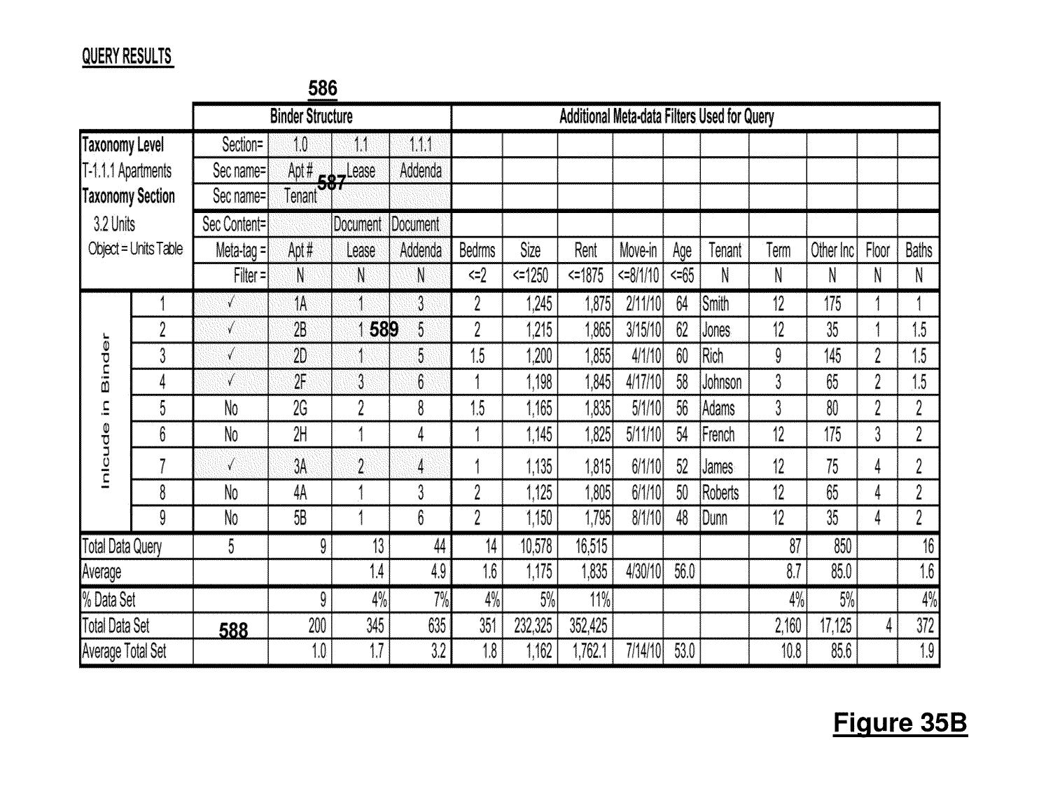

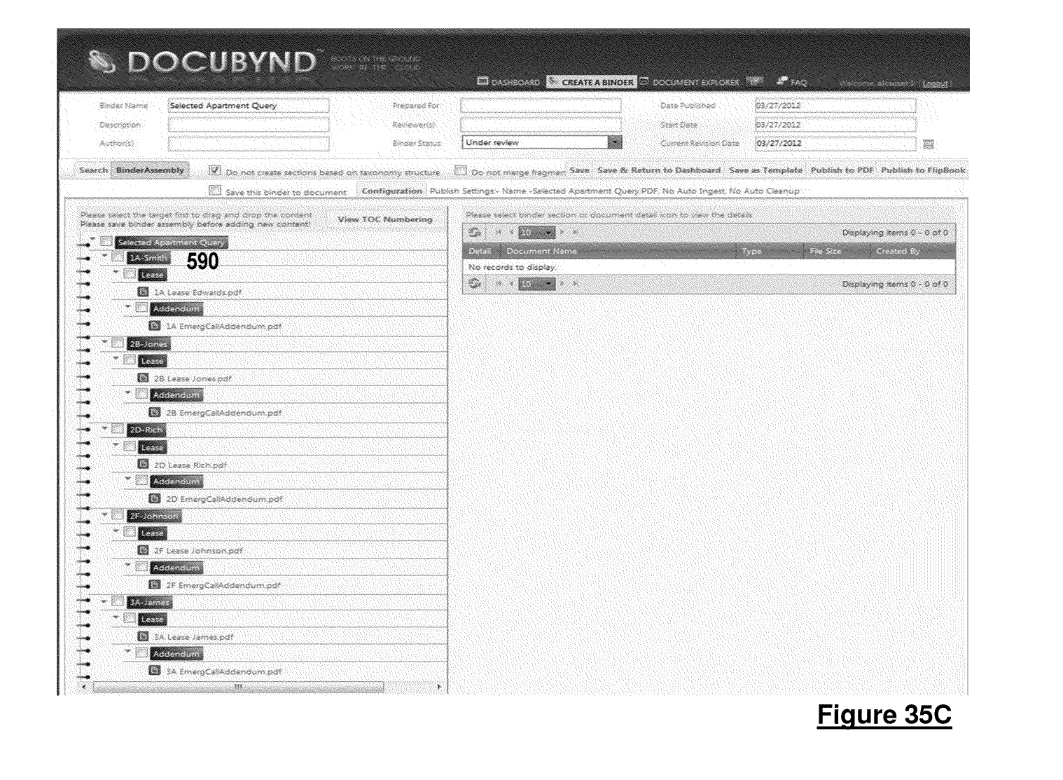

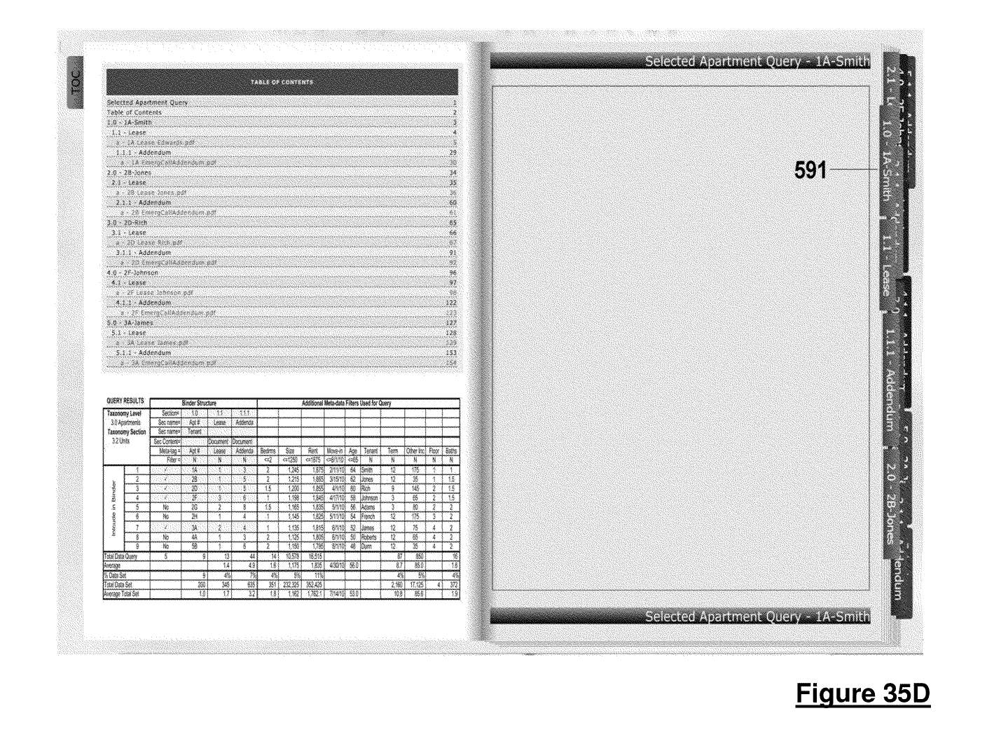

Furthermore, as used herein the term “Sub-Taxonomy” may refer to taxonomies that contain one or more categories from one or more Master Taxonomies and may be arranged in a hierarchy. For example, referring to FIGS. 1B, 35A & 35B, the master taxonomy defined subject is “Property” and a sub-taxonomy of Property is “Residential” and sub-taxonomy of Residential is “Apt. Bldg”, etc.

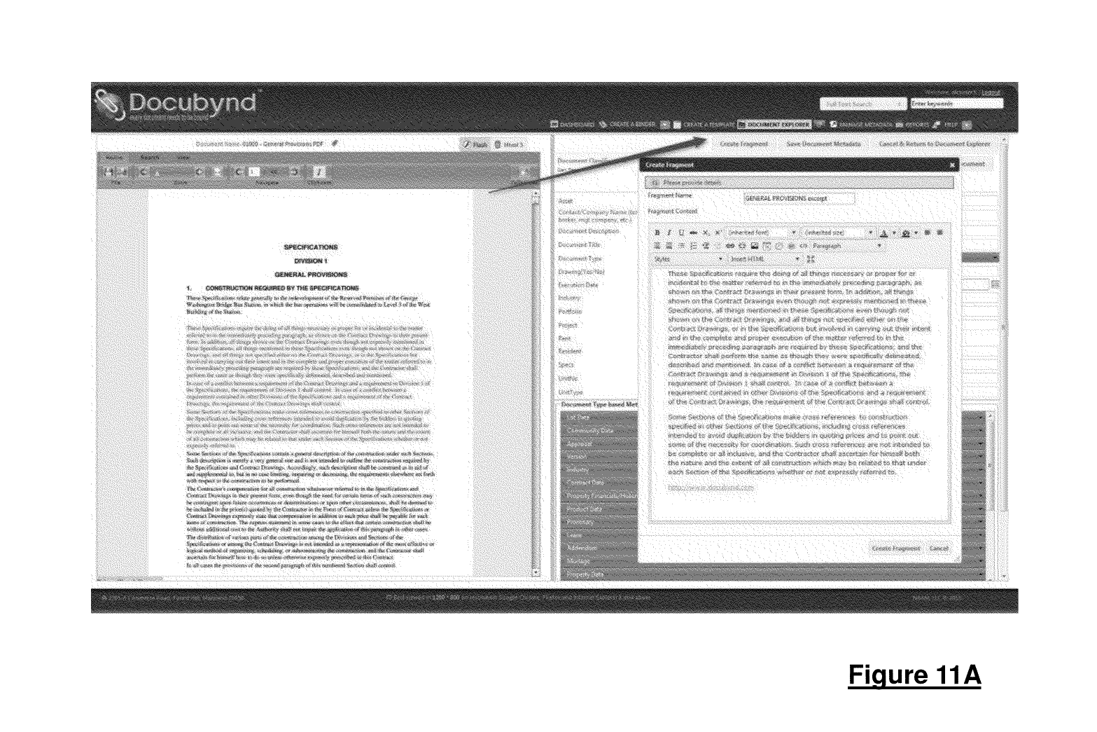

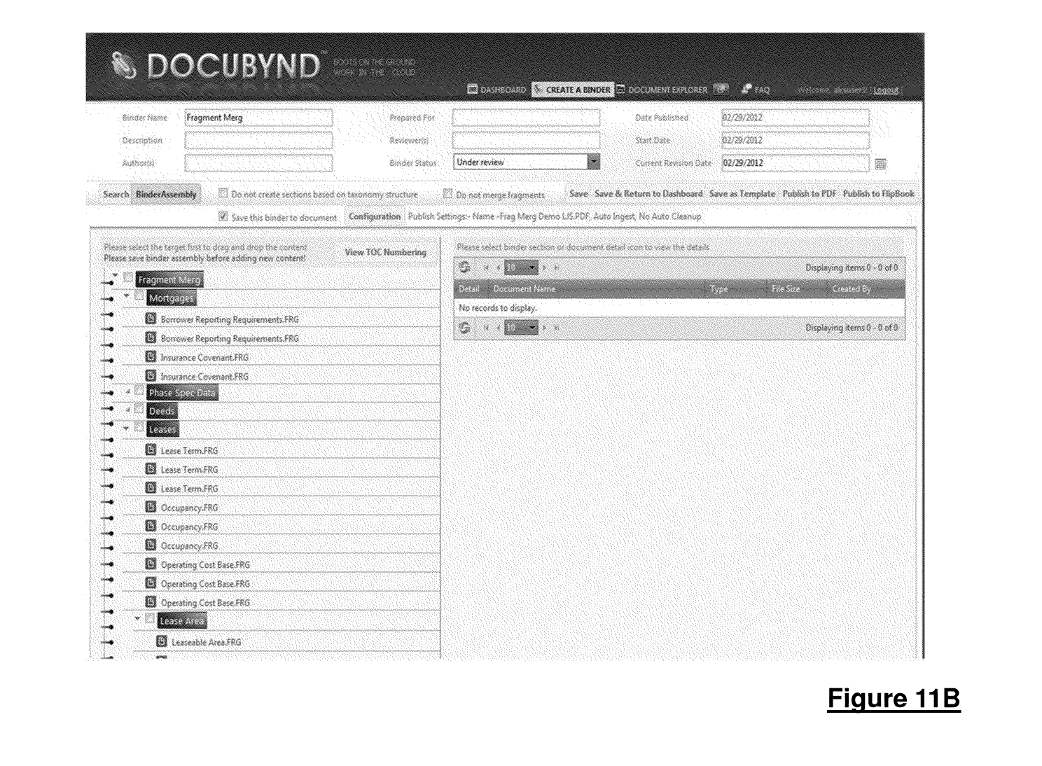

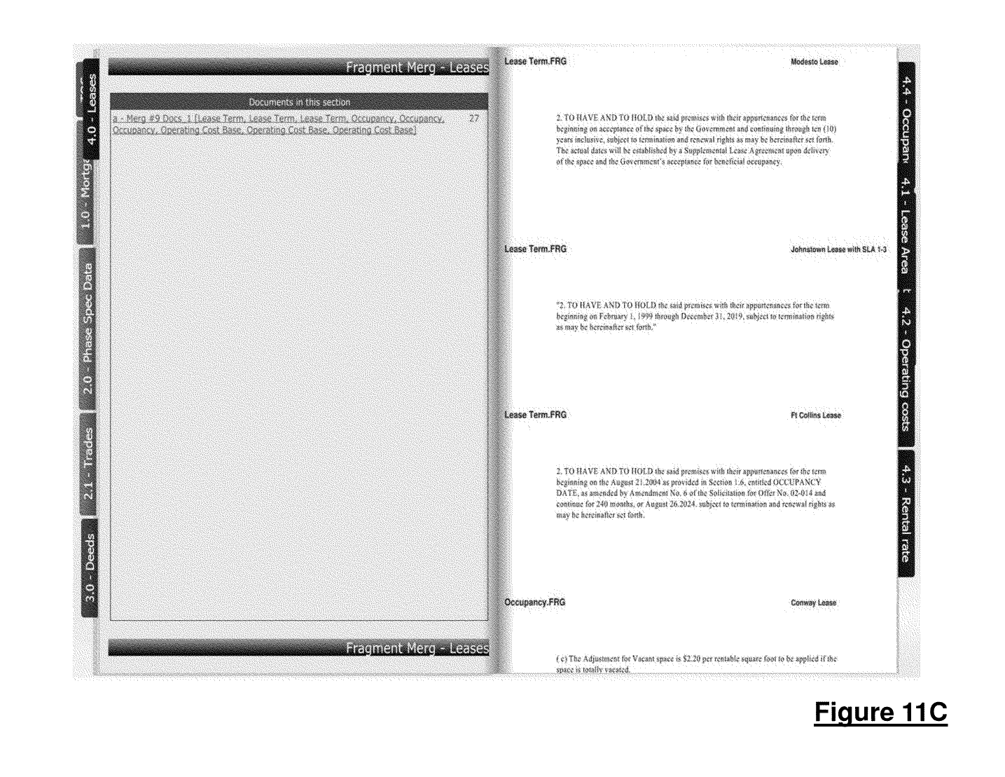

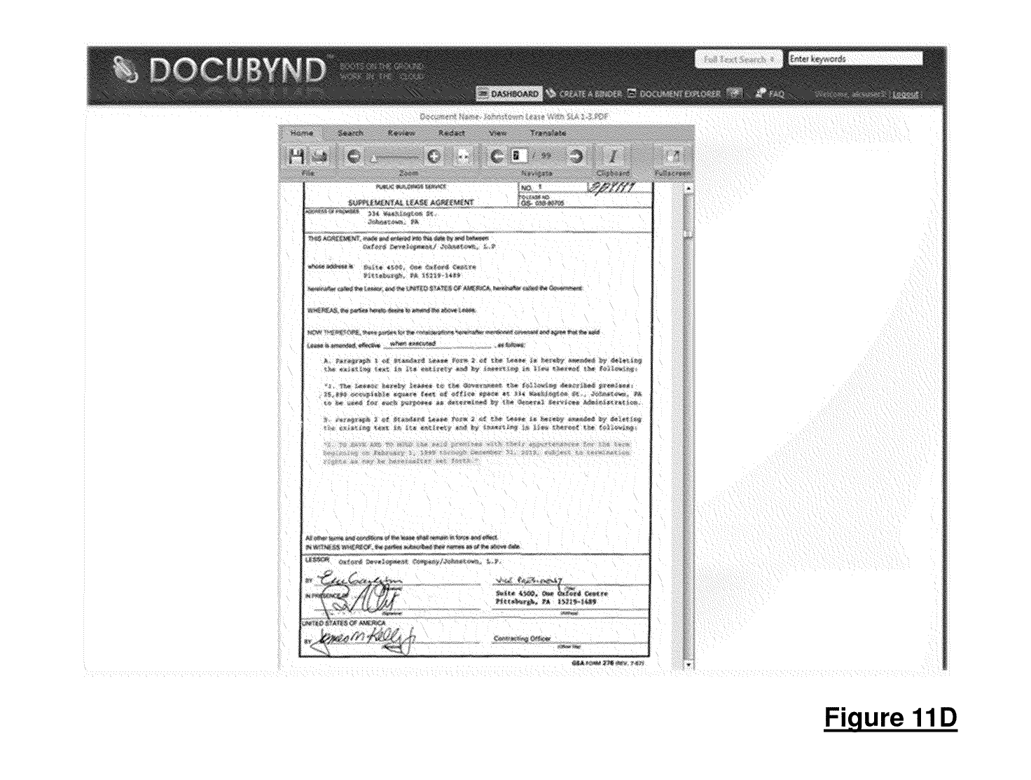

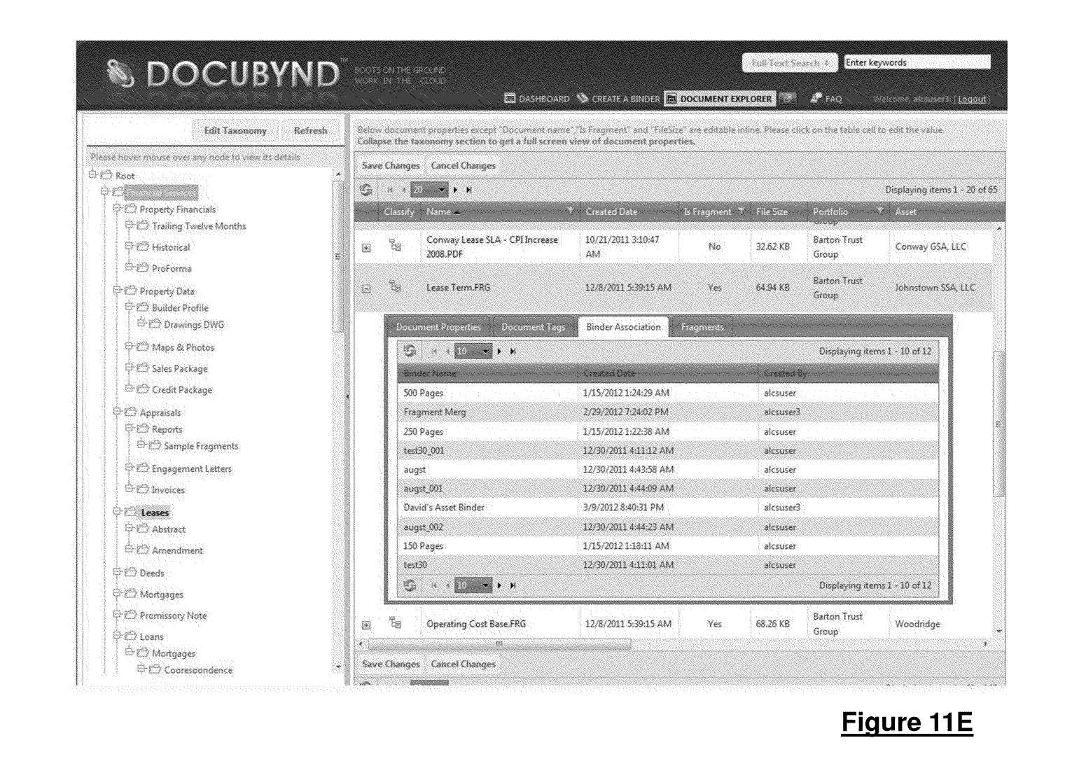

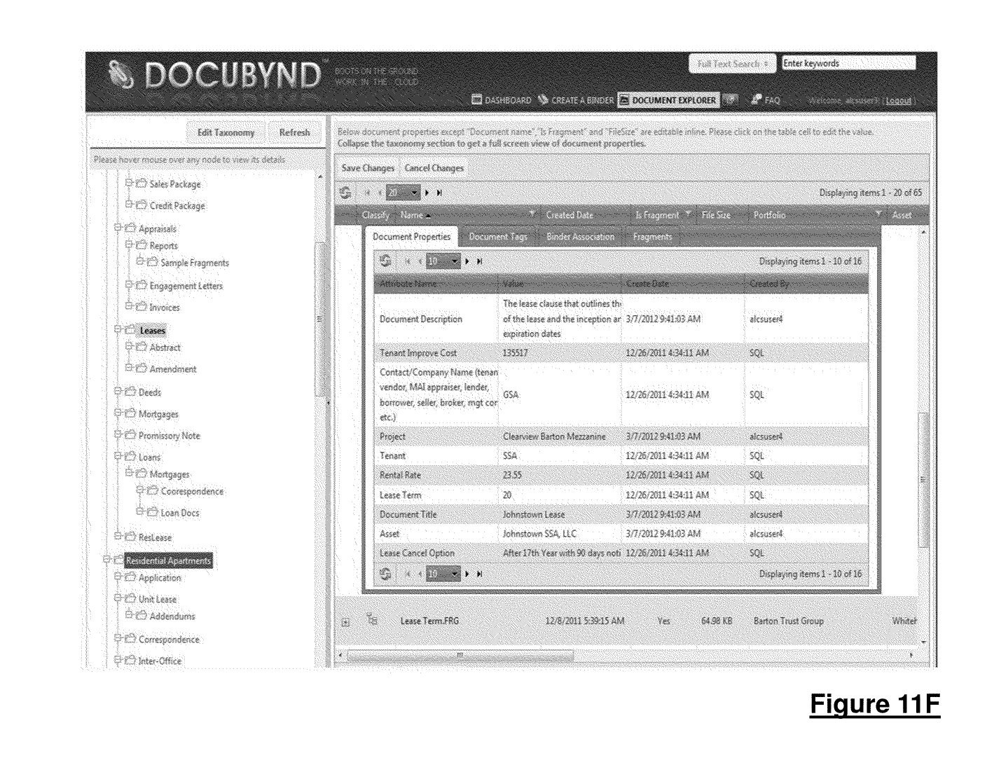

Moreover, as used herein the term “Virtual Information Package (VIP) may refer to an Electronic Information Package (EIP) that contains any number of information objects from one or more EIPs to create a unique sub-taxonomy. The use of the term “binder” herein may also refer to a VIP 100. A VIP may be assembled and arranged in a desired format and structure using a Graphical User Interface (GUI) (for example, a GUI called “CREATE A BINDER”) as shown in the FIGS. 11B, 18A, 18B, 18C, 19, 25A, 25B,35C. It is contemplated that a user may design a VIP and format its structure, i.e., table of contents, cover sheet, headings, page numbers, footers, headers, section dividers and tabs (collectively referred to as “VIP Elements”) as desired and automatically render the VIP in the desired structure. Additionally, the VIP may be stored, copied and stored as a template from which to create additional VIPs. Also, as used herein the term “Master Virtual Information Package (MVIP) may refer to a new VIP created from the combination of one or more VIPs or any parts thereof.

Furthermore, as used herein the term(s) “Information Object” (or simply “Object”) may refer to content which may include any entity that can be manipulated by the commands of a programming language, such as a value, variable, function, or data structure. Entity's include but are not limited to; documents, or any child portion or part of a parent or source document sometimes called “fragments”, etc., and VIP Elements such as indicia, text, sections, divisions, cover sheets, tabs and footnotes, and metadata which provide information about one or more aspects of the objects. It should be appreciated that an entity may also include a compound object which may be created by combining two or more existing information objects into a single object.

Additionally, as used herein the term “Document” may refer to an information object and may include any electronically formatted content (other than computer programs or system files) that is intended to be viewed as media in a VIP. Such content is typically an application file or standard file format such as MS Word, MS Excel, PDF, JPG, TIFF, DICOM, PNG, PPT, DXF, DWG, XPS, XML, SWF, ePUB, etc. The method and system of the present invention may also use unique document formats created specifically for system operation and user interfaces and publishing.

It should be appreciated that, in at least one embodiment of the invention, the system and method of the invention may be embodied as a Content Management System (CMS) which allows for information to be published, edited and modified via the method of the invention. For example, in one embodiment, a CMS may be configured to allow information to be received, categorized, arranged and displayed by creating a database that may be governed by a database taxonomy that is defined by a user within the scope of a master taxonomy. After information is introduced into the database, classified information may be generated by classifying the information objects based on the database taxonomy. In this case, the classified information objects may include information object metadata and/or an information taxonomy which is within the scope of a master taxonomy and which governs how the information handled. A virtual information package (VIP) file may be assembled based on the classified information objects and may include links to the classified information objects or other documents and/or sources of information. Additionally, it should be appreciated that the CMS may be configured to operate via a taxonomy and process which allows a user to manage, edit, manipulate and distribute virtual information packages from one or more collections of virtual information packages. When the information configuration is completed, a virtual information package file may be published in a desired electronic document format.

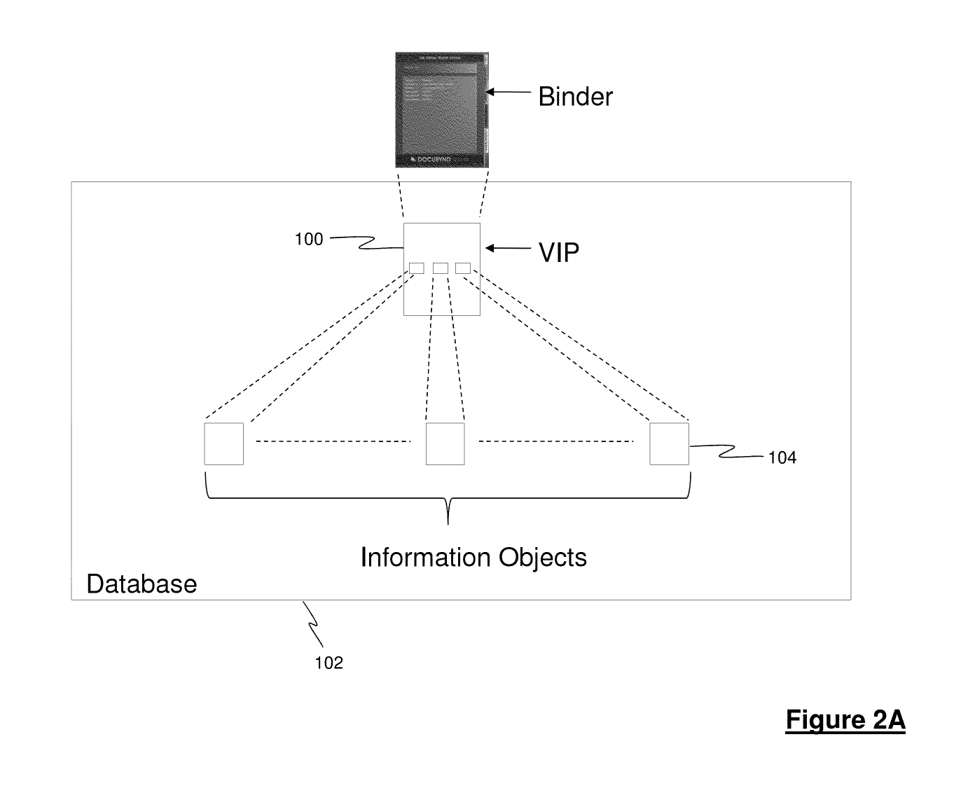

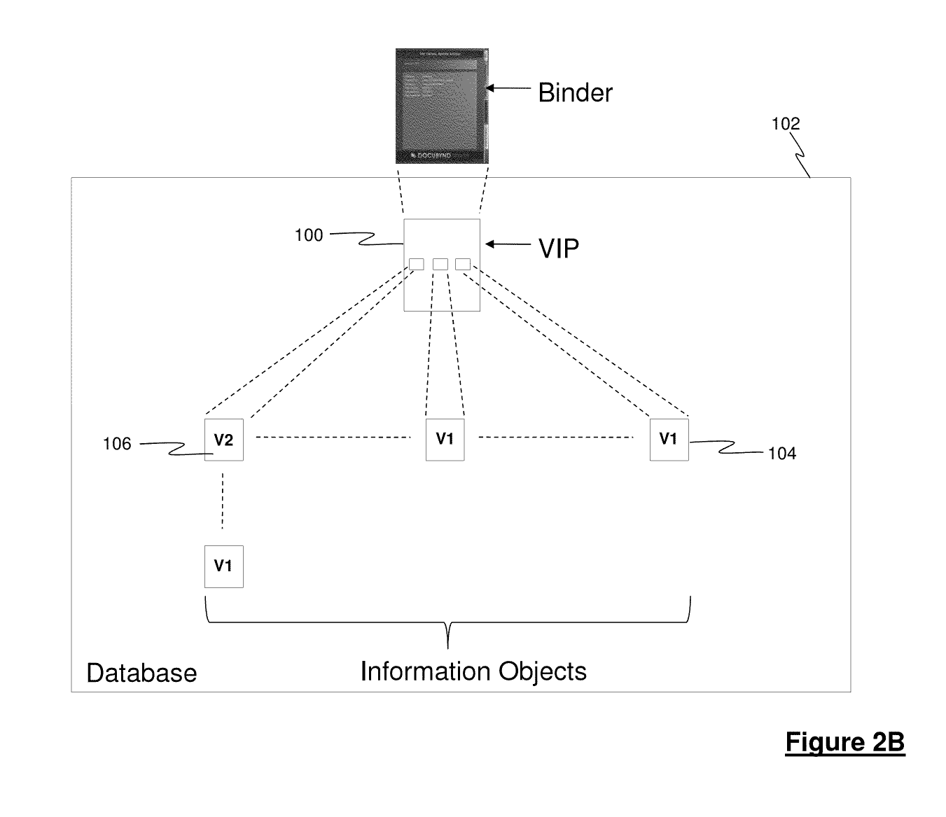

In accordance with the present invention, a method and system (hereafter collectively referred to as “Docubynd” or “DB”) for managing, processing, displaying and publishing a collection of information objects is provided, where the information objects can be integrated and maintained to generate a unique and novel Electronic Information Package (EIP) called a Virtual Information Package (VIP) based on a system taxonomy defined by a user, where the VIP obtains, assembles and arranges the information objects according to the system taxonomy and other information objects and may include a document viewer that displays the information in a unique assembly based on that taxonomy and other information objects according to the user's preferences. It should be appreciated that, in at least one embodiment, the docubynd system may be viewed as a Content Management System (CMS). Referring to FIG. 2A, a schematic block diagram illustrating a conceptual representation of one embodiment of the VIP 100 of the invention is shown. In this case, a user creates a DB database 102 based on a specific taxonomy (i.e. Master Taxonomy) that is defined by the user and that governs the DB database 102. The DB database 102 may then be populated with information objects 104 that may be associated with the master taxonomy and that remain in their original file format. It should be appreciated that the information objects 104 in the DB database 102 may have their own taxonomy or sub-taxonomy which is consistent with any master taxonomy of the DB database 102 but could also contain objects of other diverse taxonomies and databases. The VIP 100 is then generated and formatted to display the selected content in the information objects 104 based on the root's master taxonomy. Conceptually, the VIP 100 is ‘linked’ to the information objects 104 in the database and displays the information based on the master taxonomy. Thus, when the information objects 104 in the DB database 102 are changed, a ‘new version’ of the information object is created and saved in the DB database 102 and this change is reflected in the VIP 100.

In accordance with the invention, the VIP 100 may be created using any method suitable to the desired end purpose. For example, in one embodiment the VIP 100 may be created via a simple query based on any taxonomy desired. Thus, a search for information that matches the taxonomy will be added to the VIP and can be added with or without their VIP Elements such as taxonomy sections, table of contents, page numbers, footer, headers, etc. For example, content can be added to the original information object without their taxonomy sections or the user can add sections and move the content into the added section. In another embodiment, a complex query can be conducted based on the taxonomy and its metadata, where the multiple query conditions can be searched. In still yet another embodiment, a VIP can be created based solely on a sub-taxonomy and then populated by query and/or manual addition as desired. In still yet another embodiment, the VIP may be created using unique section heading names that may or may not be associated to the taxonomy categories and the user may populate these unique section headings with information objects in the DB Database 102. In yet another embodiment the user may create a VIP with section headings using any information objects in the DB 102.

It should be appreciated that the invention also allows for the information objects 104 to be modified as desired and integrated into the DB database 102 while maintaining continuity of the original information and without having to rebuild the entire VIP 100. One embodiment of this is represented in FIG. 2B, where a VIP 100 and a DB database 102 is shown with a plurality of information objects 104. A modified information object 106 is generated by modifying information in one of the information objects 104. The original information objects 104 are labeled as V1 (for version 1) and the modified information object 106 is labeled as V2 (for version 2). In this case, modifying the original information object 104 (V1) can result in the creation of a modified information object (or a compound object) 106 (V2) in the DB database 102 and the connection between V1 (parent) and V2 (child) version is preserved. This approach can be repeated as many times as desired. It should be appreciated the system may create versions of the original native files stored in the DB 102 database in any desired format (such as XML, HTML, PDF, etc) suitable to create a VIP 100 and such versions may be stored in the DB database and/or be created and reside in-memory to satisfy the desired end purpose.

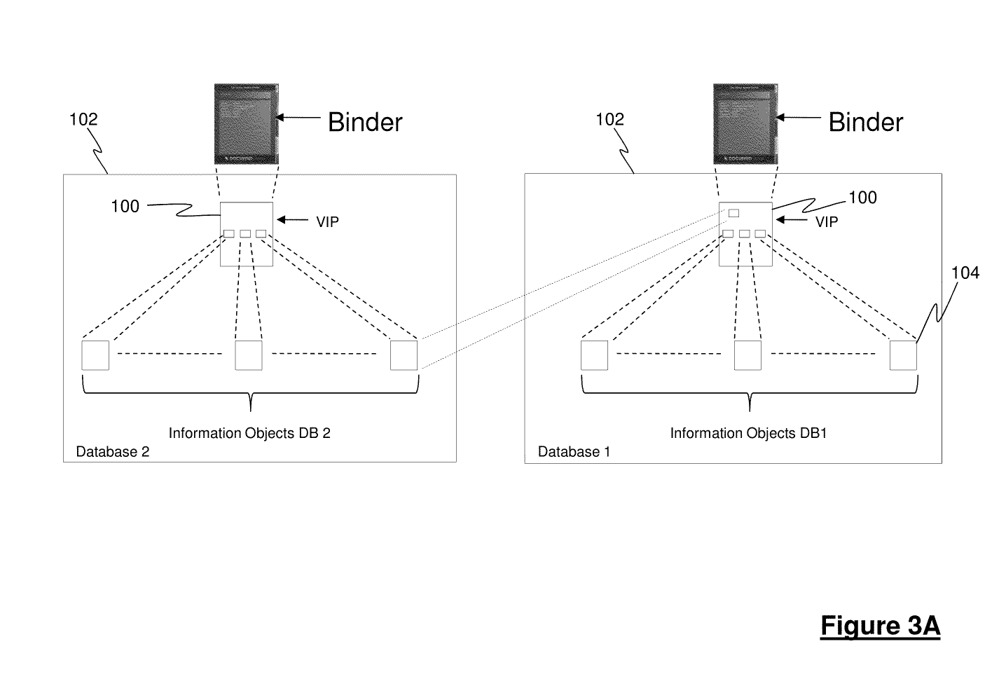

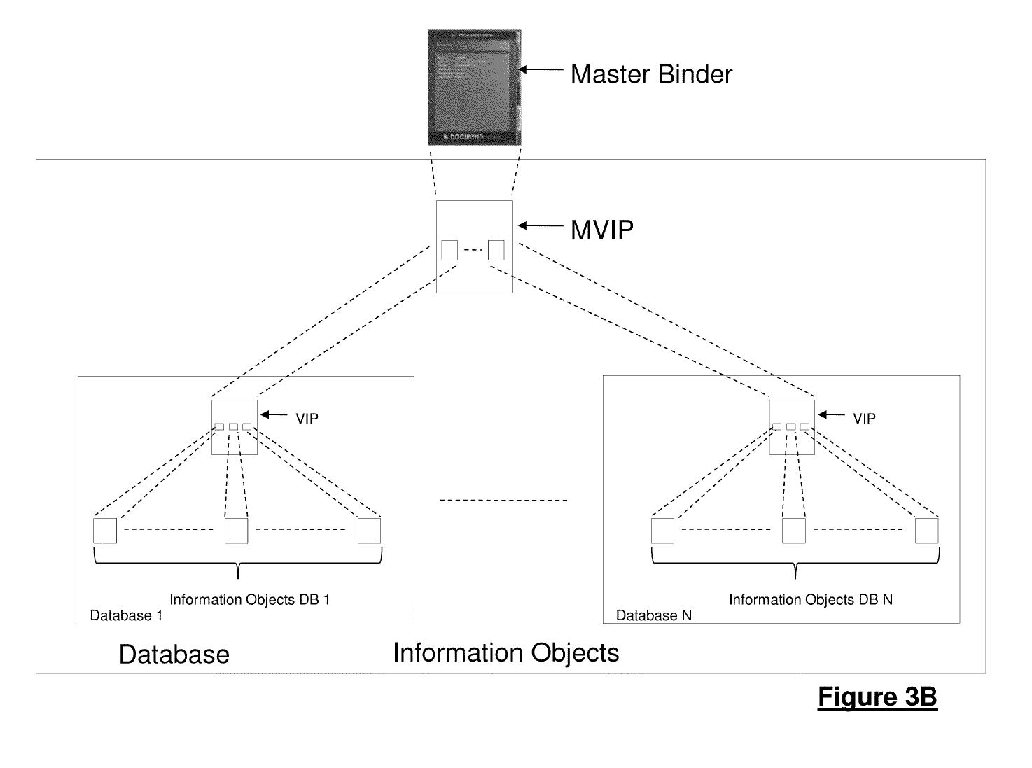

Additionally, it is contemplated that information objects 104 outside of the DB database 102 may also be integrated into the VIP 100 without having the information objects 104 being resident in the DB database 102. This is shown in FIG. 3A, where information objects from a separate database (Database 2) are integrated into the VIP 100 on DB database 102 (Database 1), without being resident in DB database 102.

In this way, it should be appreciated that the present invention provides a system and method for easily managing a collection of EIPs of discreet information objects whereby the discreet information objects may be linked with other discreet information objects or EIPs of discreet information objects and may be stored in a variety of structured VIP's. One of the novel and unique aspects of the present invention involves the ability to combine and edit one or more of these VIPs (and the information objects contained within those VIPs) and to generate a Master VIP (MVIP) as shown in FIG. 3B. While FIG. 3B shows a MVIP created from information objects stored in two separate databases, it should be appreciated that a MVIP may be generated from any combination of information object in separate VIPs in one or more databases. Simply stated, the present invention provides a system and method for classifying and assembling information objects according to a desired unique sub-taxonomy within a content management system (CMS) based on a Master Taxonomy which defines the structure of hierarchically ordered categories (for example, a tree structure). The sub-taxonomy may be easily manipulated to render the desired result. Categories of the sub-taxonomy may be renamed and reordered while maintaining their relationship to the master taxonomy. The invention allows specified information object metadata to be associated with information objects as desired and for information objects to be viewed virtually in their original file formats or converted to any specialized and/or standardized format (PDF, XML) as desired and viewed. Information Objects may be edited and the edited child information objects may be automatically associated with their parent information objects. Additionally, the invention allows for defining certain VIP Elements (such as sections, table of contents, indicia, text, cover sheets, tabs and footnotes) to be dynamically generated by the system and associated with categories and/or their associated objects. It should be appreciated that the invention also allows for the transclusion of information objects, information object groups and/or any other type of content.

In accordance with the invention, a Virtual Information Package Template (VIPT) can be created by selecting a subset of categories from a master taxonomy to form a sub-taxonomy which allows for the generation of a unique VIP, where the content of the VIP may be defined, composed, compounded, manipulated, deleted, added and/or rearranged as desired. In addition, VIPTs may be combined to dynamically create a Master VIPT Template (MVIPT), where a Master VIP (MVIP) may be generated from that template. It should be further appreciated that MVIPs and VIPs may be published as Electronic Documents (EDs) in user specified configurations and formats. Either “MVIP” or “VIP” may be used herein to effect the same operative intent of both terms

It is contemplated that the present invention also provides for unique and novel solutions to the disadvantages briefly discussed hereinabove. For example, with reference to the problem where the current method of VIP and assembly is limited because it is dependent on the file structure method of the operating system. The present invention may allow the user to simply assign the file to a new VIP taxonomy, where the new folder would automatically be created and renamed with a label conforming to its position in the VIP structure (for example, such as, numeric, alphabetical, and/or alpha-numeric). To accomplish this, the content repository may be designed in conjunction with an EIP and assembly method to create an information management system that can handle simple and complex VIPs.

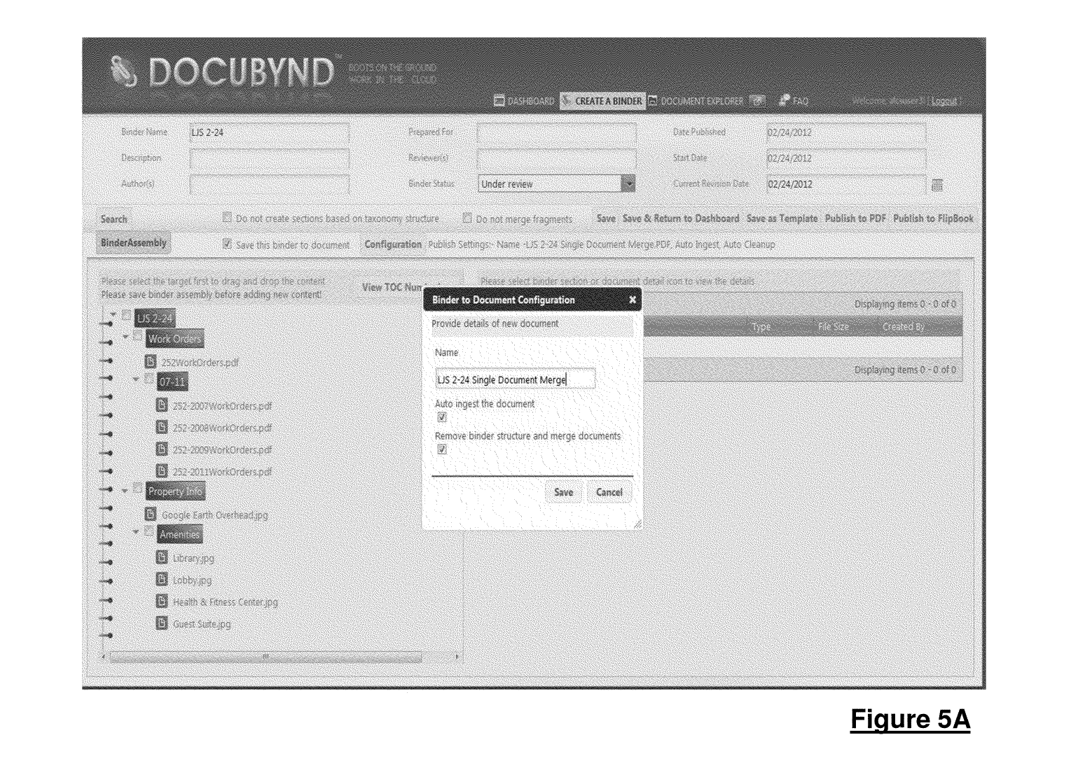

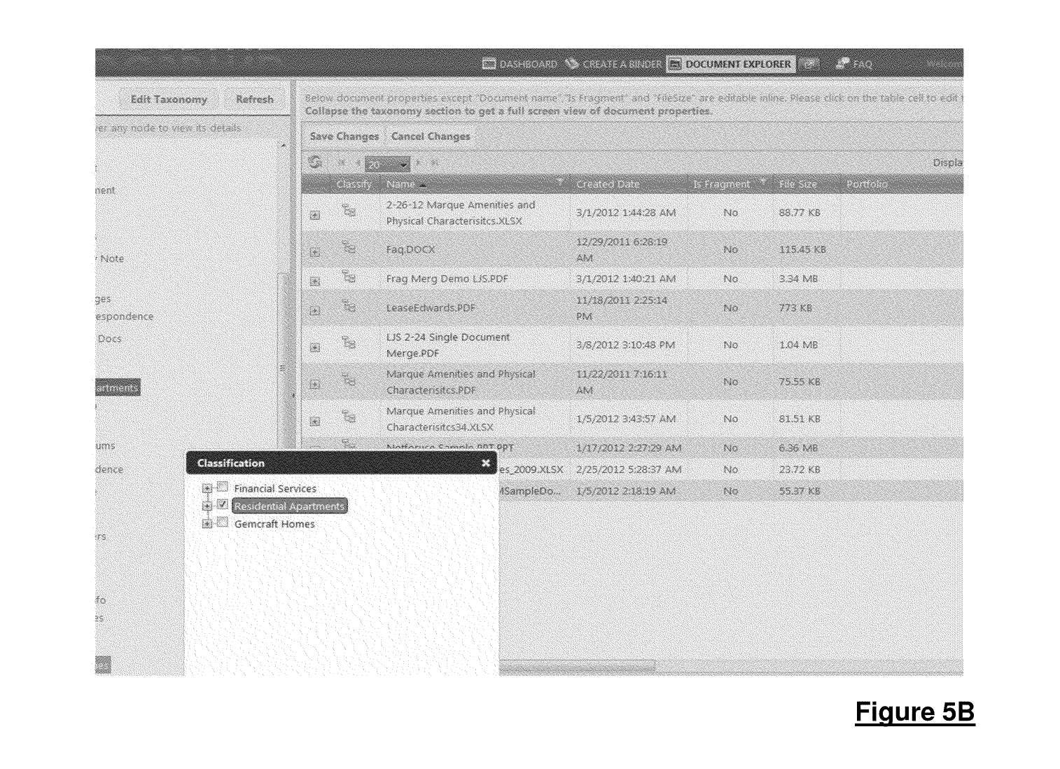

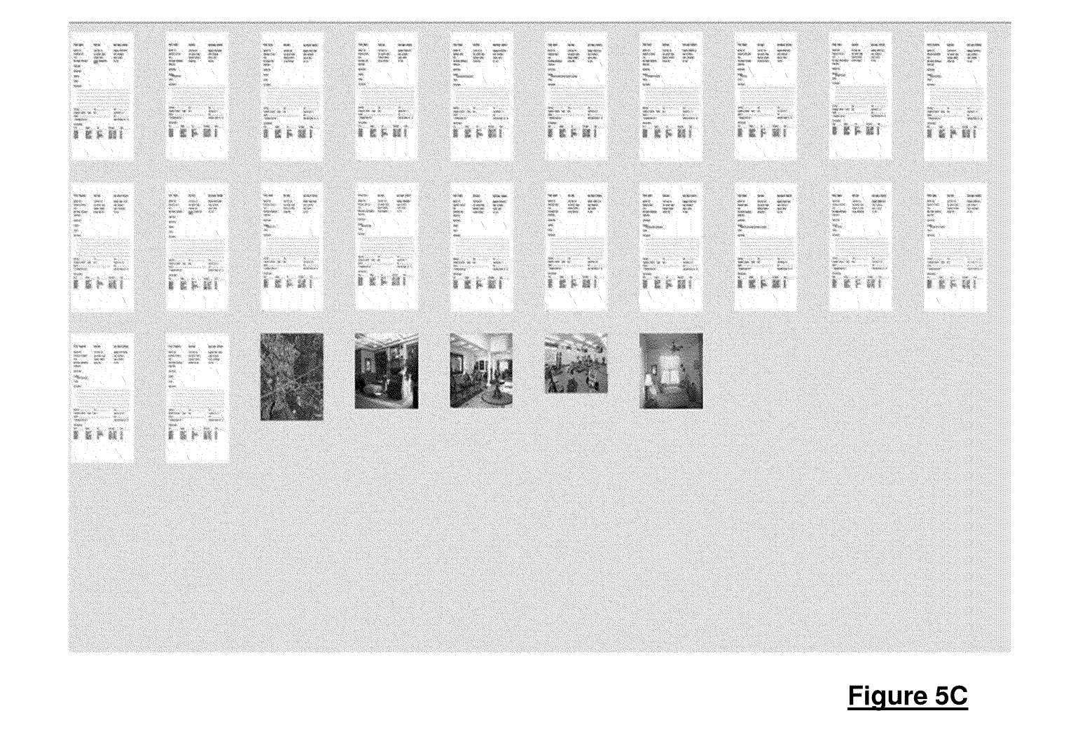

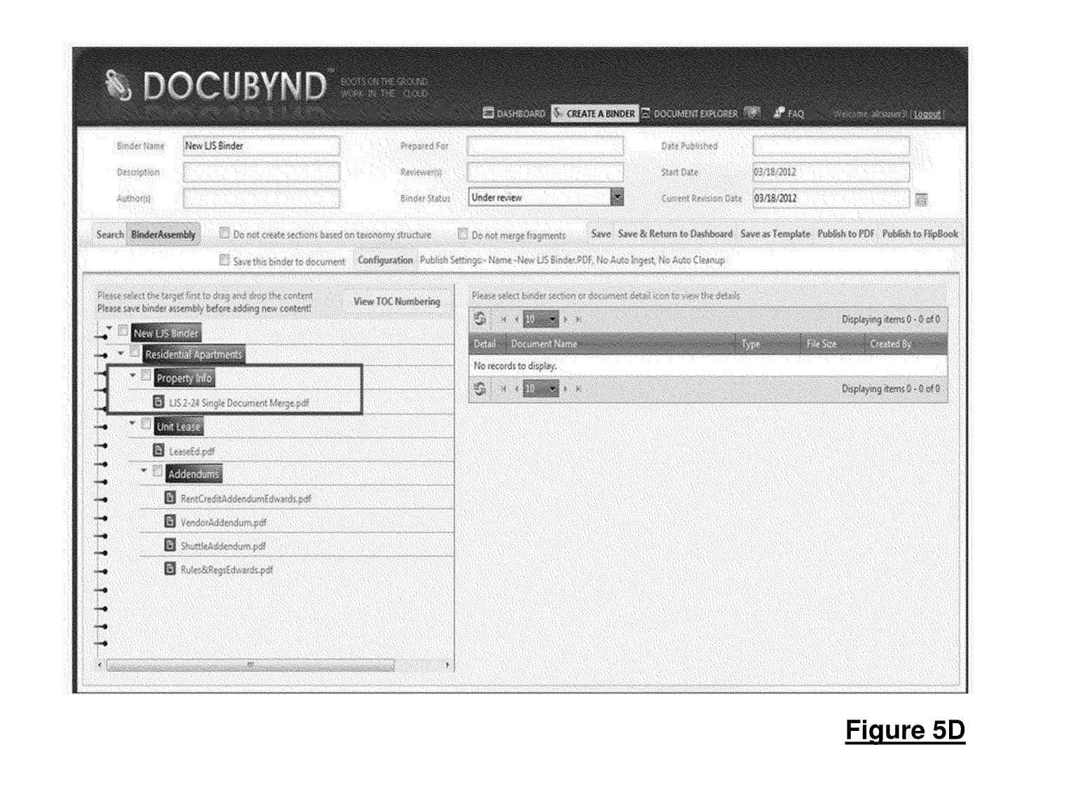

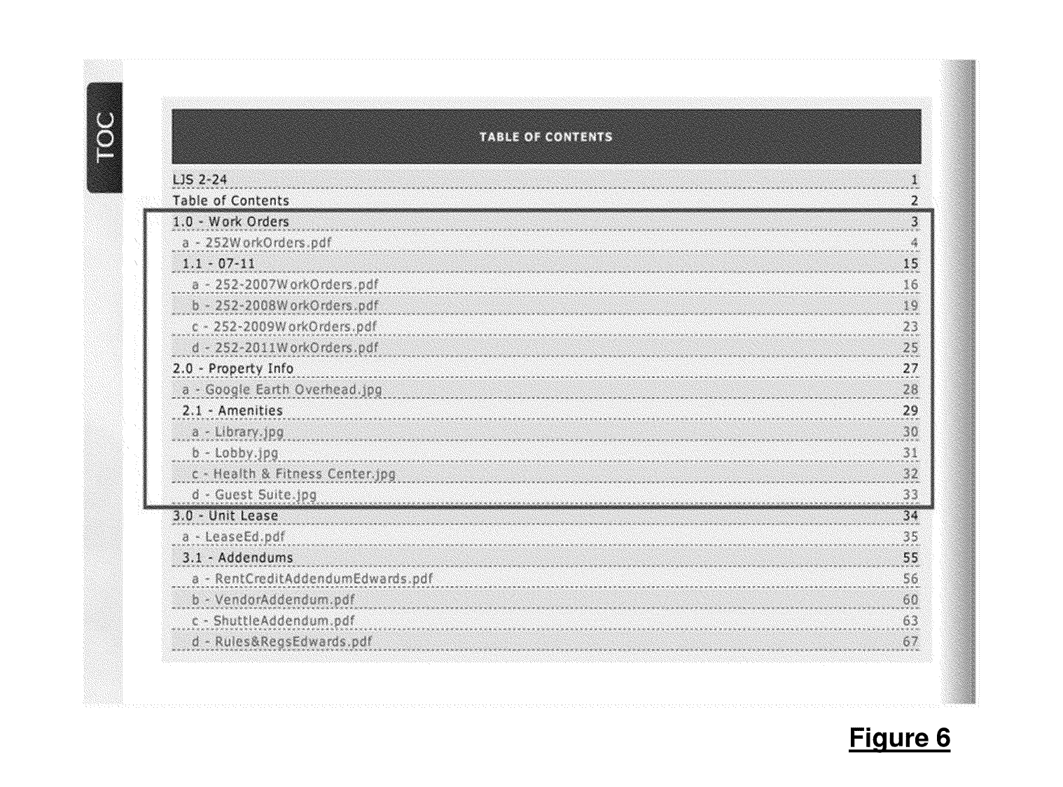

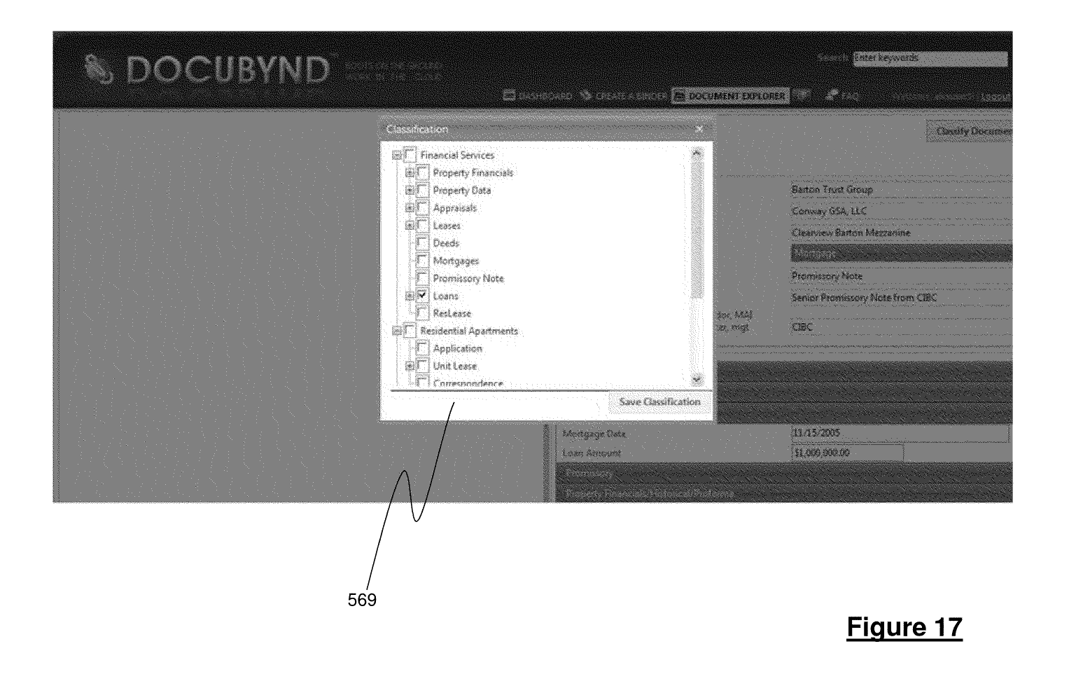

As another example, consider the problem of creating a single file from a group of files within a section or section(s) of a VIP that is overly complex. In this case, the user may be asked to select a group of files, “stack” the files in a desired order to create a single (document) file and then insert the single file into the VIP. The user may then be asked to separate the files back into the original VIP format which would require them to be placed in their original separate folders in the sub-taxonomy and in their original alpha-numeric order (FIG. 6). The present invention allows the user to perform this task, where the user would select the files within the VIP that were already in their proper position in the sub-taxonomy and the system would automatically merge them together to create a single sub-VIP. Then with a single command the system could unmerge them and return them to their prior location and order in the VIP. One embodiment of this method is illustrated in and referred to with regards to FIGS. 5A, 5B & 5C, where in FIG. 5A all the documents in a VIP called LJS 2-24 are selected to be merged together to create a single new document that is published to an ED and automatically ingested into the docubynd system (as shown in FIG. 5B) where the new single document, LJS 2-24 Document Merge PDF may be viewed (as shown in FIG. 5C) and classified as shown in FIG. 17 and then automatically placed in the selected category in the Master Taxonomy.

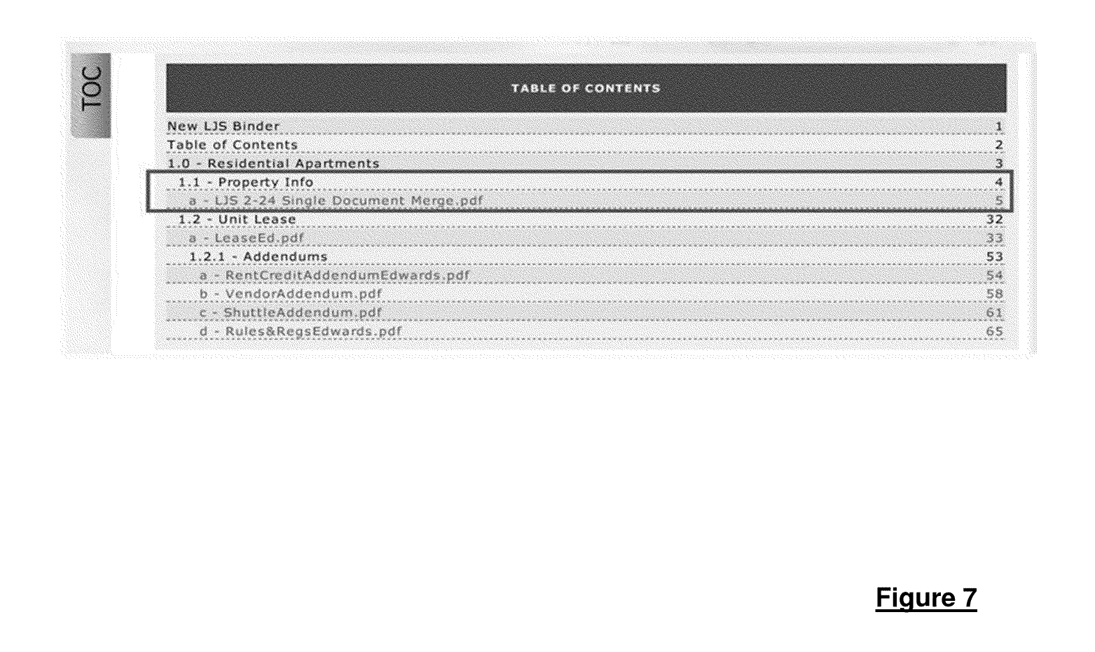

The user may choose to save the new file with or without its VIP Elements. The user may also choose to save the new document to a desired document format, such as MS Word or MS Excel, to a desktop machine, a mobile device, or any other suitable device and/or at any time to have the document automatically ingested back into the DB system and place it in the binder to be reclassified or in a new binder as shown in FIG. 5D. The user may choose the name of the new document and whether to retain or remove the VIP Elements (i.e., header, footers, sections, table of contents, etc.). FIG. 6 shows the documents comprising the single new VIP document 100 in the table of contents (TOC) of the ED with the retained VIP Elements. FIG. 7 shows the single document in the TOC of the ED without retaining the VIP Elements.

In accordance with the present invention, information objects are entered into the docubynd system and stored in the DB database. These information objects may be introduced into the docubynd system using any method or device suitable to the desired purpose. For example, the information objects may be entered into the docubynd system directly from a keyboard, the information objects may be obtained in digital format and entered into the docubynd system and/or the information objects may be created from a hard copy which is scanned into a digital format and then entered into the docubynd system. When a user wants to create a VIP the user organizes the information objects for the VIP as desired. This may be accomplished by selecting the information objects to be included in the virtual VIP and categorizing the information objects using a desired sub-taxonomy. This sub-taxonomy may include categories and sub-categories and may include a category hierarchy (such as via alpha-numeric). When this is complete, the docubynd system may then process the information objects responsive to the desired sub-taxonomy and create a VIP which is classified and ordered according to the specified alpha-numeric hierarchy. In creating the VIP, the docubynd system may generate various information objects and VIP Elements, such as a cover page, document sections, section tabs, section dividers, master table of content and section tables of content. It is contemplated that although the docubynd system may generate a default name for these VIP Elements upon creation, they may be named and/or renamed as desired. Furthermore, the structure of the VIP may be edited as desired, such as by “dragging and dropping” the content as desired.

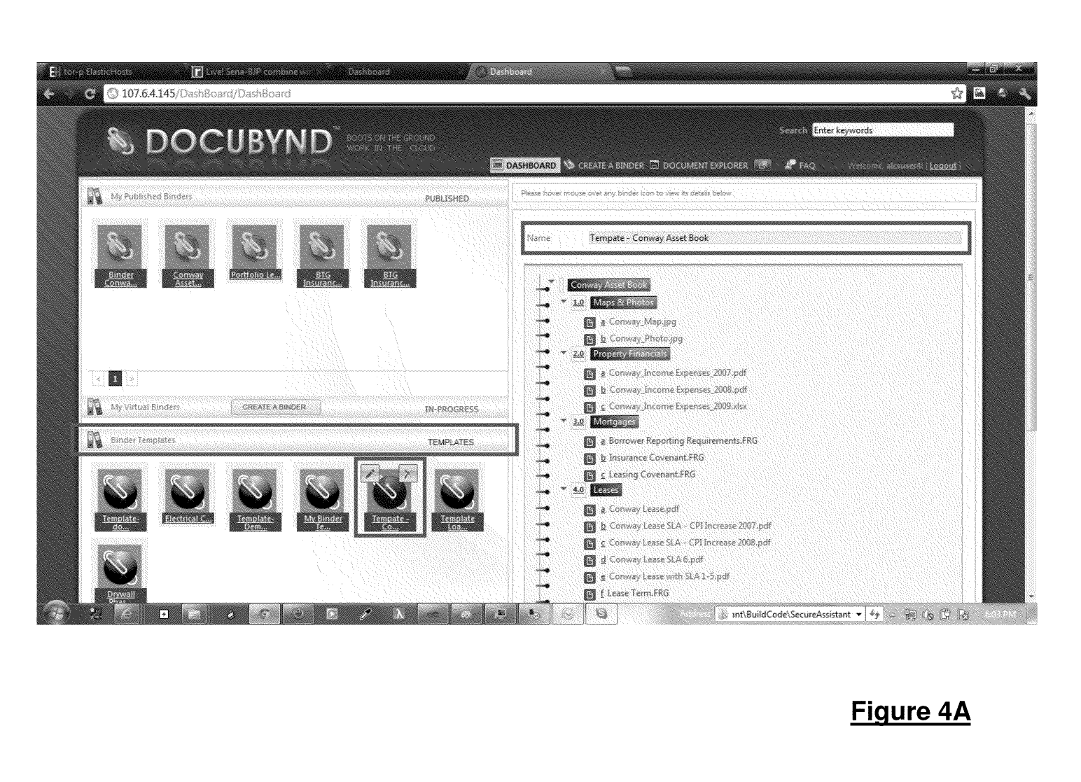

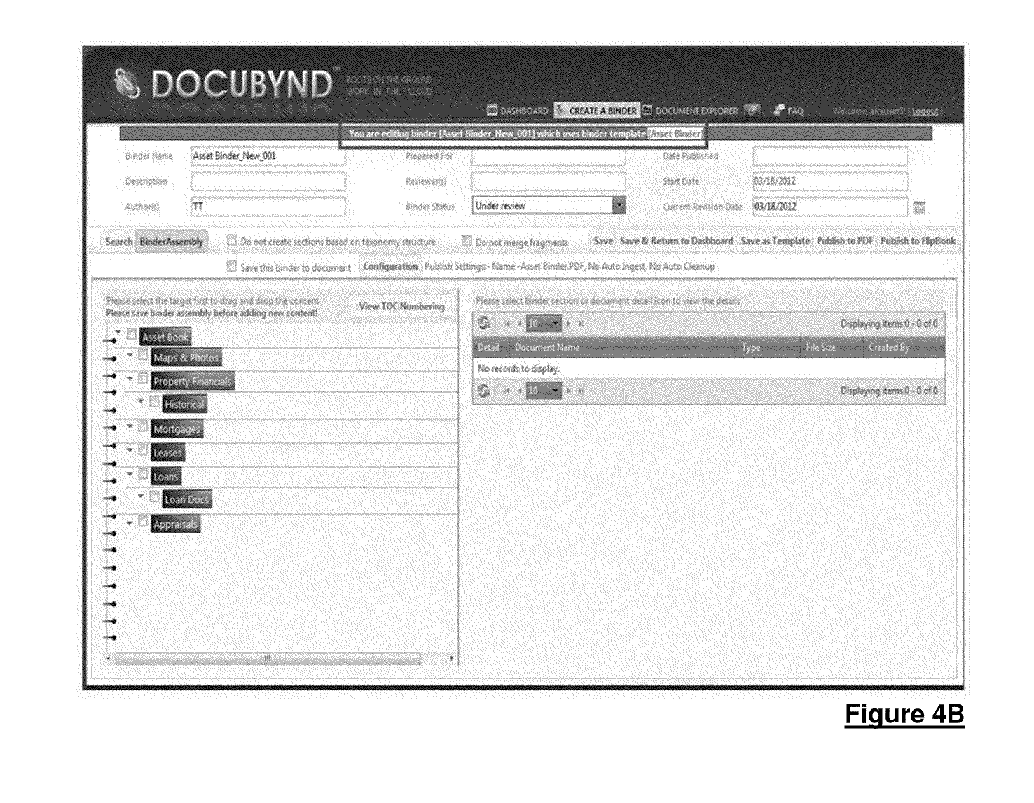

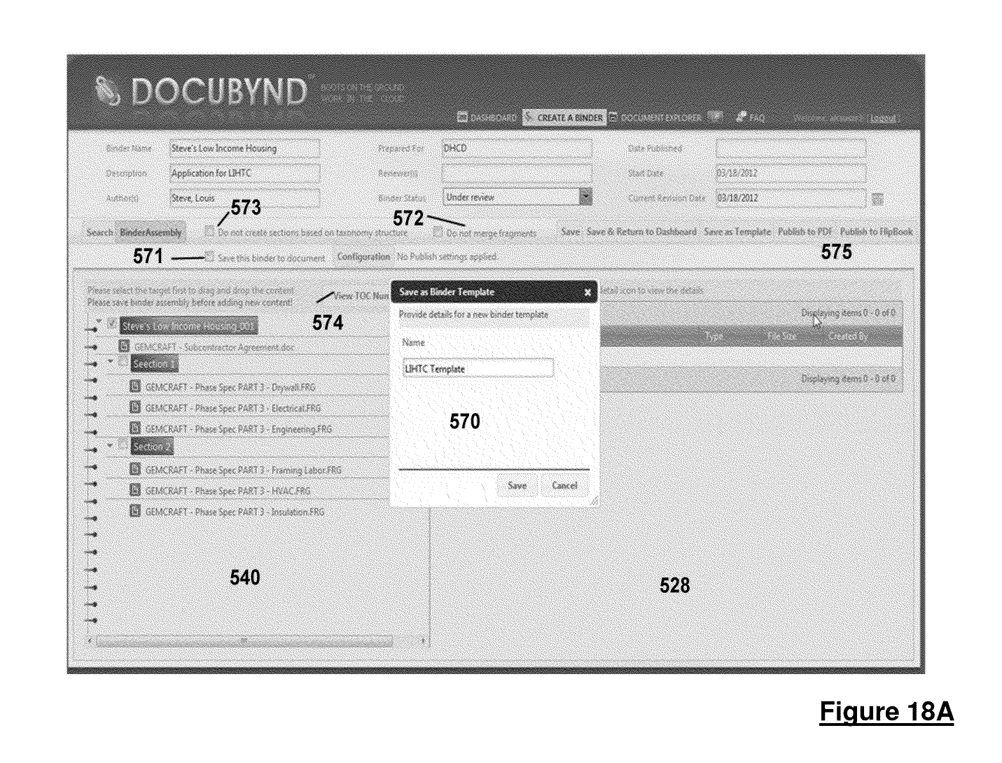

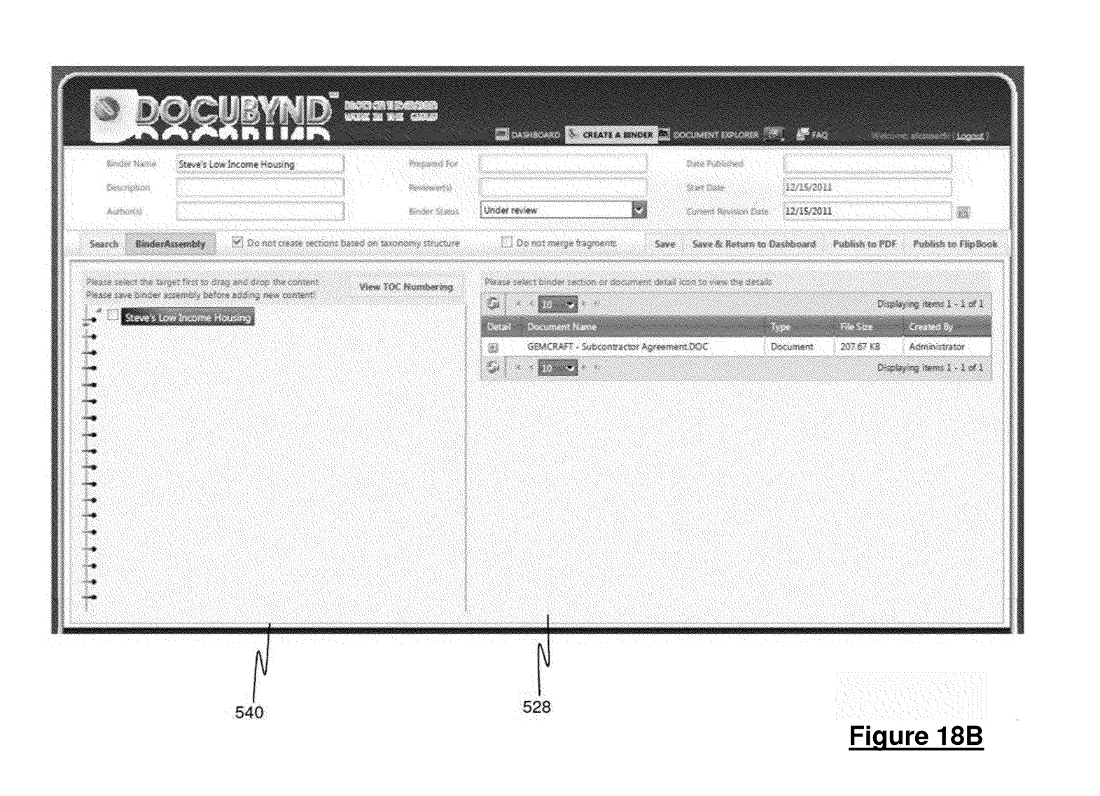

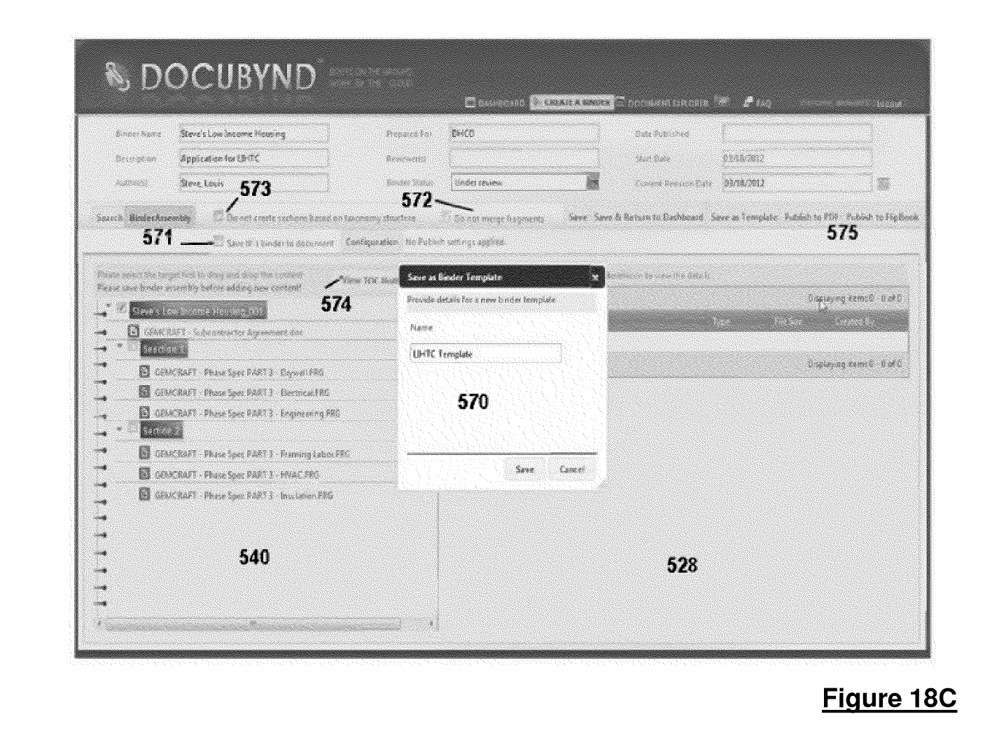

In addition a template may be created from an existing VIP (sometimes hereafter called a VIPT) as shown in FIG. 18A. VIPTs may also be modified to create new VIPTs. VIPTs may be previewed in the Docubynd dashboard GUI as shown in FIG. 4A and the documents in the preview and may be opened, viewed and edited as shown in FIG. 4B, where a version of a VIPT is automatically assigned a new name and can be saved as a new VIP or a VIPT.

The system may further include a GUI user interface to track the comments and revisions of the VIP and perform editing, where a feature of the interface may be to allow the association of comments to their respective categories and sections in the VIP as well as the ability to create a VIP that would contain only comments and revisions. Editing may be performed using the binder assembly to move and/or adjust the location of the objects and/or via a variety of tools currently available to practitioners of the art. Once the VIP has been edited it can be republished and may contain links to the edit history in the VIP taxonomy. It should be appreciated the Docubynd system will also generate reports which may be in table format that will provide the details of the comments, revisions and changes made to the VIP and track their versioning history including links to and from other information objects and VIPs in the docubynd DB system.

It should be appreciated that a collection of VIPs and their content may be stored in a specialized (or generalized as desired) repository in accordance with a taxonomy designed for this purpose. This repository may be referred to as a Virtual Information Package Library (VIPL) and may function as an archive as well as a VIP management platform where VIPs may be manipulated, edited, combined, and revised as desired. One feature of the VIPL is a GUI interface that may allow a user to combine, revise and build new taxonomies or taxonomy revisions that may be used as the taxonomic format for a VIP and may or may not require the creation of a VIP. One feature of a taxonomy revision may include the automatic population of similar categories with the information classified in a prior taxonomy. Another feature may be to create a taxonomy that would only apply to specified VIPTs. Additionally, the VIPL may manage the DB master taxonomies and could contain a master list of all taxonomic sections and their content and may use a drag and drop tool to move content and categories into a sub-taxonomy revision structure. Another feature of the VIPL may include an interface to integrate with third party systems.

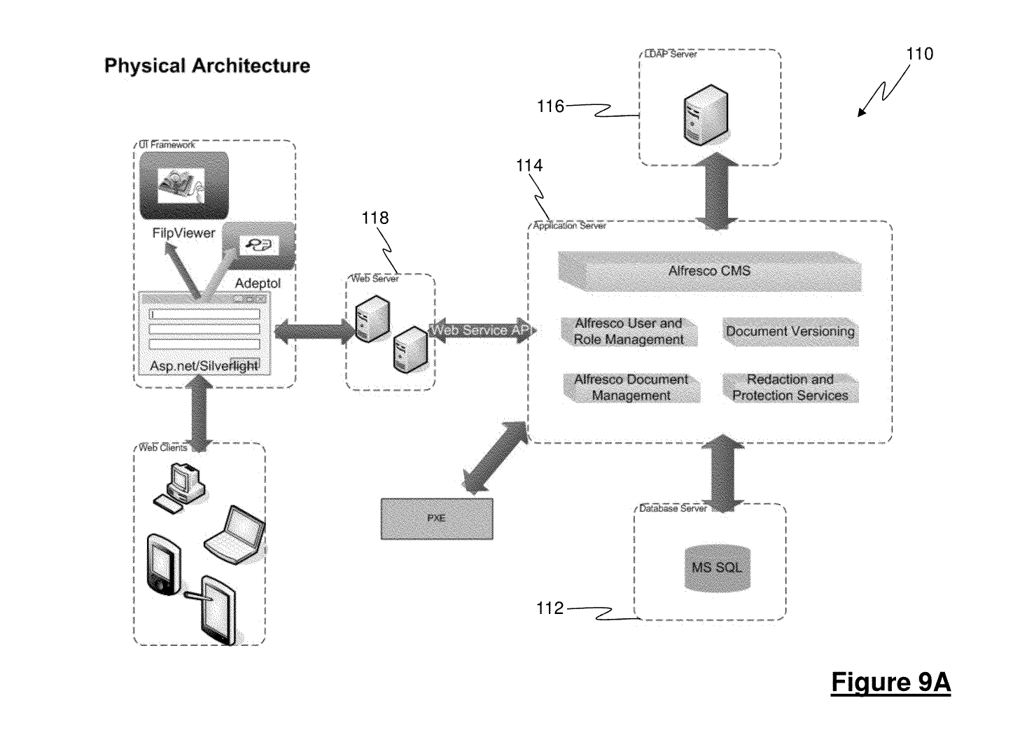

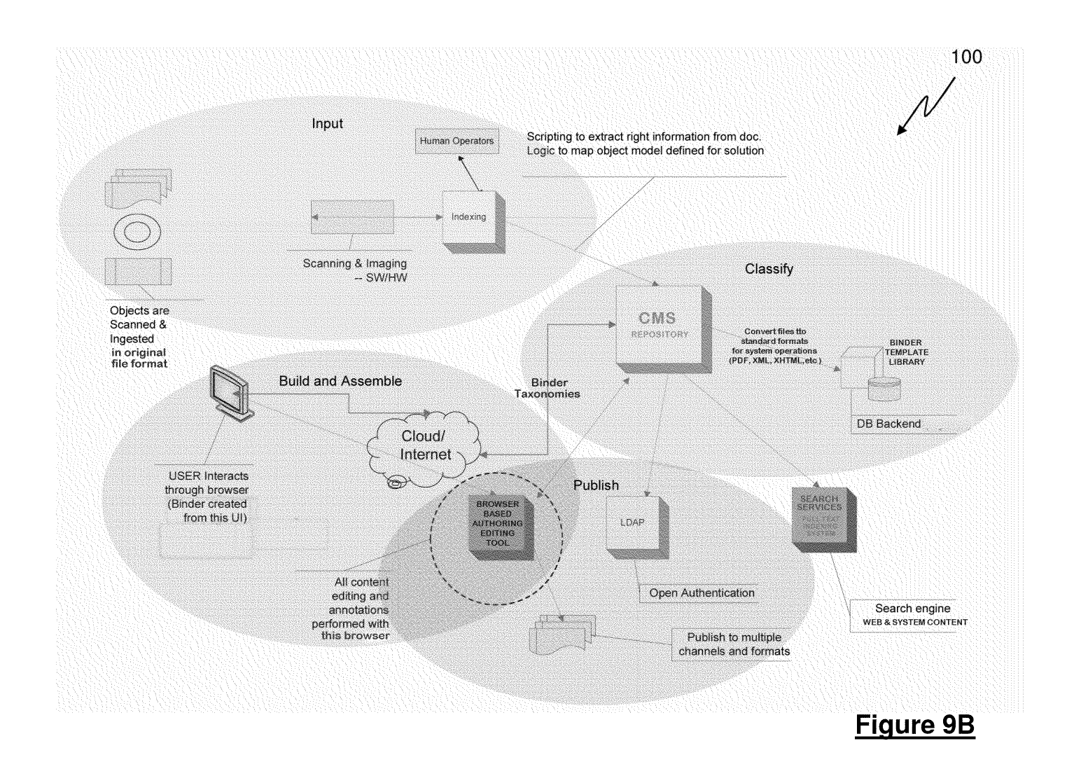

Referring to FIG. 9A, one embodiment of a physical architecture of the docubynd (DB) system 110 is shown and includes a database server 112, an application server 114 configured to implement a file sharing and editing strategy (such as a browser based authoring tool), a server 116 (such as, for example, a Lightweight Directory Access Protocol (LDAP) server and/or a server configured to support LDAP protocol) which may be used to access and manage directory information and a web server 118, where the web server 118 may be configured to implement a UI (User Interface) framework for communicating with web clients. It should be appreciated that the database server 112 may be configured to support SQL (such as MS SQL), but may also support multiple other database formats, such as NoSQL, and Object Oriented Data Bases (OODBs) or any combination of formats without limit. Moreover, it should be appreciated that the functionally of the present invention may be implemented using specialized, non-specialized and/or combined resources. For example, the LDAP server functionality, database server functionality, application server functionality and the web server functionality may be implemented using one (or more) systems and components.

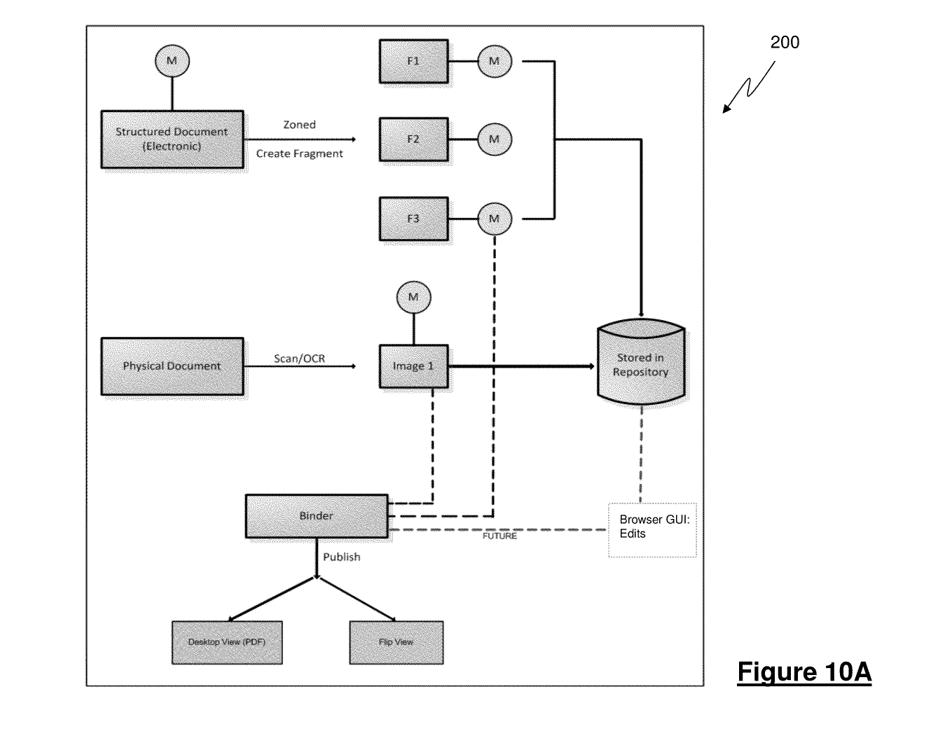

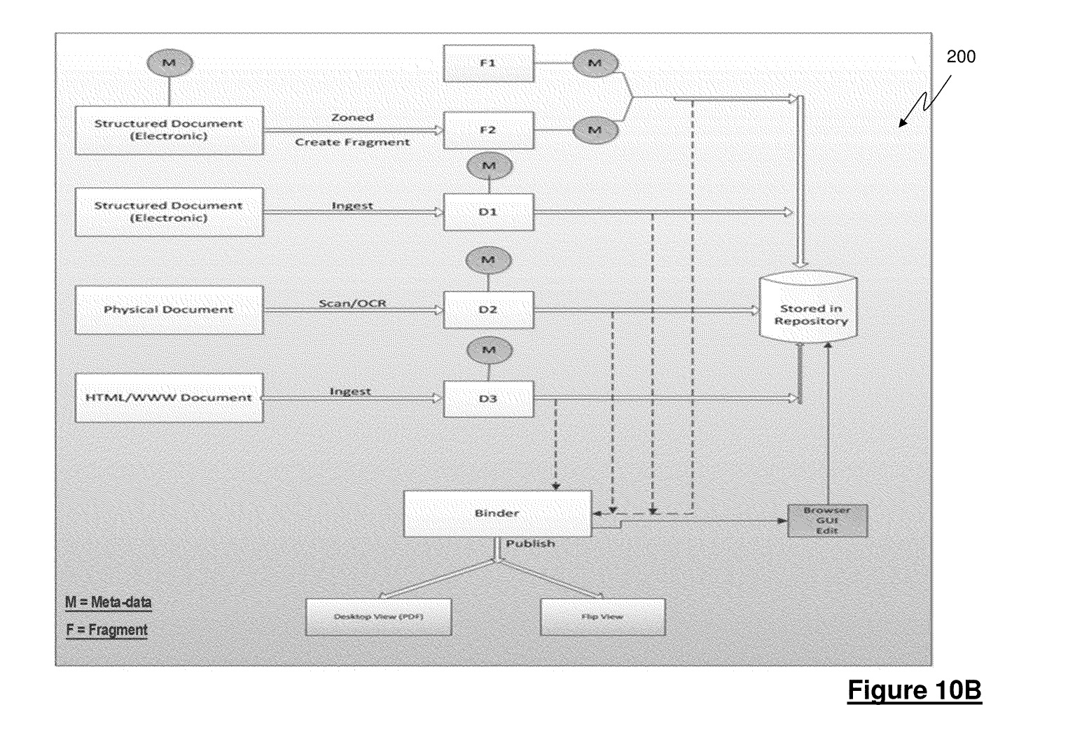

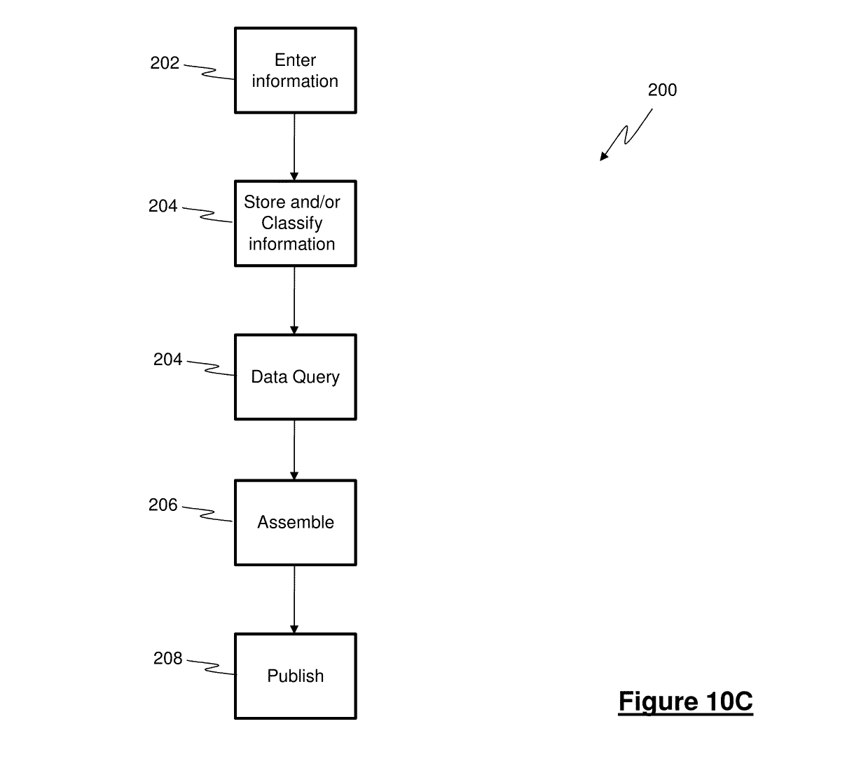

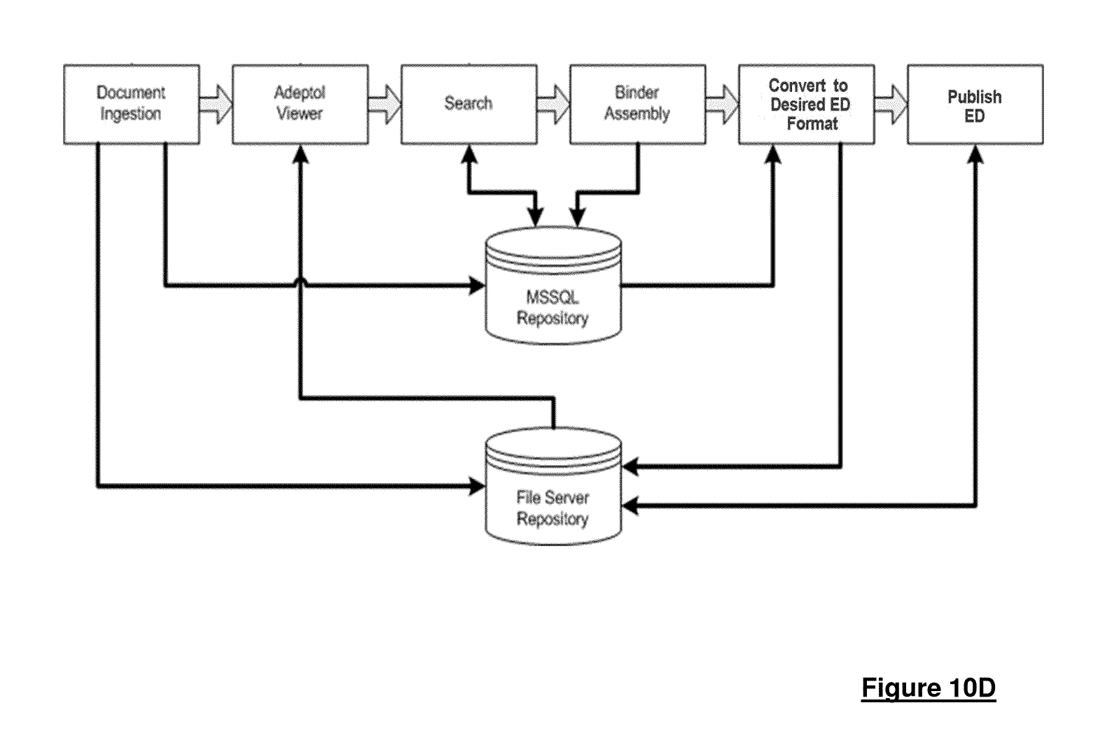

Referring to FIG. 9B, FIG. 10A (the label “M” on 10A refers to “Metadata”), FIG. 10B, FIG. 10C and FIG. 10D, an overall high level schematic diagram and an operational block diagram, respectively, illustrating one embodiment of an overall method 200 for creating a VIP is shown and includes entering or introducing information objects into the docubynd system 110, as shown in operational block 202. This may be accomplished using any method suitable to the desired end purpose and is discussed further hereinafter with regards to at least one embodiment. For example, the information may be entered by importing information objects/documents into the system 110, scanning documents into the system 110 and/or directly entering the information/documents (i.e. typing, recording, video, etc.) into the system 110. When the information has been introduced into the docubynd system 110, the resulting information objects may be stored in a repository (i.e. storage device) and classified, as shown in operational block 204. The repository may contain any type of information object as desired (i.e. video, audio, images, documents, etc.), but typically the repository may contain source documents (in the case of electronic documents, these documents may be stored in their original format or a desired format). In the case of physical documents, scanned images of the source documents may also be stored in the repository. The repository may also contain fragments of documents created during the ingestion/introduction process based on various methods like a template/stencil based operations, manual operating etc. It should be appreciated that the output of this process may be in any form desired, such as XML documents or object classes. It should be appreciated that information object fragments (children) may be associated with their source information objects (i.e. parent). Additionally, the repository may also contain metadata information objects for the information objects contained in the repository as well as information contained elsewhere (such as another repository).

It should be further appreciated that the classification of information objects may establish any number of taxonomies in any hierarchal order and may be accomplished using any method suitable to the desired end purpose and is discussed further hereinafter with regards to at least one embodiment. When the information has been introduced into the docubynd system 110 and the information objects have been stored and classified, the VIP may be built and assembled, as shown in operational block 206. After the information objects have been stored in the repository, a VIP may be created and documents and/or fragments of the information objects may be identified and used to create a VIP which may be published, as shown in operational block 208, in multiple formats (including, but not limited to a PDF format and/or a read-only flip form view) as desired. The content of the virtual VIP can then be edited and/or organized as desired independent of the published ED version. However the published ED version may be automatically updated at any time to reflect the edits in the VIP. The docubynd system 110 enables workflows to be implemented to advantageously improve processing of both the VIP as well as the published ED version(s) and allow the content to be edited, as well as annotated, commented upon and revised, wherein the changes may be interpretatively incorporated in the virtual VIP and the published ED version(s).

It should be appreciated that the selection, arrangement, ordering and/or naming of VIP Elements and Information Objects in a VIP may be accomplished using a query of the DB database and automatically or manually be input into the query format. FIGS. 35A, 35B, 35C and 35D illustrate one example of a query format using a Master Taxonomy/Sub-Taxonomy approach, where a query of 200 individual apartment units is conducted. The query's goal is to identify the apartments that meet the conditions established by the selected meta-data filters 580 in FIG. 35A, that are <=2 bedrooms, <= to 1250 sq. ft. in size, that have rent <=$1875/month, wherein the tenants moved in on or before Aug. 1, 2010 and where the tenants are 65 years of age or younger. The user may select one or more levels of taxonomy 581 to be queried. In this case a single level is selected, Section 3.2, “Units” of Sub-taxonomy “T-1.1.1, Apartments”. The user may also include selected information object(s) in the query such as a data table, in this case the “Units Table” 580 which may or may not be classified in the selected taxonomy level(s). The user may also select the desired alpha-numeric section hierarchy 583 from a list of choices. Furthermore, the user may select the section content which are document types 583 (Lease & Addendum) to be included in each section and the section's alpha numeric format. Additional VIP/ED/binder structure formatting may be performed to include and/or not include VIP Elements such as section cover sheets or other data such as query information. The Section Names 585 may be entered by their meta-data query source 584 (i.e., Document Type, Meta-tag, Taxonomy) or “New” if it is a unique name that is not already in the system. Section Names may be concatenated from top to bottom by adding additional section meta-tag names beneath the meta-tag name at the top of the input column. For example, if meta-tag “Tenant” is inserted in the cell below “Apt#” the resulting section tab would be labeled “1A Smith” in accordance with the query results in FIG. 35B and as depicted in FIG. 35C 590 and FIG. 35D 591.

It should be appreciated that the system can be programmed to default to any source section name or alpha/numeric ordering if none is entered. For instance, if the Document Type (“Doc”) 585 was not entered by the user as the Source for the Section Name in Sections 1.1 and 1.1.1, the system could be programmed to automatically enter the Document Type (“Doc”). From the query results shown in FIG. 35B, a user interface (UI) may be automatically generated to construct the resultant VIP/ED/binder.

Furthermore, the query results can be manually or automatically arranged in the desired format to depict the Binder Structure 586. For instance, in this case the Section Names are shown first (from left to right) in hierarchal order and highlighted in grey. However, they may be arranged as desired. The user may select a filter by which apartment (i.e., 1A, 2B . . . ) results to include 587 in the VIP/binder by checking the applicable cell. Additional information 588 about the data set from which the query results are derived may be calculated and displayed. In this example the number of documents are shown 589 in the column for each document type and associated to each apartment. The user may select the applicable cell to view a list of the documents and then select any document to view the document. It should be appreciated that the entire query result or any cell or group of cells in the query result may be hyperlinked, embedded or compounded in any document in the docubynd DB and/or other data sources and be similarly and/or interactively enabled to view a desired set of meta-data. As shown in FIG. 35C the user may create a binder using the VIP/binder in the “Create a Binder” GUI and make the desired changes to the binder structure in the binder assembly as previously described. The query inputs and results may be automatically updated upon saving the binder. The binder is named (in this case the binder name is “Selected apartment query”) and saved and may then be published to an ED. An example of a table derived from the query results is shown in FIG. 35C which shows the resulting ED's table of contents which includes the query result as well as the section tabs 591.

The generated UI may then be manipulated to produce the desired section headings 591, retrieve additional metadata, reorder the VIP taxonomy, assign alpha-numeric section headings, add section headings based on metadata and otherwise render the VIP as needed and/or desired.

It should be appreciated that any method for electronically introducing information into the system may be used suitable to the desired end purpose. For example, it is contemplated that a physical document may be introduced by scanning the document into an electronic format (such as any standard file format e.g. PDF, Word, Excel, images, etc.). Accordingly, the documents may be uploaded and processed using Optical Character Recognition (OCR) software and/or the documents may be uploaded by scanning a document into the system into various formats of images, for example Tiff, JPEG or PDF. Additionally, the documents may contain tables and pictures in addition to text that may also be extracted into separate files upon entering the docubynd system 110. It is contemplated that the docubynd system 110 may be configured to accept and operate with new general and specialized (such as industry specific data formats) data formats as well. It is also contemplated the docubynd system 110 will provide specialized ingestion tools to expedite the organization of the content to be introduced into the system 110. These tools may provide for the formatting of taxonomies and offer a means to assign different levels of metadata detail to specified classes. These tools may reside concurrently on the user's desktop, a mobile device or any other suitable device and the docubynd system 110. Specialized “hot” folders may be installed on the user's desktop machine to automatically transfer the new or revised content into the docubynd system 110. Any combination of storage media capable of communicating with the docubynd DB system may be used and synchronized so that all information objects and revisions are updated concurrently on any number of devices.

It should be further appreciated that in one embodiment the docubynd system 110 may be configured to conduct an online search (i.e. internet, specialized database, etc . . . ) for information based on information (or information parameters) contained within the repository (or specific search queries). When information is identified, it may be set aside for further inspection or inclusion into the repository. If desired the docubynd system 110, 200 may be configured to identify and compare information with information objects in the DB database to prevent information object duplicates.

Moreover, the uploaded content may be classified into an available taxonomy that may be created based on various factors, such as the document type and/or document metadata. Thus, content (documents and/or specific information in documents) that is uploaded into the docubynd system 110 may be tied to an appropriate classification hierarchy. This advantageously allows for custom document types and/or content types and versions thereof which may also be based on unique metadata sets. As such, custom document types/content types may be created in the system and made part of the classification even while uploading the document. It is contemplated that custom document types/content types may be of any types suitable for the desired end purpose and may be based on the particular application or purpose. For example, for information that has application in the area of Real Estate, the custom document type/content type may be typed as a Contract, a Deed or a HUD statement.

It should be further appreciated that the docubynd system 110 may be configured to allow for the manual input of metadata and/or the automatic extraction of metadata associated with the uploaded information based on a set of rules and/or desired parameters, such as content type or document type (See FIGS. 35A-35D). Furthermore, it is contemplated that the docubynd system 110 may be configured to allow metadata that is associated with the uploaded information to be edited (i.e. add metadata, subtract metadata, modify metadata). This is advantageous in situations where the metadata that is extracted is not sufficient and needs to be augmented, enhanced or more clearly descriptive. Accordingly, additional metadata may be added to documents/information objects after the documents/information objects have been initially classified (in fact, throughout the life of the document/information). Moreover, text, images and other information (in any format desired) object fragments may be extracted out of the documents/information objects that have been introduced into the docubynd system 110. It should be appreciated that the docubynd system 110 may be configured to allow the contents of the documents/information objects retrieved and automatically inserted into a newly created VIP based on a query of various parameters, such as keywords, file names, content, metadata and/or any other desired parameters. Moreover, the docubynd system 110 may provide the ability to have custom filters based on the desires and/or needs of a user (for example, custom document types).

It should be further appreciated that after the documents/information objects have been uploaded into the docubynd system 110 and the metadata is extracted, the docubynd system 110 may generate and/or provide the allowed classification/taxonomy that can be applied to the resulting information objects. Moreover, information object metadata can be used and can be created and associated with the information objects at run time or they can be applied from existing information object metadata.

As mentioned briefly hereinbefore the docubynd system 110 provides a method to design object class models which may be defined as desired (such as by using concepts like class, generic function, message, inheritance, polymorphism and/or encapsulation) that separate parent objects such as a “contract” document into its child objects such as paragraphs, sentences, or other metadata. These child objects or “fragments” may be created from any available information object(s) (such as an open text document) by selecting the information object(s) (i.e. any piece of a document, like a paragraph) and storing the selected information object(s) as a separate and new entity (fragment), where the new entity (fragment) may be treated as any other information object type in the docubynd system 110. It is contemplated that other methods for accomplishing this task may be used as well. Referring to FIG. 11A, one embodiment for creating a fragment is illustrated and involves opening a ‘parent object’ and selecting text in the ‘parent object.’ The create fragment tab is then selected which opens a ‘create fragment window’ with the selected text. The fragment is then created by selecting the create fragment tab on the bottom of the ‘create fragment window.’

The system may also provide a method of tracking and storing versions of the parent and child objects that may be changed. For example, if a document is contained within the repository and is opened, a portion of the information contained within the document may be selected and saved as a separate and new entity. This entity will be treated like any newly added document/information (there may be metadata associated with the fragment or metadata may be created). As discussed hereinafter with regards to VIPs, when a fragment is included in a VIP 100, the VIP 100 may contain a copy of the content of the fragment. The fragment's life cycle may be managed independently and may or may not get refreshed (automatically or manually) when the parent document is modified. However, if desired the source document (i.e. parent document) can be tagged with markers associating the fragment(s) with the source document (parent) and this would allow for an update to be performed. An embodiment of this tagging, marking and tracking process is shown in FIG. 11B where fragments of the source documents are marked with a file extension .FRG and the parent source document can be viewed by selecting the parent source document link in the binder in FIG. 11C to view the fragment in its location within the source parent document in FIG. 11D. A tracking method is shown in FIG. 11E where all the binders in which the fragment is associated are listed and the name of the parent source document and other document properties are shown in FIG. 11F.

An important feature of the docubynd system 110 is the ability to merge a group of fragments in VIPs to create a single document that may be viewed in the published ED. Since the fragments may in many instances be less than one page, an important benefit of this feature reduces the number of pages in the VIP 100 or the published ED. The merged fragments retain their original file format and provide a link to the source (parent) documents in the DB database 102. An embodiment of this feature is where the fragments marked with the file extension .FRG in the binder assembly shown in FIG. 11B are automatically merged in the published ED in FIG. 11C unless the user “checks” the box “Do not merge fragments”.

In accordance with the present invention, the docubynd system 110 may be configured such that information objects like documents and/or fragments may be selected and introduced into a new VIP file for the creation of the VIP file via select/copy/paste and/or via a drag & drop process. Additionally, a VIP 100 may be created through the selection of documents and/or fragments of a document by selecting content which matches to the defined taxonomy.

It is contemplated that the docubynd system 110 may be configured to allow the content of the VIP 100 to be viewed and edited online in real time as a programmable object in memory, as shown in FIG. 9B, (one embodiment may use a development tool, for example such as Silverlight that may be used as an application framework for writing and/or running rich Internet applications) FIG. 10A, FIG. 10B, FIG. 10C and FIG. 10D using a browser based (or non-browser based) authoring and editing tool without the need to publish the VIP in an ED format. A GUI may be provided and supported by a browser (show reference) that allows the user to view, preview and assemble the VIP 100 in memory from the DB database in a variety of formats and window screens, multiple page view formats and thumbnail views. It should be appreciated that the browser may support the ability to make a variety of queries, edits and revisions and distribute the VIP 100 using workflows designed for the purpose and installed in the docubynd system 110 for comment, review and approval by persons granted permission to do so. The VIP 100 may be previewed at any time after the editing process is completed and a record of the changes that were made may be viewable.

In accordance with the present invention, the VIP 100 may include different VIP Elements such as tabbed sections, divisions, Tables of Content (TOC) and subdivisions. Moreover, sections and subdivisions may be added as desired and the number of sections and subdivisions may be defined, unlimited and/or limited. Additionally, VIPs 100 may be saved for future use or converted to a MVIPT or VIPT. Moreover, VIPs 100 may be configured and/or distributed and viewed in various modes to just show sections, TOCs, information object groups including document types, fragment groups, and/or any combination of sections/information that may be desired depending on the desires of the user and the TOC may automatically reflect the revised alpha-numeric ordering. For example, two modes in which a VIP may be viewed are; a TOC view that allows for quick glance viewing (See for example, FIG. 35D); and, a configuration view which allows for viewing of different select pieces of information objects in the content. When viewed in the TOC view, the contents and organization of the contents are quickly viewable. In this mode, the structure of the VIP 100 may be reorganized as desired and the documents/fragments of information objects may be edited, inserted or removed into/out of the VIP 100 (such as via drag & drop and/or cut & past, etc . . . ). All or only select pieces of information objects may be viewed as desired.

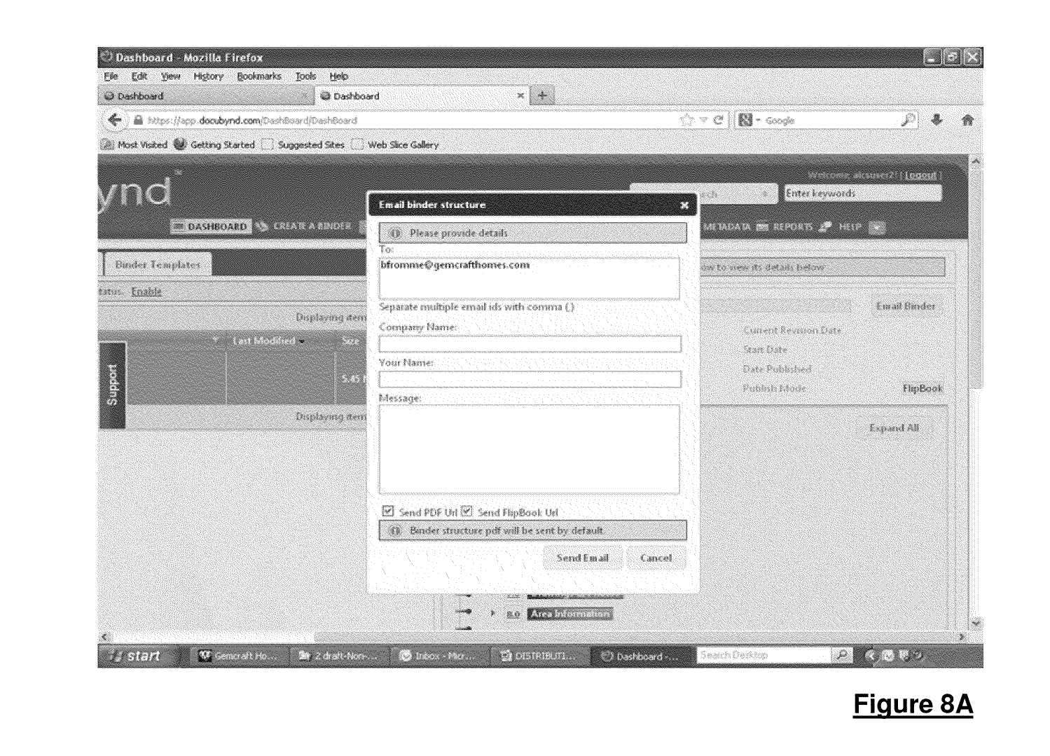

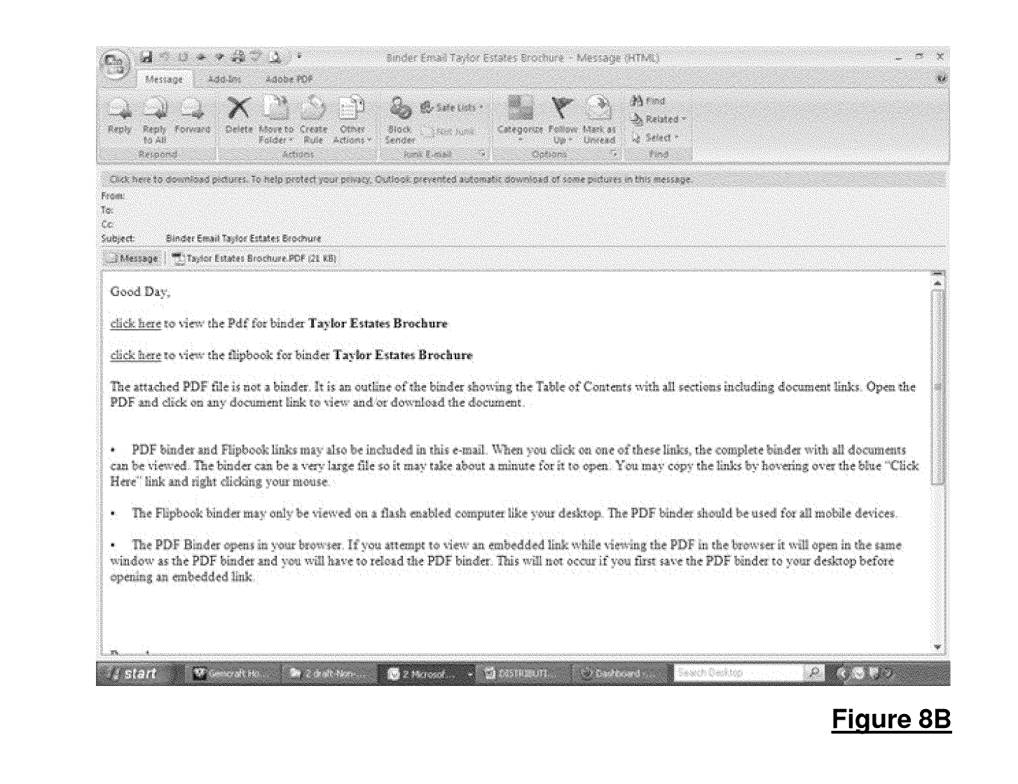

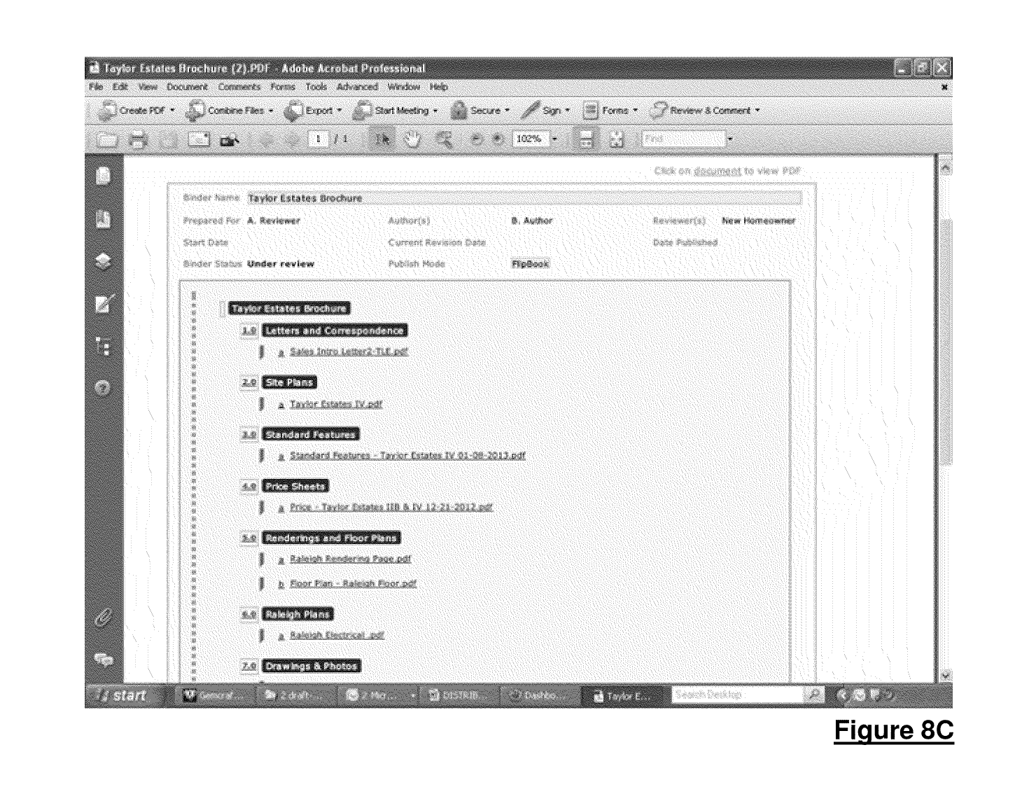

It should be appreciated that, in one embodiment, the resultant binder may be distributed by email (or other method, such as website link) by either a URL link to a PDF or flipbook or as a table of contents (TOC) attachment. The PDF or flipbook URL link may download and display the entire binder (or sections of the binder as desired) on the users viewing device. For example, referring to FIG. 6, FIG. 7, FIG. 8A and FIG. 8B, when the resultant binder is created the TOC may be distributed to individuals that require access to review the objects used to create the binder. The TOC includes hyperlinks to the information used to create the binder. It should be appreciated that one of the unique features is that the binder TOC can be included as an attachment which has hyperlinks to individual documents. Clicking on the hyperlink will open a docubynd document viewer and provide access to the data used to create the binder to users outside of the docubynd system. Accordingly, the resultant binder is distributed simply by distributing the TOC (For example, refer to FIG. 8C).

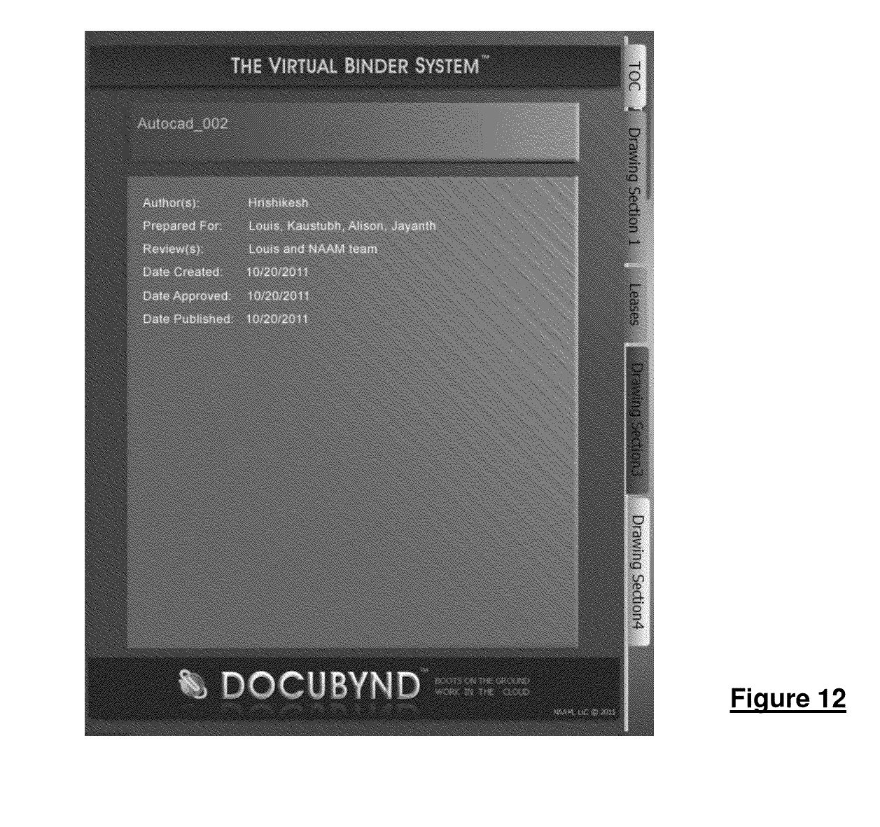

Furthermore, referring to FIG. 12, the docubynd system 110 may be configured such that the contents of a VIP 100 may be viewed in any ED output format or mode desired, such as a read-only mode (such as in a flip view fashion which allows a user to “flip” through the information page by page). Accordingly, in one embodiment, the docubynd system 110 would allow users to preview a VIP 100 using flip view. It should be appreciated that the VIP 100 may be published when viewed in the flip view mode if desired. Additionally, it is contemplated that the VIP 100 may be published in an ED format such as ePub or SWF using a Flip Viewer, or the VIP 100 may be published for viewing on the user's desktop, a mobile device or any other suitable device in an HTML, PDF, or any other format so desired. Furthermore, the VIP 100 may be viewed in various other multiple formats. It should also be appreciated that access to the ED may be granted using a method of workflows and permissions where users are restricted to view only certain documents, or VIP Elements. For example a user who may be an environmental engineer may only be permitted to view and comment on the Environmental; Reports section of a Loan Closing binder that has twenty other sections.

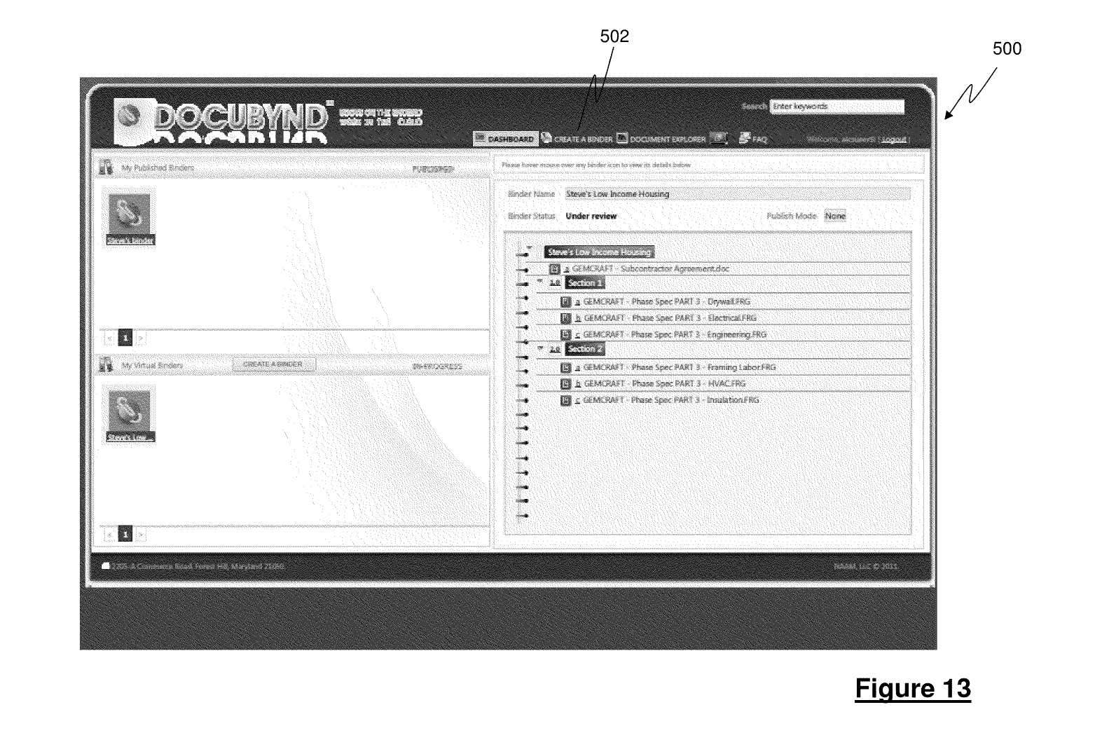

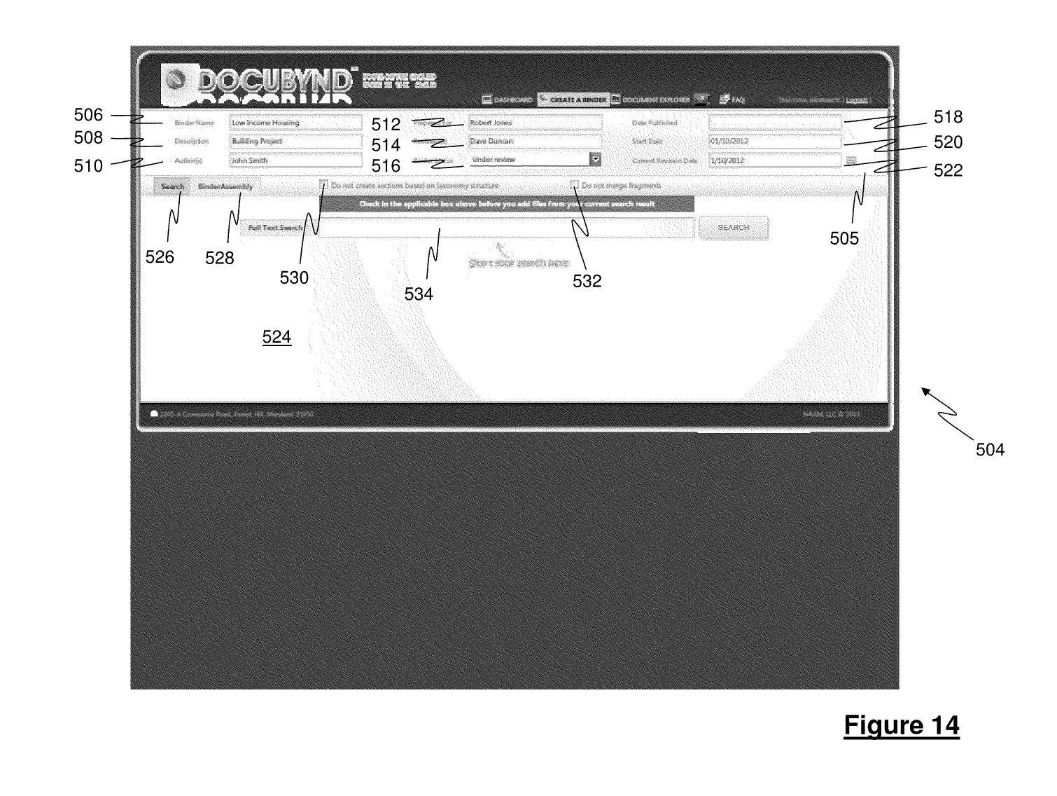

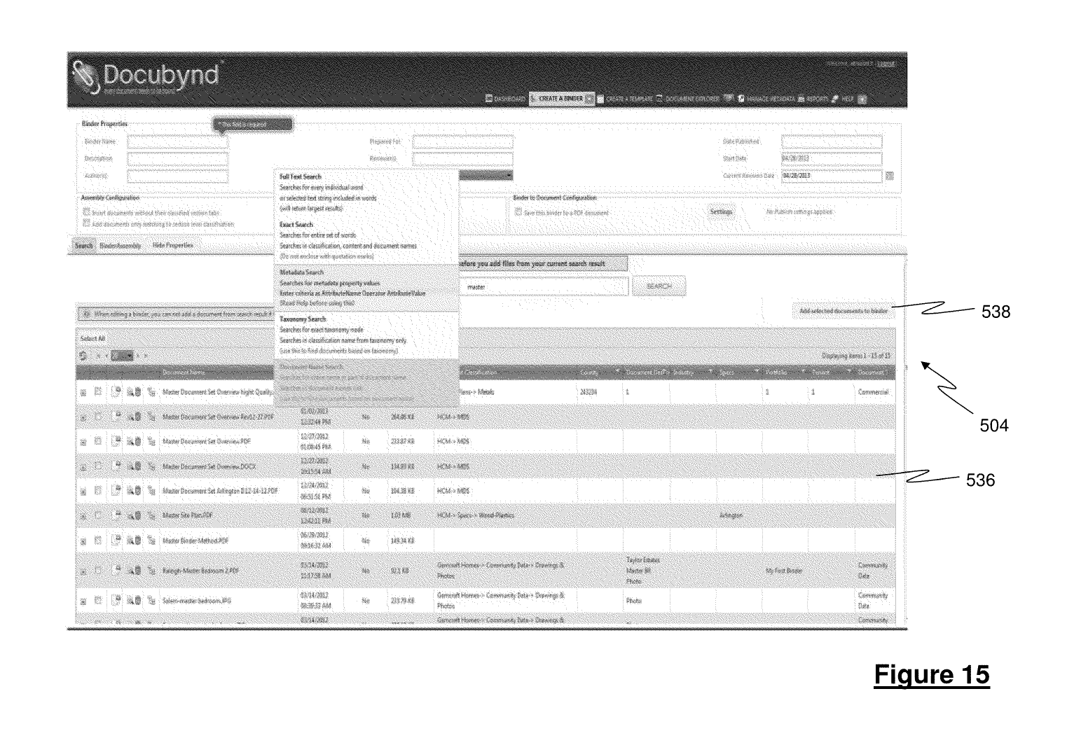

In accordance with one embodiment of the invention, the method of FIG. 9A, FIG. 10A, FIG. 10B, FIG. 10C and FIG. 10D as described herein is illustrated with regards to the following example. It should be appreciated that for purposes of this example, it is assumed that all desired content that is to be used in generating a VIP 100 has already been entered into the docubynd system 110, stored in a repository and classified as information objects. Referring to FIG. 13, to create a VIP 100, a user will access the docubynd system 110 via a main Graphical User Interface (GUI) 500 (also referred to as the “dashboard”) which lists any published and/or VIPs and VIPTs the user may have already created. The user could then select the “Create a Binder” link/button 502 or create a binder from a VIPT which will display a binder information page 504 where the user may enter information about the binder into the respective information fields. One embodiment of a binder information page 504 is shown in FIG. 14 and includes an information field section 505 which may have a binder name field 506, a description field 508, an author(s) field 510, a prepared for field 512, a reviewer field 514, a binder status field 516, a publication date field 518, a start date field 520 and a current revision date field 522. Additionally, the binder information page 504 includes a document section 524 having an information search section 526 and a binder assembly section 528. Also, there may be selection fields 530, 532 which gives the user the option to create (or not to create) sections based on a taxonomy structure and/or the option of merging fragments of information objects. As shown, when the search section 526 is displayed, there is a search query field 534 which allows the user to search the repository for desired information object to be included in the binder. All of the documents that satisfy the users search query are identified and displayed below the search query field 534 in the document display section 536, as shown in FIG. 15. The documents that are to be included in the binder are then selected for inclusion into the binder. This may be accomplished by checking the box(es) for the documents to be added and selecting the “Add selected documents to binder” button 538. This process may be repeated as many times as necessary to ad content to the VIP (binder). At this point the binder assembly section 528 may be displayed and illustrates the structure of the partially assembled binder 540, as shown in FIG. 18C. Additionally, the user may also be granted permission to 570 save a binder template, 571 merge and unmerge fragments, 572 create a single document/fragment from a groups of documents/fragments, 573 create sections unique to the VIP and not based not based on the system taxonomy or meta tagging, view binder alphanumeric ordering 574 and/or publish the binder to an ED 575.

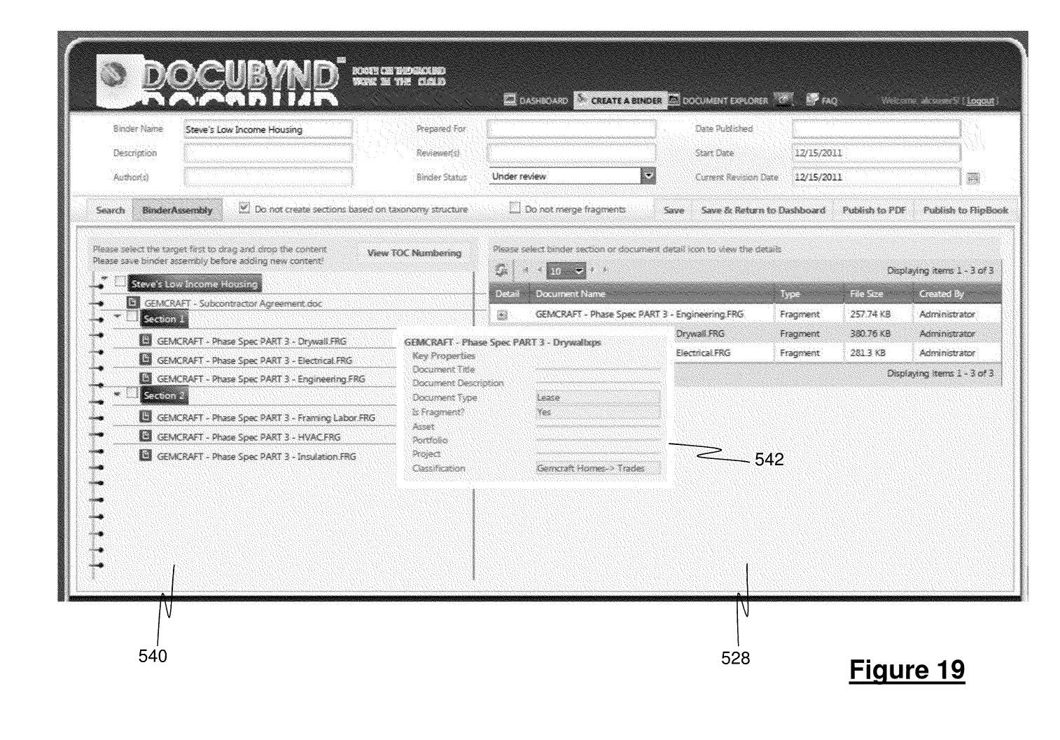

As can be seen, the structure of the partially assembled binder is shown in the left hand column 540 in FIG. 18A and displays the taxonomy structure and the documents/sections contained within the structure. This display may be collapsed partially or fully, as shown in FIG. 18B and FIG. 18C. It should be appreciated that metadata about the document or section may be displayed (or made available) for each (all or some) of the documents and/or sections. Referring to FIG. 19, for example, when the curser is located over one of the names of the documents (in this case “GEMCRAFT—Phase Spec PART 3—Drywallxps”), metadata about this document is displayed in a pop-up box 542. A VIP 100 can be built and designed quickly and there is no need to access the Master Taxonomy(s) to create a VIP 100 or one based on an existing VIP 100. The user may publish the VIP 100 in any desired ED format from the GUI. It should be appreciated that the use of the term “binder” herein may also refer to a VIP 100.

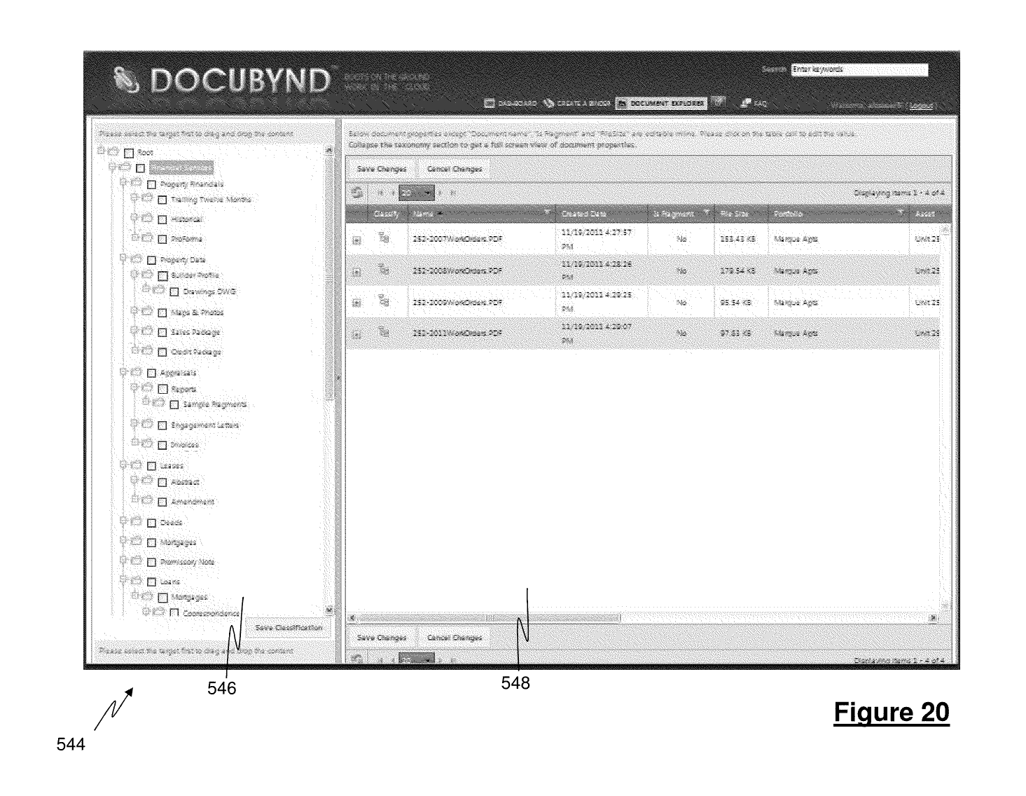

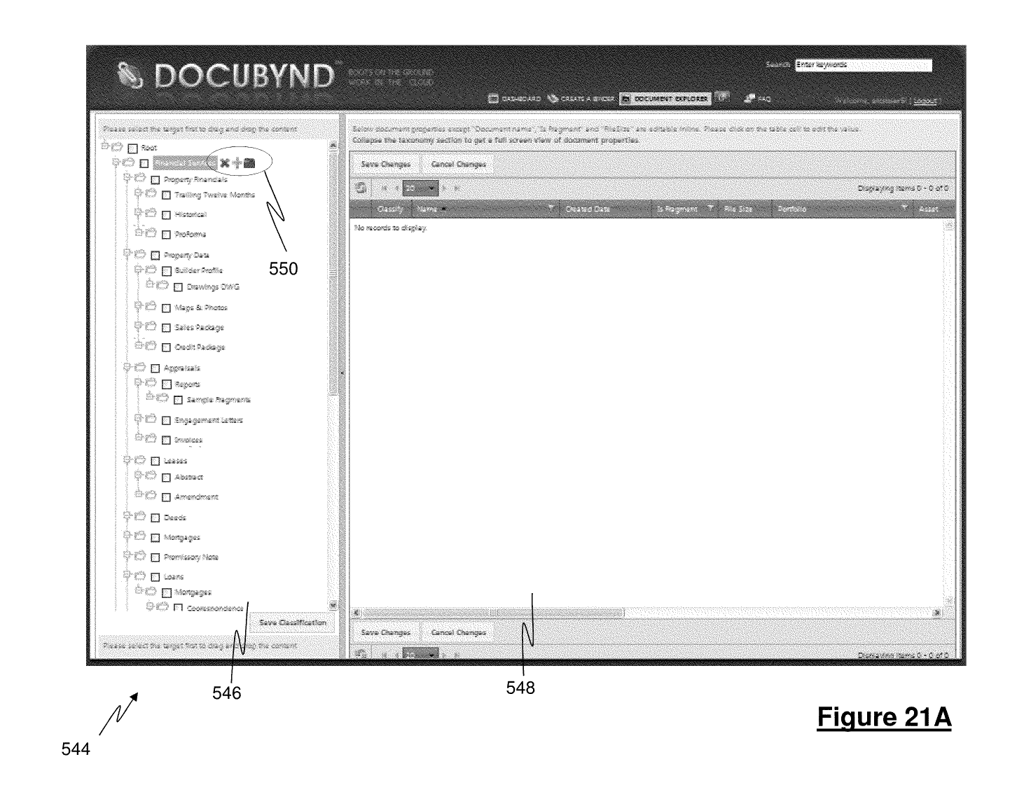

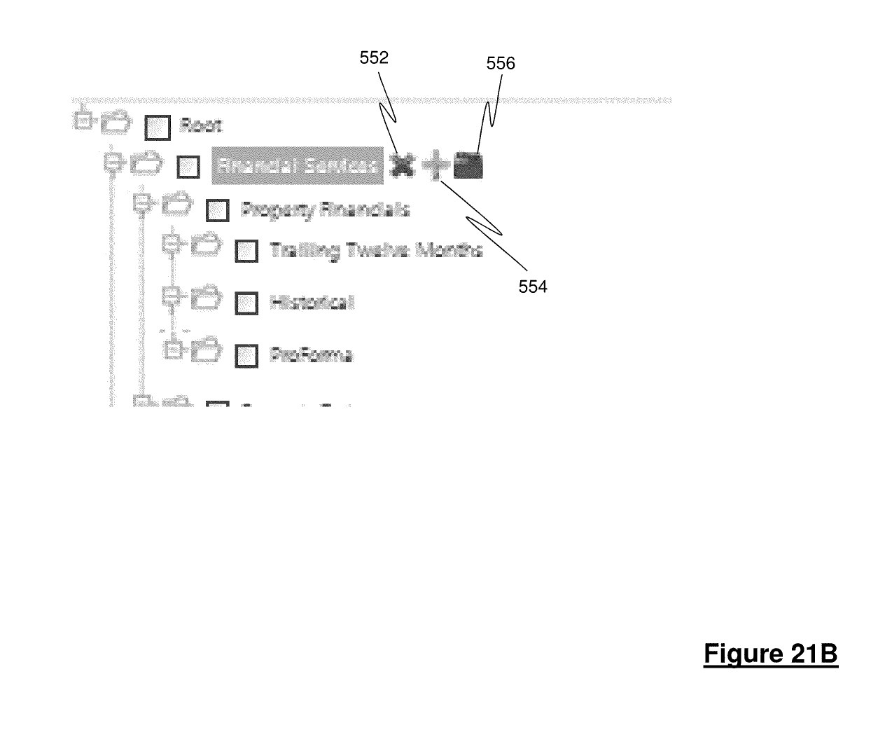

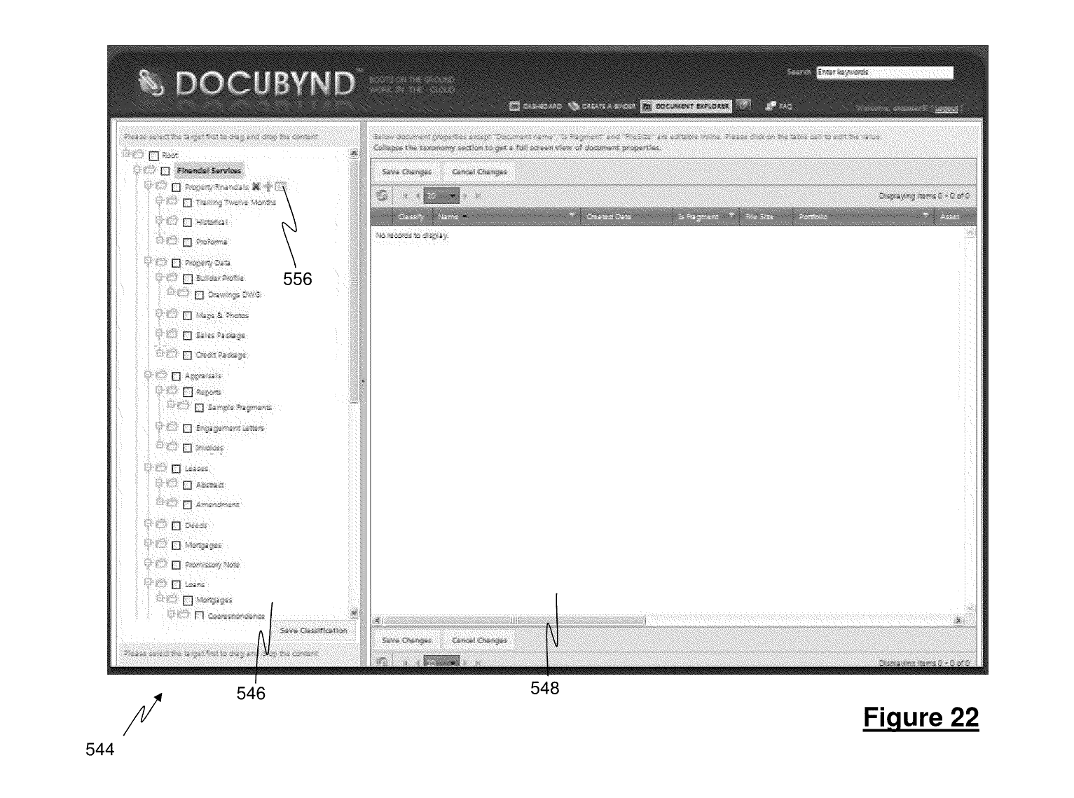

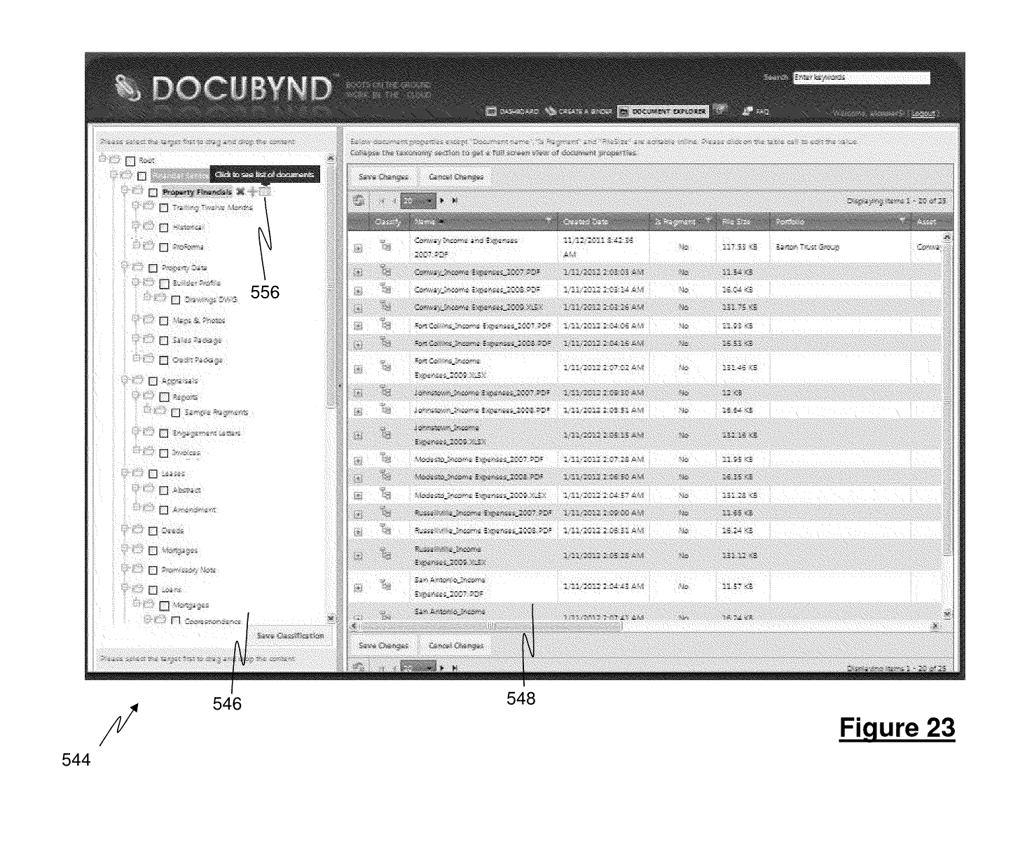

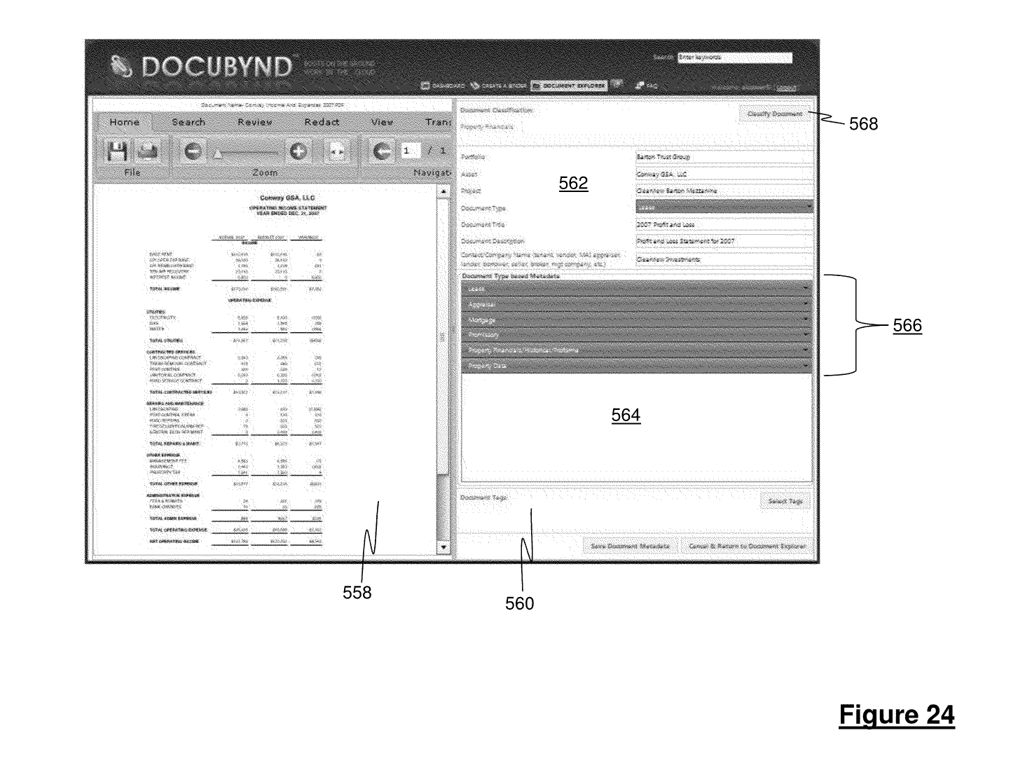

In accordance with the present invention, referring to FIG. 20, the GUI 500 may also include a document explorer window 544 which is divided up into two (or more) windows, a window showing the master taxonomy folder structure 546 and a window that performs a variety of system functions. One embodiment of the window shows a list of files within a selected folder section 548. It should be appreciated that the explorer folder taxonomy section 546 lists the folders that are contained within the VIP 100 and are arranged relative to their hierarchy. The user may modify this arrangement as desired by simply selecting a folder and dragging and dropping it into the new location in the taxonomy. The user may also add, delete and rename folders in the taxonomy as desired. The explorer file list section 548 lists the files/documents that are contained within a selected folder listed in the explorer folder list section 546. In accordance with one embodiment of the invention, the files/documents that are contained within a selected folder listed in the explorer folder list section 546 may be shown by placing the cursor over a desired folder such that an action symbol 550 appears, as shown in FIG. 21A. As shown in FIG. 21B, the folder action symbol (or ICON) 550 may be an “X” 552 representing a delete function, a “+” 554 representing adding a folder function and/or a folder content symbol 556, where the folder content symbol 556 may be one symbol when the folder has no content (shown as a dark red folder in FIG. 21A and FIG. 21B) and another symbol when the folder has content (shown as a file list icon in FIG. 22). It should be appreciated that any symbols may be used as desired—When the file list symbol 556 is selected, a list of the files/documents contained in that folder is displayed in the explorer file list section 548, as shown in FIG. 23. If the user wants to view the contents and metadata information of a file/document displayed in the explorer file list section 548, the user simply has to select the desired file/document mouse cursor. Once selected, the GUI 500 may display a document content section 558 and a metadata section 560, as shown in FIGS. 23 and 24.

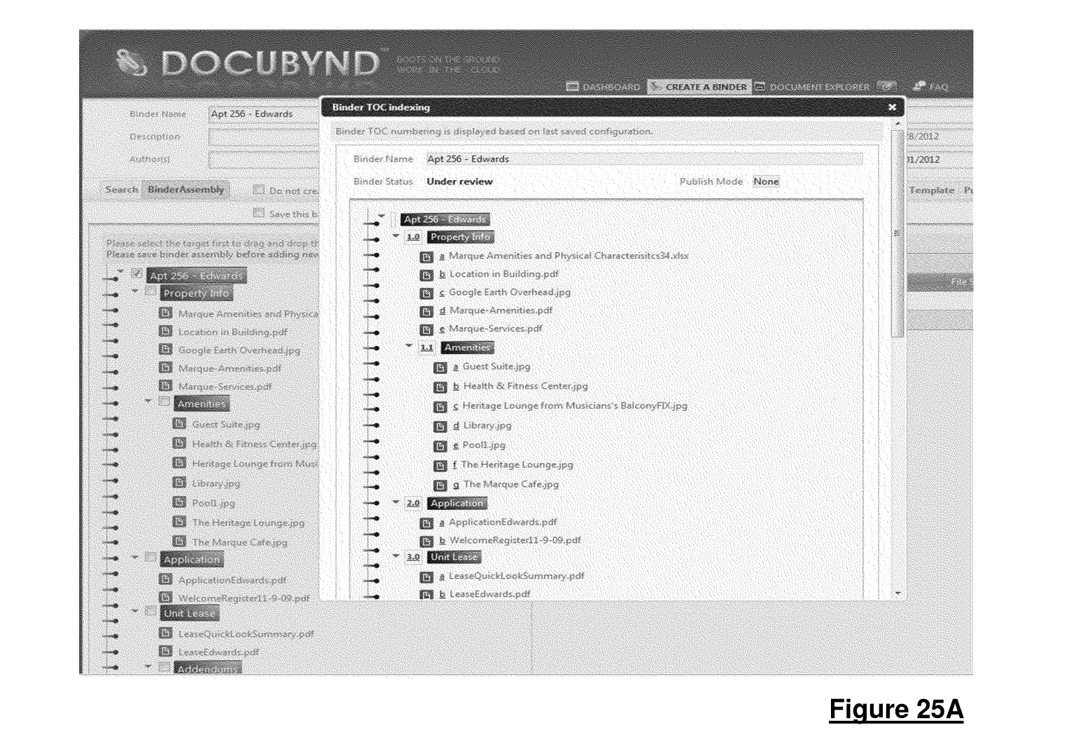

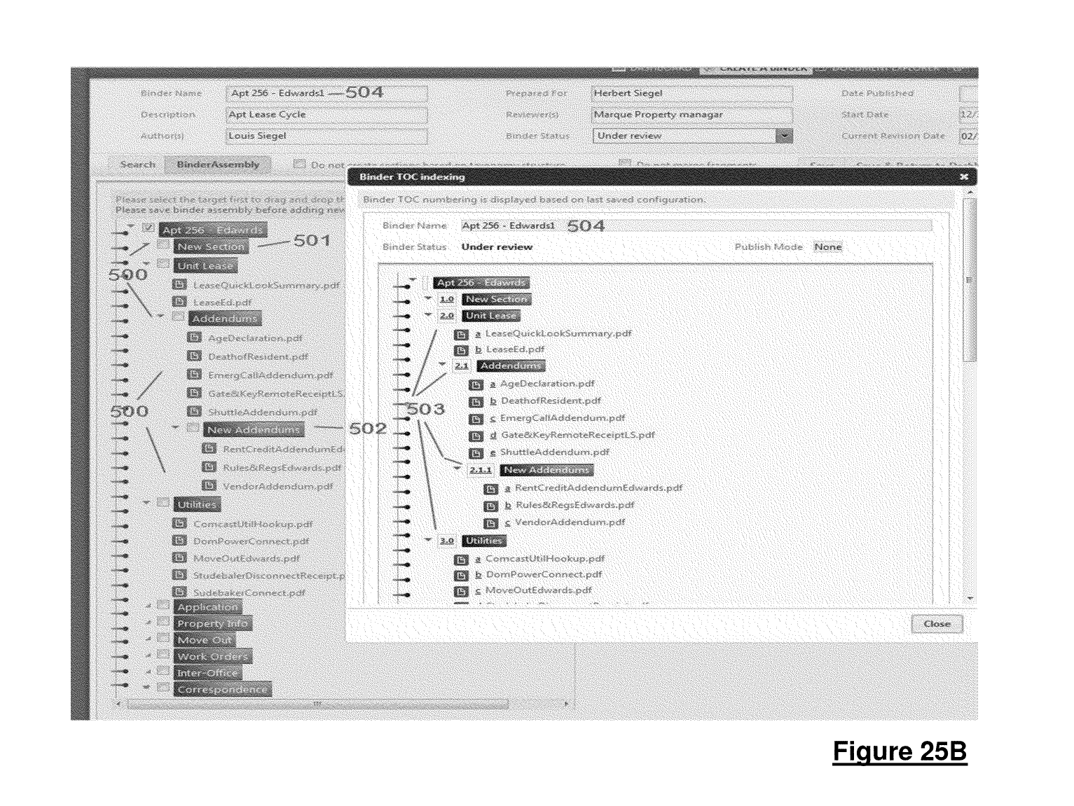

Another advantage of the present invention is that it satisfies the need to easily rearrange a VIP 100, its assembly, content and/or its taxonomy and/or to automatically reorder its alpha numeric hierarchy (See FIGS. 6, 25A and 25B). In FIG. 25A an original binder assembly and it sections and subsections are depicted with its alpha numeric ordering. In FIG. 25B the original binder has been modified by reordering the sections 500 and adding a new section 501 (“New Section”) and a new subsection 502 (“New Addendums”). The alpha numeric ordering 503 has automatically adjusted to reflect the new section hierarchy. The binder name 504 has been automatically changed (“Edwards1”) to reflect the name of the new version. The ability of the system and method of the invention to quickly achieve the transformation from that shown in FIG. 25A to FIG. 25B is an important improvement over current systems and methods.

Furthermore, referring again to FIG. 12, the docubynd system 110, 200 may be configured such that the contents of a VIP 100 may be viewed in any ED output format or mode desired, such as a read-only mode (such as in a flip view fashion which allows a user to “flip” through the information page by page). Accordingly, in one embodiment, the docubynd system 110, 200 would allow users to preview a VIP 100 using flip view. It should be appreciated that the VIP 100 may be published when viewed in the flip view mode if desired.

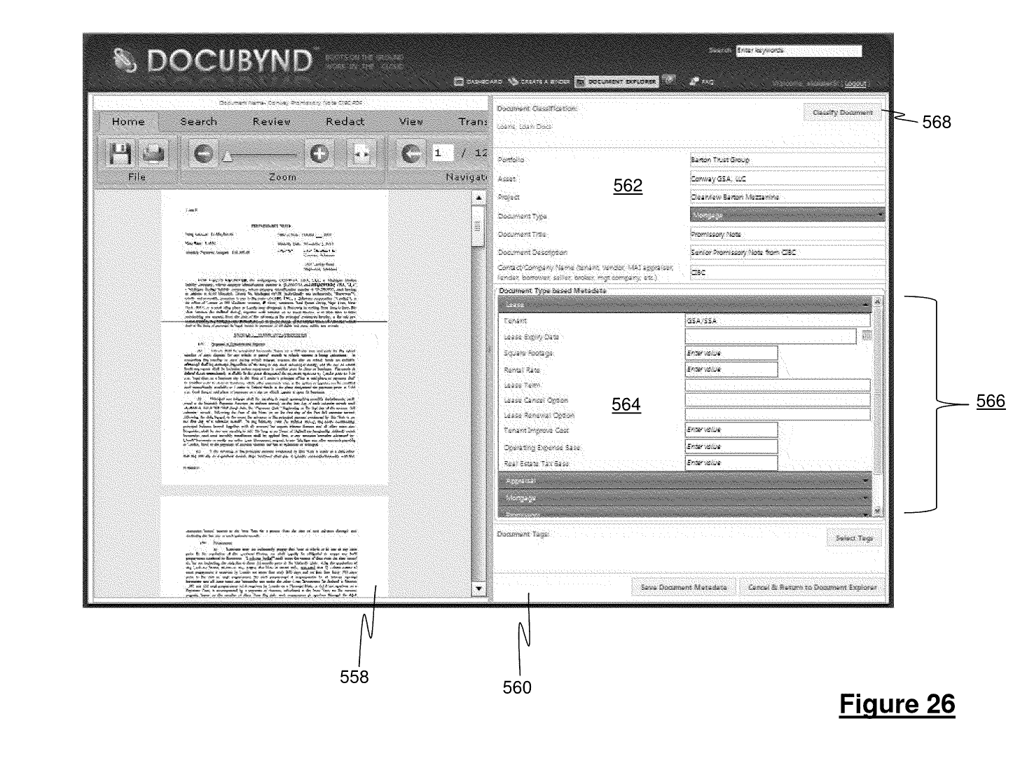

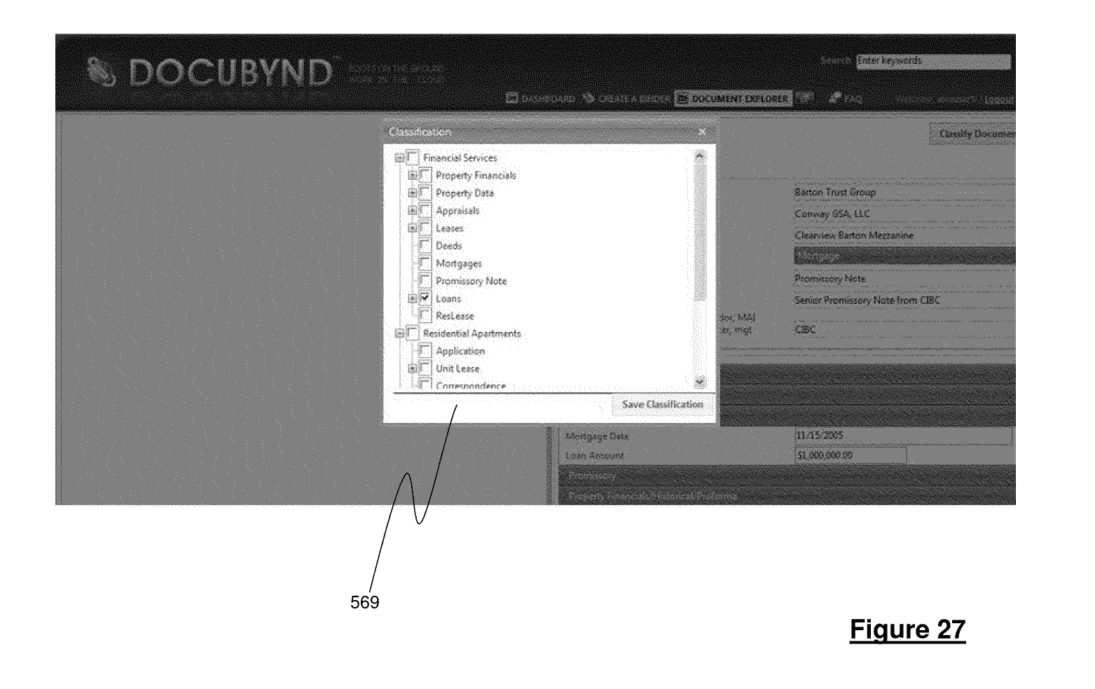

Referring again to FIG. 24, it should be appreciated that the metadata section 560 may include a document classification section 562 and a Document Type Metadata section 564. The document classification section 562 may include fields for contain document information such as Portfolio Name, Asset Name, Project Name, Document Type, Document Title, Document Description and/or Company/Contact information. The Document Type Metadata section 564 may include subsections 566 which may include fields for containing more specific metadata information. For example, referring to FIG. 26, the Document Type Metadata section 564 includes six (6) subsections 566: Lease, Appraisal, Mortgage, Promissory, Property Financials/Historical/Proforma and Property Data, where each of these subsections 566 may include fields for containing specific metadata information. It should be appreciated that the document may be classified or re-classified by selecting the Classify Document button 568, where when selected a classification menu 569 will be displayed to the user to select a classification, as shown in FIG. 27.

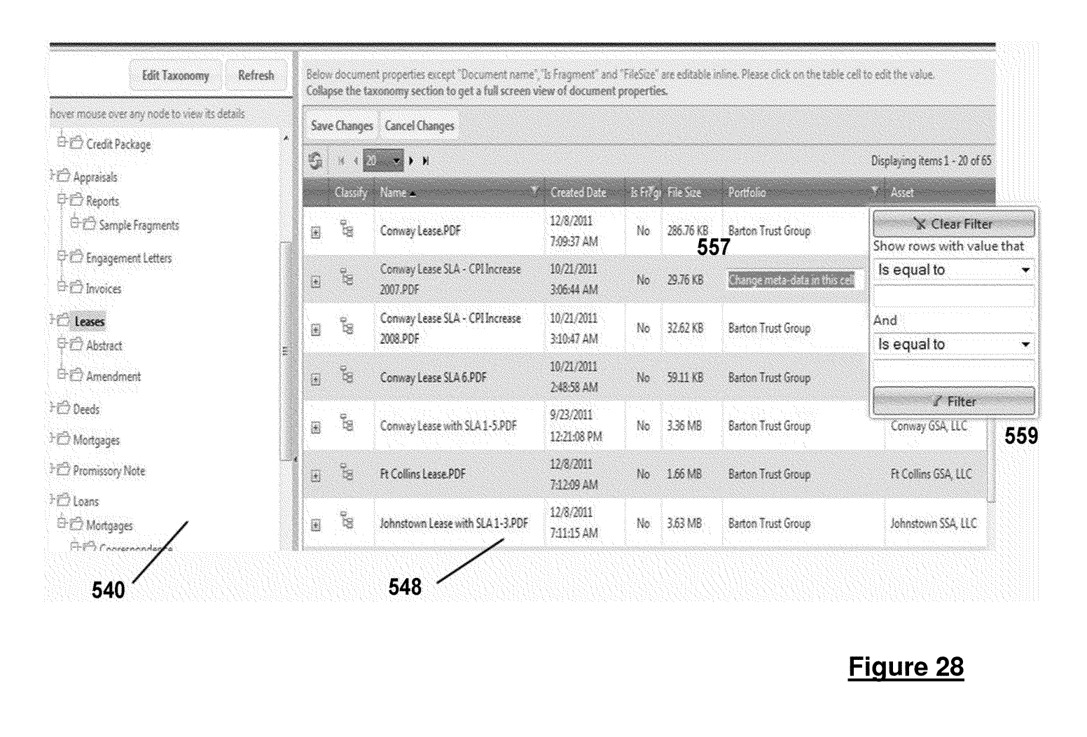

Information objects may also be classified and sorted using the GUI window shown in FIG. 28 the user may change 557 the meta-data by changing the information in the selected cell. The user may also 559 filter data in any column to more precisely query the selected meta-data in the column.

A document may also be tracked in a GUI window displaying its properties as shown in FIG. 11E, its metadata, its location in all VIPs in the system, as shown in FIG. 11F and by tracking its association to its child objects or fragments.

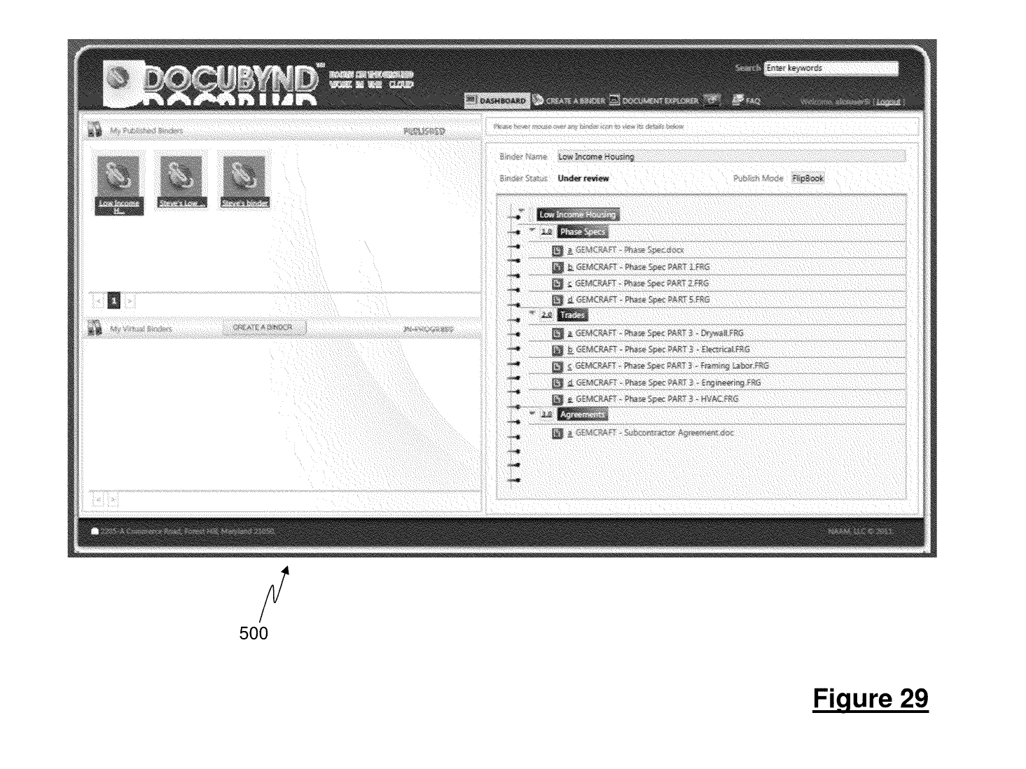

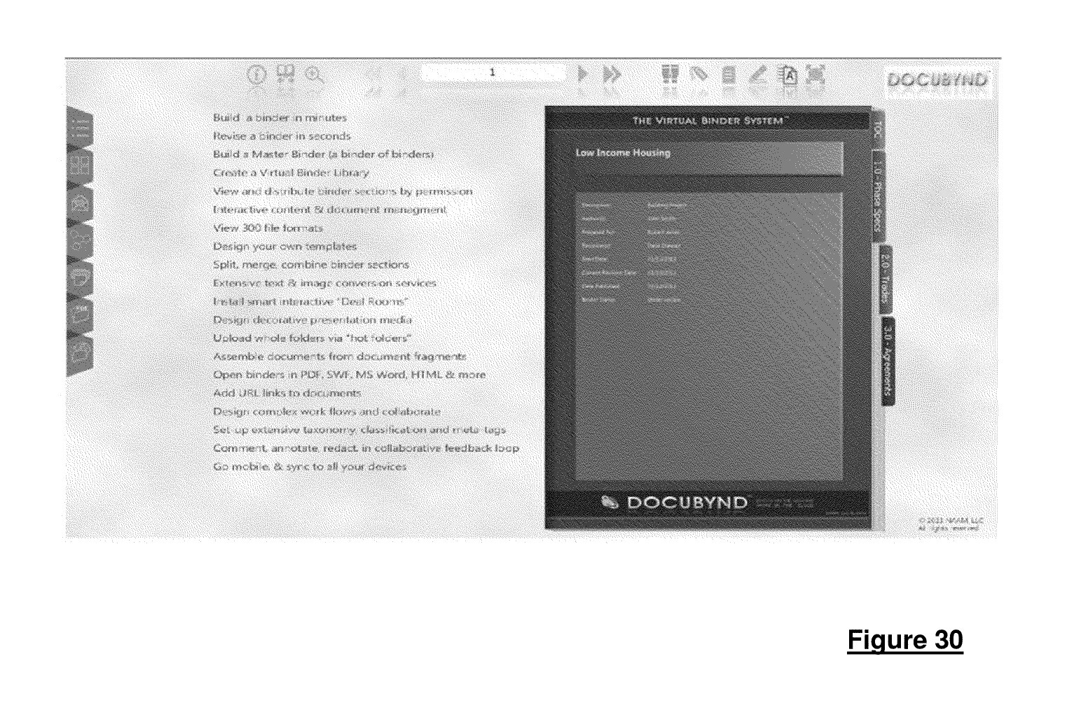

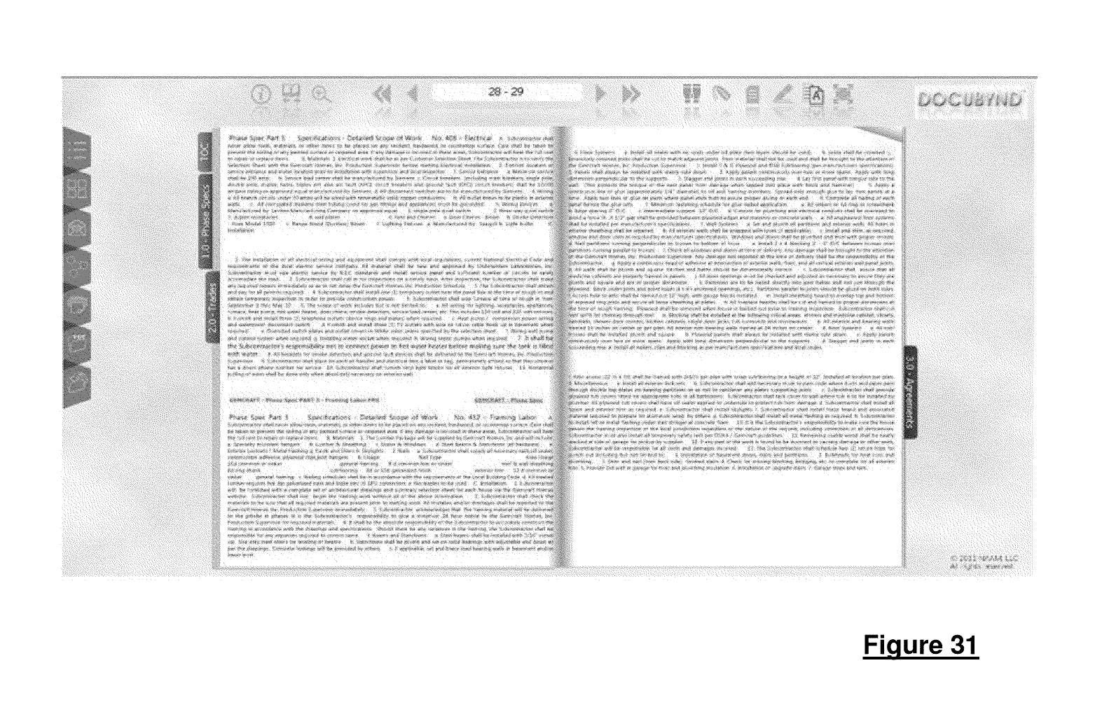

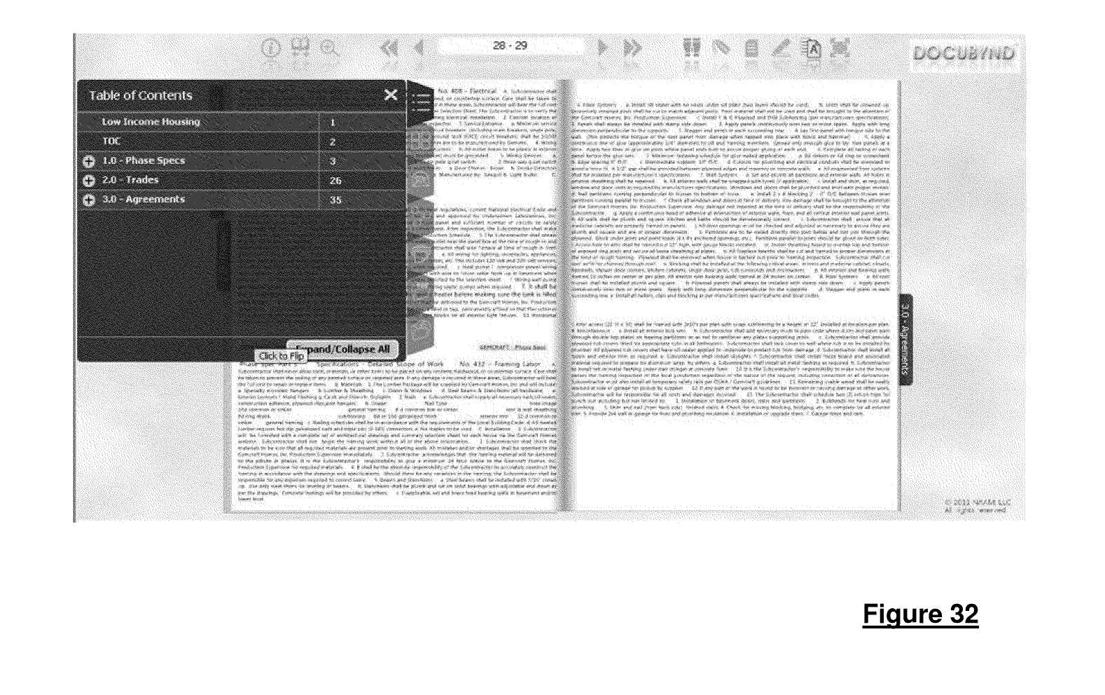

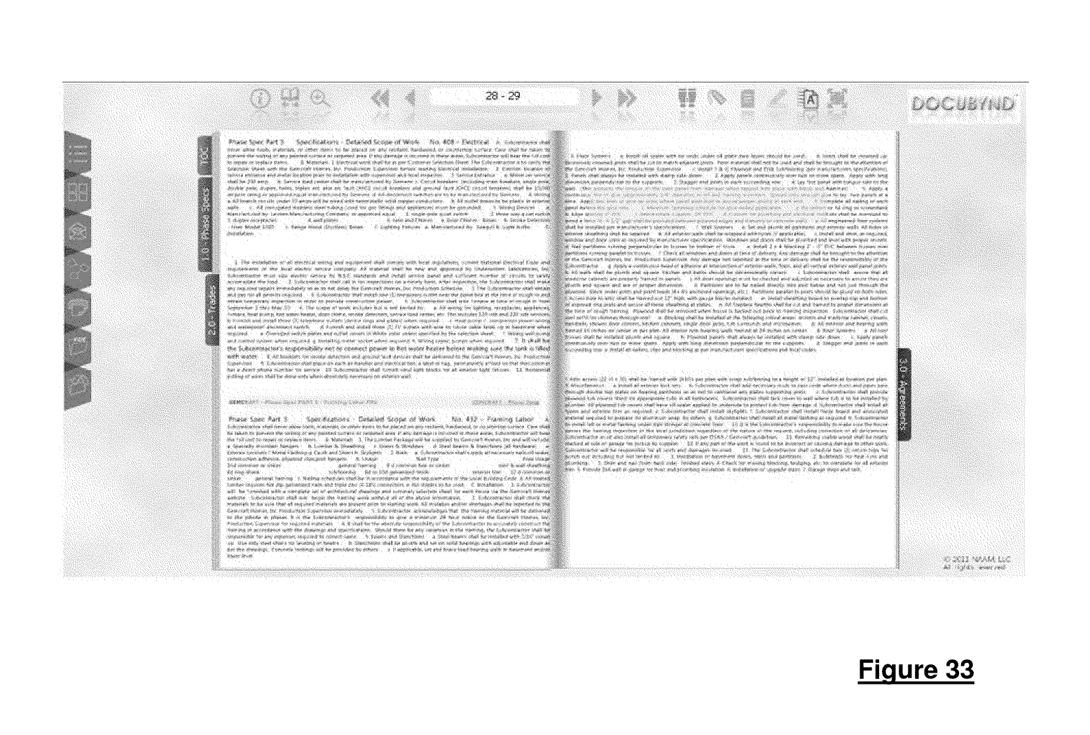

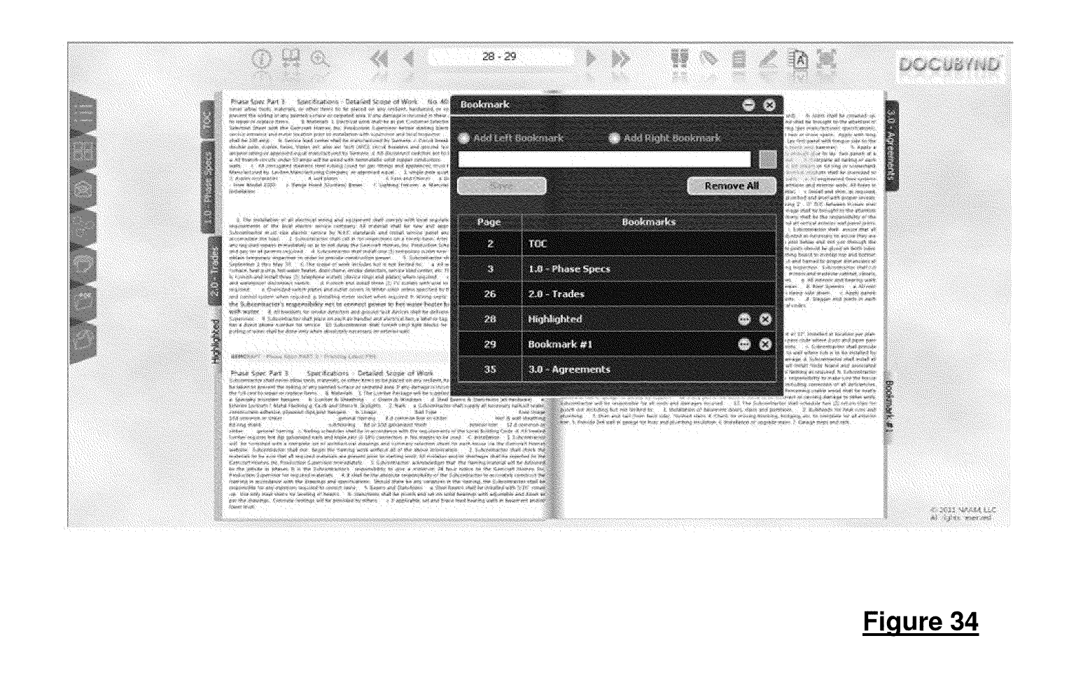

At any time the documents/information that are to be included in the VIP may be selected, inserted and classified as desired and the Virtual VIP 100 may be published into a .pdf or it may be published into a “FlipBook” format (or other type of document viewing format) (See FIG. 28). The Virtual Binder will then be displayed in the Published Binder section of the Dashboard 500, as shown in FIG. 29 and the VIP documents may be viewed, printed and annotated. The “FlipBook” format, which is shown in FIG. 30, FIG. 31 and FIG. 32, allows a user to view the binder information via a book format which may include a table of contents and sections separated by tabs. Additionally, referring to FIG. 33 and FIG. 34, when viewing the information via the FlipBook format, a user may be able to highlight desired text, as well as insert bookmarks and/or perform other functions as desired. The user may also be able to search the entire binder for relevant text. The user may also edit the published binder, e-mail and download it. Numerous views of the binder can be seen.

In accordance with the present invention, the docubynd system may include and/or the processing of the method of the invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing. The method of the invention can be implemented using any software technology suitable to the desired end purpose, such as .NET or Java

Moreover, the docubynd system may include and the method of the present invention may be embodied in the form of a computer and/or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for managing information, comprising:
creating a database, wherein the database is governed by a database taxonomy defined by a user and wherein the database taxonomy establishes rules for information within the database;
introducing information objects into the database responsive to the database taxonomy;
generating classified information objects by classifying the information objects responsive to the database taxonomy, where the classified information objects include information object metadata;
assembling a virtual information package responsive to the classified information objects, wherein the virtual information package includes links to the classified information objects and wherein the database taxonomy establishes rules for assembling the virtual information package;
allowing access to the virtual information package to allow additional information objects to be introduced into the database responsive to the database taxonomy;
finalizing the virtual information package; and
publishing the virtual information package in a desired electronic document format.

2. The method of claim 1, wherein creating a database includes introducing relevant information objects from one or more information resources.

3. The method of claim 2, wherein creating a database includes defining a database taxonomy which establishes rules for distributing the information objects contained within the database, wherein the information objects include documents and data fragments.

4. The method of claim 1, wherein introducing information objects includes introducing information objects that satisfy the database taxonomy.

5. The method of claim 2, wherein generating classified information includes classifying information based on the database taxonomy, wherein the database taxonomy is at least one of a master taxonomy and a sub-taxonomy, wherein the sub-taxonomy is responsive to the database taxonomy.

6. The method of claim 2, wherein generating classified information includes identifying or creating an information object and classifying the information object responsive to at least one of a sub-taxonomy and a master taxonomy.

7. The method of claim 2, wherein assembling a virtual information package includes designing a virtual information package format structure responsive to the database taxonomy and generating the virtual information package responsive to the virtual information package format structure.

8. The method of claim 7, wherein allowing access to the virtual information package includes generating hyperlinks to the classified information objects.

9. The method of claim 2, wherein finalizing the virtual information package includes,
introducing additional relevant information into the database;
examining the additional information to determine if the additional information conforms to the database taxonomy; and
adding the additional information that conforms to the database taxonomy to the classified information objects.

10. A method for managing information, comprising:
creating a database for containing information, wherein the information contained within the database is governed by a database taxonomy;
generating classified information by classifying the information responsive to the database taxonomy;
assembling a virtual information package responsive to the classified information, wherein the virtual information package includes a link to the classified information and wherein the database taxonomy establishes rules for assembling the virtual information package file;
finalizing the virtual information package; and
publishing the virtual information package in a desired electronic document format.

11. The method of claim 10, wherein creating the database includes introducing information into the database responsive to the database taxonomy.

12. The method of claim 10, wherein creating a database includes defining a database taxonomy which establishes rules for distributing the information objects contained within the database, wherein the information objects include documents and data fragments.

13. The method of claim 10, wherein creating a database includes defining the database taxonomy.

14. The method of claim 10, wherein generating classified information includes classifying information based on the database taxonomy, wherein the database taxonomy is at least one of a master taxonomy and a sub-taxonomy, wherein the sub-taxonomy is responsive to the database taxonomy.

15. The method of claim 10, wherein generating classified information includes identifying or creating an information object and classifying the information object responsive to at least one of a sub-taxonomy and a master taxonomy.

16. The method of claim 10, wherein assembling a virtual information package includes designing a virtual information package format structure and generating the virtual information package responsive to the virtual information package format structure.

17. The method of claim 10, wherein finalizing the virtual information package includes allowing access to the virtual information package via hyperlinks to the classified information objects.

18. The method of claim 10, wherein finalizing the virtual information package includes,
introducing additional relevant information into the database;
examining the additional information to determine if the additional information conforms to the database taxonomy; and
adding the additional information that conforms to the database taxonomy to the classified information objects.

19. A system for implementing a method for receiving, categorizing, arranging and displaying information, the system comprises:
an input device for introducing information objects into the system;
a display device, wherein the display device includes the display screen for displaying the information introduced objects in to the system; and
a processing device, wherein the processing device is configured to implement a method for receiving, categorizing, and displaying information objects , wherein the method includes,
creating a database, wherein the database is governed by a database taxonomy defined by a user and wherein the database taxonomy establishes rules for information within the database;
introducing information objects into the database responsive to the database taxonomy;
generating classified information objects by classifying the information objects responsive to the database taxonomy, where the classified information objects include information object metadata;
assembling a virtual information package responsive to the classified information objects, wherein the virtual information package includes links to the classified information objects and wherein the database taxonomy establishes rules for assembling the virtual information package;
allowing access to the virtual information package to allow additional information objects to be introduced into the database responsive to the database taxonomy;
finalizing the virtual information package; and
publishing the virtual information package in a desired electronic document format.

20. The system of claim 19, wherein creating the database includes,
identifying relevant information from one or more information resources;
defining the database taxonomy; and
introducing the relevant information into the database responsive to the database taxonomy.
